(19) United States
(12) Patent Application Publication
(10) Pub. No.: US 2025/0202519 A1
(43) Pub. Date: Jun. 19, 2025

(54) SYSTEM AND METHOD FOR PERFORMING MOTION CAPTURE USING CHANNEL STATE INFORMATION

(71) Applicant: Rearden, LLC, Mountain View, CA (US)

(72) Inventors: Stephen G. Perlman, Palo Alto, CA (US); Fadi Saibi, Sunnyvale, CA (US); Roger van der Laan, Lakeport, CA (US); Stephen Johnson, Hayward, CA (US); Allan Ievers, San Carlos, CA (US)

(21) Appl. No.: 18/977,818

(22) Filed: Dec. 11, 2024

Related U.S. Application Data
(60) Provisional application No. 63/609,769, filed on Dec. 13, 2023.

(51) Int. Cl. H04B 1/3827; G01S 13/89

(52) U.S. Cl. CPC H04B 1/385; G01S 13/89

(57) ABSTRACT

A wearable device including at least one radio frequency (RF) transmitter comprising an antenna integrated into at least one component of the wearable device, the at least one RF transmitter configured to periodically transmit at least one RF waveform, and at least one RF receiver comprising an antenna integrated into the at least one component of the wearable device, the at least one RF receiver configured to receive the at least RF waveform subsequent to the at least one RF waveform contacting an anatomy of a wearer of the wearable device. A channel state information (CSI) is estimated from the received RF waveform, the estimated CSI is compared with CSI entries in a database to determine a closest matching CSI, and a texture map of the wearer's anatomy is selected by associating with the CSI in the database.

### CROSS-REFERENCE TO RELATED APPLICATIONS

This patent application claims priority to and the benefit of U.S. Provisional Application No. 63/609,769, filed Dec. 13, 2023, entitled “System and Method for Performing Motion Capture using Channel State Information”, and incorporates U.S. Provisional Application No. 63/609,769 in its entirety.

This U.S. Provisional Application may be related to the following filed, issued, and/or co-pending U.S. Patent Applications:
U.S. Provisional Application No. 63/609,769, filed Dec. 13, 2023, entitled “System and Method for Performing Motion Capture using Channel State Information”
U.S. Provisional Application No. 63/007,358, filed Apr. 8, 2020, entitled, “Systems and Methods for Electromagnetic Virus Inactivation”
U.S. Pat. No. 11,190,947, issued Nov. 30, 2021, entitled “System And Method For Concurrent Spectrum Usage within Actively Used Spectrum”
U.S. Pat. No. 11,189,917, issued Nov. 30, 2021, entitled “System And Method For Distributing Radioheads”
U.S. Pat. No. 11,070,258, issued Jul. 20, 2021, entitled “System And Method For Planned Evolution and Obsolescence of Multiuser Spectrum”
U.S. Pat. No. 11,050,468, issued Jun. 29, 2021, entitled “System And Method For Mitigating Interference within Actively Used Spectrum”
U.S. Pat. No. 10,985,811, issued Apr. 20, 2021, entitled “System And Method For Distributed Input Distributed Output Wireless Communication”
U.S. Pat. No. 10,886,979, issued Jan. 4, 2021, entitled “System And Method For Link adaptation In DIDO Multicarrier Systems”
U.S. Pat. No. 10,848,225 issued Nov. 24, 2020, entitled “Systems And Methods For Exploiting Inter-Cell Multiplexing Gain In Wireless Cellular Systems Via Distributed Input Distributed Output Technology”
U.S. Pat. No. 10,749,582, issued Aug. 18, 2020, entitled “Systems And Methods to Coordinate Transmissions in Distributed Wireless Systems via User Clustering”
U.S. Pat. No. 10,727,907, issued Jul. 28, 2020, entitled “System And Methods to Enhance Spatial Diversity in Distributed-Input Distributed-Output Wireless Systems”
U.S. Pat. No. 10,547,358, issued Jan. 28, 2020, entitled “System and Methods for Radio Frequency Calibration Exploiting Channel Reciprocity in Distributed Input Distributed Output Wireless Communications”
U.S. Pat. No. 10,425,134, issued Sep. 24, 2019, entitled “System and Methods for Planned Evolution and Obsolescence of Multiuser Spectrum”
U.S. Pat. No. 10,349,417, issued Jul. 9, 2019, entitled “System and Methods to Compensate for Doppler Effects in Distributed-Input Distributed Output Systems”
U.S. Pat. No. 10,333,604, issued, Jun. 25, 2019, entitled “System and Method For Distributed Antenna Wireless Communications”
U.S. Pat. No. 10,320,455, issued Jun. 11, 2019, entitled “Systems and Methods to Coordinate Transmissions in Distributed Wireless Systems via User Clustering”
U.S. Pat. No. 10,277,290, issued Apr. 30, 2019, entitled “Systems and Methods to Exploit Areas of Coherence in Wireless Systems”
U.S. Pat. No. 10,243,623, issued Mar. 26, 2019, entitled “System and Methods to Enhance Spatial Diversity in Distributed-Input Distributed-Output Wireless Systems”
U.S. Pat. No. 10,200,094, issued Feb. 5, 2019, entitled “Interference Management, Handoff, Power Control And Link Adaptation In Distributed-Input Distributed-Output (DIDO) Communication Systems”
U.S. Pat. No. 10,187,133, issued Jan. 22, 2019, entitled “System And Method For Power Control And Antenna Grouping In A Distributed-Input-Distributed-Output (DIDO) Network”
U.S. Pat. No. 10,164,698, issued Dec. 25, 2018, entitled “System and Methods for Exploiting Inter-Cell Multiplexing Gain in Wireless Cellular Systems Via Distributed Input Distributed Output Technology”
U.S. Pat. No. 9,973,246, issued May 15, 2018, entitled “System and Methods for Exploiting Inter-Cell Multiplexing Gain in Wireless Cellular Systems Via Distributed Input Distributed Output Technology”
U.S. Pat. No. 9,923,657, issued Mar. 20, 2018, entitled “System and Methods for Exploiting Inter-Cell Multiplexing Gain in Wireless Cellular Systems Via Distributed Input Distributed Output Technology”
U.S. Pat. No. 9,826,537, issued Nov. 21, 2017, entitled “System And Method For Managing Inter-Cluster Handoff Of Clients Which Traverse Multiple DIDO Clusters”
U.S. Pat. No. 9,819,403, issued Nov. 14, 2017, entitled “System And Method For Managing Handoff Of A Client Between Different Distributed-Input-Distributed-Output (DIDO) Networks Based On Detected Velocity Of The Client”
U.S. Pat. No. 9,685,997, issued Jun. 20, 2017, entitled “System and Methods to Enhance Spatial Diversity in Distributed-Input Distributed-Output Wireless Systems”
U.S. Pat. No. 9,386,465, issued, Jul. 5, 2016, entitled “System and Method For Distributed Antenna Wireless Communications”
U.S. Pat. No. 9,369,888, issued Jun. 14, 2016, entitled “Systems and Methods to Coordinate Transmissions in Distributed Wireless Systems via User Clustering”
U.S. Pat. No. 9,312,929, issued Apr. 12, 2016, entitled “System and Methods to Compensate for Doppler Effects in Distributed-Input Distributed Output Systems”
U.S. Pat. No. 8,989,155, issued Mar. 24, 2015, entitled “System and Methods for Wireless Backhaul in Distributed-Input Distributed-Output Wireless Systems”
U.S. Pat. No. 8,971,380, issued Mar. 3, 2015, entitled “System And Method For Adjusting DIDO Interference Cancellation Based On Signal Strength Measurements”
U.S. Pat. No. 8,654,815, issued Feb. 18, 2014, entitled “System and Method For Distributed Antenna Wireless Communications”
U.S. Pat. No. 8,571,086, issued Oct. 29, 2013, entitled “System And Method For DIDO Precoding Interpolation In Multicarrier Systems”
U.S. Pat. No. 8,542,763, issued Sep. 24, 2013, entitled “Systems and Methods to Coordinate Transmissions in Distributed Wireless Systems via User Clustering”
U.S. Pat. No. 8,428,162, issued Apr. 23, 2013, entitled “System and Method for Distributed Input Distributed Output Wireless Communication”
U.S. Pat. No. 8,170,081, issued May 1, 2012, entitled “System And Method For Adjusting DIDO Interference Cancellation Based On Signal Strength Measurements”
U.S. Pat. No. 8,160,121, issued Apr. 17, 2012, entitled “System and Method For Distributed Input-Distributed Output Wireless Communications
U.S. Pat. No. 7,885,354, issued Feb. 8, 2011, entitled “System and Method For Enhancing Near Vertical Incidence Skywave (“NVIS”) Communication Using Space-Time Coding”
U.S. Pat. No. 7,711,030, issued May 4, 2010, entitled “System and Method For Spatial-Multiplexed Tropospheric Scatter Communications”
U.S. Pat. No. 7,636,381, issued Dec. 22, 2009, entitled “System and Method for Distributed Input Distributed Output Wireless Communication”
U.S. Pat. No. 7,633,994, issued Dec. 15, 2009, entitled “System and Method for Distributed Input Distributed Output Wireless Communication”
U.S. Pat. No. 7,599,420, issued Oct. 6, 2009, entitled “System and Method for Distributed Input Distributed Output Wireless Communication”
U.S. Pat. No. 7,418,053, issued Aug. 26, 2008, entitled “System and Method for Distributed Input Distributed Output Wireless Communication”
U.S. application Ser. No. 17/224,977, filed Apr. 7, 2021, entitled “Systems and Methods for Electromagnetic Virus Inactivation”
U.S. application Ser. No. 16/505,593, filed Jul. 8, 2019, entitled “System And Method to Compensate for Doppler Effects in Multi-user (MU) Multiple Antenna Systems (MAS)”
U.S. application Ser. No. 14/611,565, filed Feb. 2, 2015, entitled “System And Method For Mapping Virtual Radio Instances Into Physical Areas of Coherence in Distributed Antenna Wireless Systems”
U.S. Pat. No. 10,593,090, issued Mar. 17, 2020, entitled “Apparatus and Method for Performing Motion Capture Using a Random Pattern on Capture Surfaces”
U.S. Pat. No. 9,996,962, issued Jun. 12, 2018, entitled “Apparatus and Method for Performing Motion Capture Using a Random Pattern on Capture Surfaces”
U.S. Pat. No. 9,928,633, issued Mar. 27, 2018, entitled “Apparatus and Method for Performing Motion Capture Using a Random Pattern on Capture Surfaces”
U.S. Pat. No. 8,659,668, issued Feb. 25, 2014, entitled “Apparatus and Method for Performing Motion Capture Using a Random Pattern on Capture Surfaces”
U.S. Pat. No. 8,207,963, issued Jun. 26, 2012, entitled “System and Method For Performing Motion Capture and Image Reconstruction”
U.S. Pat. No. 8,194,093, issued Jun. 5, 2012, entitled “Apparatus and Method for Capturing the Expression of a Performer”
U.S. Pat. No. 7,667,767, issued Feb. 23, 2010, entitled “System and Method for Three Dimensional Capture of Stop-Motion Animated Characters”
U.S. Pat. No. 7,633,521, issued Dec. 15, 2009, entitled “Apparatus and Method for Improving Marker Identification Within a Motion Capture System”
U.S. Pat. No. 7,605,861, issued Oct. 20, 2009, entitled “Apparatus and Method for Performing Motion Capture Using Shutter Synchronization”
U.S. Pat. No. 7,567,293, issued Jul. 28, 2009, entitled “System and Method for Performing Motion Capture By Strobing a Fluorescent Lamp”
U.S. Pat. No. 7,548,272, issued Jun. 16, 2009, entitled “System and Method for Performing Motion Capture Using Phosphor Application Techniques”
U.S. application Ser. No. 12/455,771, filed Jun. 5, 2009, entitled “System and Method For Performing Motion Capture and Image Reconstruction With Transparent Makeup”
U.S. application Ser. No. 10/942,609, filed Sep. 15, 2004, entitled “Apparatus and Method for Capturing the Motion of a Performer”

These applications are collectively referred to as the “Related Patents and Applications” and are incorporated herein by reference.

### BACKGROUND OF THE INVENTION

### Field of the Invention

This invention relates generally to the field of motion capture. More particularly, the invention relates to an improved apparatus and method for unobtrusively performing facial motion capture and image reconstruction.

### Description of the Related Art

“Motion capture” refers generally to the tracking and recording of human and animal motion. Motion capture systems are used for a variety of applications including, for example, creating video games and computer-generated movies. In a typical motion capture session, the motion of a “performer” is captured and translated to a computer-generated character. Motion capture is also used to capture the motion of humans for sports and medical applications, for example, to track the motion of a golf swing so it can be improved, or to track the gait of an injured leg after surgery as part of physical therapy. Motion capture is increasingly used in consumer applications, for example, when a mobile phone's camera tracks a user's facial motion to animate a character's face, or when a virtual reality (“VR”), augmented reality (“AR”), or collectively, extended reality (“XR”), headset tracks the user's facial motion to animate a character in an XR environment.

As illustrated in FIG. 1 in a motion capture system, a plurality of motion tracking “markers” (e.g., markers 101, 102) are attached at various points on a performer's 100's body. The points are selected based on the known limitations of the human skeleton. Different types of motion capture markers are used for different motion capture systems. For example, in a “magnetic” motion capture system, the motion markers attached to the performer are active coils which generate measurable disruptions x, y, z and yaw, pitch, roll in a magnetic field.

By contrast, in an optical motion capture system, such as that illustrated in FIG. 1, the markers 101, 102 are passive spheres comprised of retro-reflective material, i.e., a material which reflects light back in the direction from which it came, ideally over a wide range of angles of incidence. A plurality of cameras 120, 121,122, each with a ring of LEDs 130, 131, 132 around its lens, are positioned to capture the LED light reflected back from the retro-reflective markers 101, 102 and other markers on the performer. Ideally, the retro-reflected LED light is much brighter than any other light source in the room. Typically, a thresholding function is applied by the cameras 120, 121, 122 to reject all light below a specified level of brightness which, ideally, isolates the light reflected off of the reflective markers from any other light in the room and the cameras 120, 121, 122 only capture the light from the markers 101, 102 and other markers on the performer.

A motion tracking unit 150 coupled to the cameras is programmed with the relative position of each of the markers 101, 102 and/or the known limitations of the performer's body. Using this information and the visual data provided from the cameras 120-122, the motion tracking unit 150 generates artificial motion data representing the movement of the performer during the motion capture session.

A graphics processing unit 152 renders an animated representation of the performer on a computer display 160 (or similar display device) using the motion data. For example, the graphics processing unit 152 may apply the captured motion of the performer to different animated characters and/or to include the animated characters in different computer-generated scenes. In one implementation, the motion tracking unit 150 and the graphics processing unit 152 are programmable cards or devices coupled to the bus of a computer (e.g., such as the PCI Express and Thunderbolt-3 buses found in many personal computers). One well known company which produces motion capture systems is Vicon (see, e.g., www.vicon.com).

There are a wide range of other technologies to perform motion capture, including a variety of optical technologies that utilize passive markers, such as those described above, and active markers such as ones that include LEDs to differentiate them from each other. Other optical technologies use no markers at all, but rather infer the motion of the performer through computer vision techniques where the performer might wear a special close-fitting suit of known characteristics to the computer vision system by which it can infer the performer's motion, or where the performer wears whatever clothing they desire and a computer vision system infers their motion through knowledge of how clothing moves relative to the performer's body.

In addition to the magnetic and optical motion capture systems stated above, there are also inertial motion capture system, in which inertial sensors are attached to the performer and the performer's motion is inferred from inertial detection of motion of their body parts.

In addition to the above motion capture systems, there are motion capture systems that sense mechanical motion. For example, a performer might wear a glove which is able to detect the mechanical motion of the fingers.

Also, there are radio frequency (“RF”) positioning systems used for motion capture. There are a variety of different approaches, including using radar to measure motion from time-of-flight and using channel state information (“CSI”) to measure multiple RF characteristics such as phase and amplitude.

The above motion capture approaches are often combined. For example, the skeletal motion of the body might be captured optically at the same time the fine motion of the hands might be captured mechanically by means of a glove.

Once the motion capture information is captured, through one or more means, it is then processed to determine with varying degrees of precision and reliability the three-dimensional (“3D”) position of the parts of the performer's body sought to be captured. There are a variety of ways to process this data. For example, with optical capture often two or more cameras in a known position relative to each other are used to triangulate the 3D position of a visibly identifiable location on the performer's body or clothing. There are several proprietary and non-proprietary approaches that are used to accomplish this, depending on the nature of the particular optical motion capture technology, the motion capture vendor's choice, and the evolutionary stage of available technology at a given time (e.g., camera resolution and light sensitivity, and processing power). Other techniques, such as magnetic, inertial, mechanical and RF each have their own specific processing requirements to determine the spatial positional information required.

Within the general field of performance motion capture, there are sub-fields. These subfields include:
1. skeletal motion capture, such as that illustrated in FIG. 1, where the 3D positions of the torso, limbs and head are captured in motion,
2. hand motion capture, where the 3D positions of the digits and the hands are captured in motion,
3. facial capture, where some or all of the 3D surface of the face is captured in motion, and
4. cloth capture, where the 3D surface of cloth is captured in motion.

Related to motion capture are fields that recognize certain physical characteristics of the body, without necessarily providing exact 3D positions in space. The fields recognizing certain physical characteristics of the body include:
1. 3D pose estimation, where an approximate pose of an individual is captured, either statically or in motion,
2. gesture recognition, where a gesture, typically with the hands and/or arms is identified, either statically or in motion,
3. facial recognition, where a person is identified by their face, either while they are stationary or in motion, and
4. lip reading, where the lips are read to try to determine utterances, for example, to assist the hearing impaired if the person speaking is wearing a medical mask and their lips are not visible when they are speaking.

Each of the above motion capture technologies and the technologies recognizing certain physical characteristics of the body have certain limitations. For example, optical systems often suffer from occlusions that block certain parts of the body from being captured. Inertial capture is generally limited to skeletal motion and subject to inaccurately reporting motion, mechanical capture is generally limited to joint motion, magnetic capture is often very sensitive to metallic objects disrupting the capture, and RF capture is often very limited to low resolution at frequencies that readily penetrate materials (e.g., sub-6 GHz) or is limited to line-of-sight capture at very high frequencies (e.g., over 18 GHz) because the capture resolution is typically proportional to the wavelength.

Also, the apparatus needed for the above motion capture technologies often limits their fields of application. For example, optical systems inherently require cameras and, high-resolution optical facial capture systems require cameras that are fairly close to the face, both to capture the face with maximum resolution, but also to minimize the likelihood of occlusions blocking one or more cameras from seeing some or all of the face. Optical facial capture systems also need to be in front of the face since light, unlike RF, is unable to penetrate the head. Also, for optical systems to capture the high-resolution 3D geometry of the face completely and accurately, generally more than one angular view is required for triangulation of 3D points. While technologies like LIDAR can be used to determine distance from a single point on a face (e.g., from the LIDAR emitter on a mobile phone), they are typically too limited in depth resolution to capture micro-motions of the face, which are often sub-millimeter, and they are unable to track the motion of a given point on the face since the projected LIDAR pattern cannot be locked to the movement of the skin of the face. As such, single point of view optical capture systems such as mobile phones, whether or not the optical cameras are augmented by LIDAR, can only achieve very approximate facial motion capture.

Even if the resolution and tracking issues were solved for optical facial motion capture systems, it is still the case that there are many situations where having any camera, even one, situated before a face is either impractical or inconvenient. We've all become accustomed to seeing people making videoconference calls (e.g., Apple FaceTime, Google Meet, Microsoft Teams, etc.) with a cell phone or a laptop camera held before their faces for the entire call. This is often awkward (for example, in a public space like an airport) or inconvenient (for example, if the camera is on a desk and the user needs to walk away from the desk). Also, in general, these videoconferences are not 3D captures of the face, which limits emerging use cases such as XR, where users participate in 3D environments and it would be desirable to have a 3D capture of the face either to show the actual face of the user, or to drive the face of a 3D avatar.

In motion picture and video game production, facial capture systems typically have one or more cameras pointed at the face mounted on an extension from a helmet, such as the apparatus shown diagrammatically in FIG. 2. The performer 201 wears a helmet 202 or some other device secured to their head, and there typically are support arms 203a-c that hold camera 204a-c, and the performer may have some sort of makeup pattern 205 or markers on their face. This apparatus is very intrusive to the production environment and can never be used in a live action scene, for example, with other actors in costume and sets and backgrounds, without a post-production step wherein the pixels showing the apparatus are digitally “removed” to look like whatever was obstructed by the apparatus in the scene (e.g., with an artist using a tool like Photoshop or, more recently, using generative AI “inpainting” techniques) in each frame of the scene. While high-budget productions can afford such apparatuses and post-production costs, many, if not most, motion picture and television productions cannot. Further, the world is increasingly turning to smaller-scale productions, whether low-budget motion picture, television and short-form production work, often produced by individual or small-team so-called “creators”, and often viewed, for example, on YouTube and TikTok. Such “creators” (as opposed to movie and video game studios) who make such short-form productions do not have the means to pay for expensive and unwieldy facial capture apparatuses and the post-production work required to remove them from each frame.

Optical cameras are also limited in the fact that they require visible light to operate. Users in dark locations (e.g., outdoors at night, in a poorly-lit restaurant, in a bedroom where someone else is sleeping, during a dark scene in a movie theater) often do not have the option of capturing their faces optically because there is not enough light for the cameras to operate.

Additionally, high-resolution optical cameras used for facial motion capture typically require significant power to operate. They are typically capturing high-resolution images at 24 frames per second or higher, and this results in a large amount of data that has to be processed either locally or transmitted to another device or to an edge or cloud server to be processed. If processed locally, the large amount of data will consume battery power. If processed remotely the data will utilize a large amount of data bandwidth and will also consume battery power for the transmission.

One motion capture technology that was developed by the assignees of the present invention and was co-invented by an inventor of the present invention is called Contour® Reality Capture and has been offered by MOVA® LLC and its successors-in-interest, which include the assignee of the present invention. MOVA's Contour technology has been often referred to in the market as just “MOVA”. MOVA Contour has been used primarily for high-resolution performance facial capture for movies, commercials and video games, including major motion pictures, such as The Curious Case of Benjamin Button (2008), Harry Potter and the Deathly Hallows, Parts I and II (2010, 2011), Gravity (2013) and many others. In 2009, The Curious Case of Benjamin Button won the Academy Award® for Best Visual Effects for the computer-generated aging of Brad Pitt that used MOVA Contour. Then, in 2015, MOVA Contour technology was awarded a Sci-Tech Academy Award, one of the highest recognitions of both technical and commercial achievement for a visual effects technology.

MOVA Contour (which hereinafter may be referred to as simply Contour) is an optical high-resolution surface capture technology that is described in detail in the Related Patents and Applications listed above. A photograph of one version of the MOVA Contour apparatus is shown in FIG. 3 which is typically used in a dark studio space. (Note that FIG. 3 uses dashed lines so that they are visible on top of the photograph, but the dashes carry no significance.) The apparatus includes a plurality of grayscale and color cameras 304a-304f mounted on a rig 302 constructed of aluminum beams, and the cameras are pointed at the subject to be captured from a wide range of angles, including left, right, side, above, below, and many angles in between. Note that only a fraction of the cameras on one side are identified as 304a-304f, but there are typically 21 cameras or more. Note also, that in many cases a grayscale and color camera are side-by-side to capture from a highly similar angle. The subject is illuminated by alternatingly flashing white lamps and ultraviolet (so called “black light”) lamps 306a-306b, that flash in synchrony with the shutters on the camera. Note that only 2 of the multiple lamps are identified as 306a-306b, but there typically are 4 or more large lamps or dozens of lamps used. The subject surface to be captured (e.g., in this example the face 305 of the subject 301) is typically sprayed using an airbrush (not shown) in a random pattern using a fluorescent makeup that is transparent under white light, but glows under ultraviolet light. Typically, the apparatus is operated by alternating synchronization signals controlling the timing of the camera shutters and the lamps such that (a) in a first state, the white lamps are illuminated and the ultraviolet lamps are shut off (causing the fluorescent makeup to be transparent) and the grayscale camera shutters are closed and the color camera shutters are opened to capture the color of the skin surface of the subject, and (b) in a second state, the ultraviolet lamps are illuminated and the white lamps are shut off (causing the fluorescent makeup to glow) and the color camera shutters are closed and the grayscale camera shutters are opened to capture the random patterns of the glowing fluorescent makeup.

The said synchronization signals alternate the first and second states so rapidly (e.g. 96 frames per second) that the human visual system does not perceive the flashing. The color camera shutters only open during the first state and capture continuous video of the white light-illuminated color (e.g., skin and eye color) of the subject during the performance. The grayscale shutters only open during the second state and capture continuous video of the random pattern of the fluorescent makeup on the performer. Typically, there is a display screen 307 used during the operation of the apparatus that shows one of more windows 307a that show the random pattern captured by one or more grayscale cameras, and one of more windows 307b that show the white lamp illuminated skin surface captured by one or more color cameras. In this way the operator of the apparatus, the performer, and the director of the performance can see that the performer's normal skin surface looks like during the performance and can also confirm the performer's face is being properly captured by the grayscale cameras (e.g., the performer does not move out of range of the cameras or out of the area where they are in focus).

There are variations to the operation of the apparatus. For example, synchronization signals can be configured to leave the white lights on all of the time and also open the grayscale camera shutters, and thus have them capture the white-light illuminated color of the subject during the performance. Also, while the large apparatus shown in FIG. 3, is often used, Contour can also be used with fewer cameras in a head-mounted apparatus such as that shown in FIG. 2.

FIG. 4 shows still frames from a Contour capture and the various stages of capture and processing. The performer 401 has fluorescent makeup sprayed on their face typically by an airbrush and is captured in the apparatus in FIG. 2 or FIG. 3. Image 407b shows the performer's natural skin face texture when captured during an interval when the white lamps are on and the ultraviolet lamps are off. (Note that the performer's natural skin face texture is typically captured in color, but is shown in grayscale in image 407b for the purposes of filing this patent with only grayscale figures.) Image 407a shows the glow of the random pattern of fluorescent makeup that had been sprayed on the performer when captured during an interval when the ultraviolet lamps are on and the white lamps are off.

Contour captures faces at extremely high-resolution (e.g., from 10s of thousands to millions of points) with sub-millimeter precision and, significantly, is able to track each of these points as it moves from frame-to-frame. For example, Contour generates a high-resolution 3D surface mesh of the face for a given initial frame time, with each point on the mesh corresponding to a point on the skin of the actor's face by cross-correlating the random patterns seen from the various camera angles, triangulating the 3D position of each pixel of the camera that sees the same random pattern, and then stitching together the triangulated 3D points into a 3D surface mesh. This 3D surface mesh is shown as the gray surface of the performer's face 408. Note that it is not feasible to spray fluorescent makeup onto some parts of the face, such as the eyes 408a, nostrils 408b, and inner mouth 408c. The Contour system is still able to cross-correlate the natural texture of these surfaces in these non-makeup areas with reasonable precision as shown in FIG. 4. Contour can then be used to create a “Tracked 3D Mesh” 409a at a user-configured resolution that can track the entire face or, as shown with 409a, a portion of the face. This Tracked 3D Mesh is a connected mesh whose vertices (the intersection points shown in the 409a mesh) remained locked to the same point on the performer's face from frame-to-frame, both tracking the motion of smooth surface areas of the skin and areas that deform such as wrinkles around the smile 409c and tendons in the neck 409b. Contour accomplishes this by generating in the next frame time, a 3D surface mesh based on the new position of the random pattern from the motion of the face, and then cross-correlating the random pattern located at the location of vertices in Tracked 3D Mesh 409a in the prior frame with 3D points in the current frame, and then generating a Tracked 3D Mesh for the current frame with new locations for each vertex. When this operation is performed for each successive frame, the result is each vertex of the Tracked 3D Mesh 409a exactly follows the 3D motion of a point on the performer's face.

The user can configure Contour for whatever resolution 3D tracked mesh they require for their needs. For example, Tracked 3D Mesh 410a is much higher resolution than Tracked 3D Mesh 409a, which allows more surface detail to be captured, for example, at points 410b and 410c. For the Tracked 3D Mesh of both resolutions 409a and 410a, each point in the Tracked 3D Mesh moves in 3D space in correspondence with the same point on the skin of the actor's face, whether the user configures Contour for 10,000 points or 1,000,000 points or any other resolution.

As an example, let's consider how Tracked 3D Mesh 409a or 410a tracks the motion of a performer's face. Consider a point on the Tracked 3D Mesh 409a or 410a that corresponds to a particular point on the performer's cheek. Suppose that in the next frame time that point on the cheek moves in x by 1 mm, in y by 0.5 mm, and in z by 0.2 mm, then that point on the Tracked 3D Mesh 409a or 410a generated by MOVA Contour technology will also move that same amount in x, y and z. And, this is true for all of the points in the Tracked 3D Mesh 409a or 410a, whether there are 10,000 points or 1,000,000 points or any other resolution selected by the user. And, as the skin on the performer's face moves in each subsequent frame time, the x, y, z position of each point in the mesh will move by the same amount in each subsequent frame time.

Thus, the Contour Tracked 3D mesh 409a or 410a not only provides a high-resolution 3D mesh that corresponds to the shape of the skin of the actor (a deformable surface), but the points of this high-resolution 3D mesh consistently track the same points on the face from frame-to-frame. This is a capability that prior art facial capture technologies could not do. For example, a projected pattern on the face can be used to determine the 3D shape of the face, but it cannot track the same points from frame-to-frame since the projection will overlap different regions of the skin in subsequent frames as the skin moves. Similarly, many optical facial capture technologies that rely on triangulation between cameras viewing bare skin from different angles suffer from what is known as “drift”, where some or all points in the mesh corresponding to the actor's face do not stay locked to the same points on the skin in subsequent frames.

The reliable tracked mesh provided by Contour is used for many applications, including transforming the actor's face into the face of a creature (e.g., Contour was used to make actors Edward Norton's and Mark Ruffalo's face (playing the part of Bruce Banner) transform into the face of Incredible Hulk in The Incredible Hulk (2008) and The Avengers (2012)), or the face of a different person (e.g., Contour was used to transform actor Emma Watson's face (playing Hermione) into the face of Daniel Radcliffe (playing the part of Harry Potter in Harry Potter and the Deathly Hallows Part I (2010)), or to make an actor look older (e.g., Contour was used to transform Brad Pitt's face (playing the part of Benjamin Button) to an old man's face in The Curious Case of Benjamin Button (2008)). All of this was possible because, as any point in the captured face of the actor moved during the performance, the corresponding point in the 3D tracked mesh moved the same. The Tracked 3D Mesh 409a or 410a was then “retargeted” to the desired new face. For example, the Hulk's face was proportionally larger with exaggerated creature-like features that were very different than those of the actors. Points on the tracked mesh were proportionally transformed in 3D to the position of corresponding features of the Hulk's face. For example, the points around the nostrils of the actor were proportionately transformed in 3D to correspond to the points on the nostrils of the Hulk's face. Then, when the actor's performance caused the Tracked 3D Mesh 409a or 410a to move, for example if the actor flared his nostrils, then the Tracked 3D Mesh 409a or 410a moved with the Hulk's face proportions (e.g., the much larger Hulk nostrils also flared, but proportionately to their larger size). The result is a face that looks like the desired target character (whether a creature, another person, a different age person, or otherwise), but retains the same performance as the actor's performance.

While Contour offers these significant advantages, it is an optical system that relies on cameras and suitable lighting and is impractical to use in many scenarios. There certainly are compromises that can be made with fewer or smaller cameras, but any such compromises will also reduce precision and reliability of the facial capture and the tracked mesh. It would be desirable to develop a solution that does not significantly compromise the precision or reliability of the Contour system, but is practical to use in a larger number of scenarios.

Since the Contour system was developed, there have been other facial capture systems developed that can also capture the faces of actors and generate an accurate tracked mesh. While Contour continues to hold some advantages over these systems, other systems have some advantages themselves. Thus, between Contour and other technologies, the state of the art is such that the surface of the human face can be captured and tracked in 3D with high accuracy as it moves framed to frame, resulting in a tracked mesh whose motion corresponds to the motion of the human face. But, while high accuracy can be achieved by these technologies, none of these technologies is practical to be used in a wide range of scenarios by consumers. For example, none of these technologies is practical and convenient enough to be used during a FaceTime or Zoom call when a user is walking down the street, and while AR, VR, and XR headsets can capture some facial motion, to capture facial motion with the level of accuracy of Contour is not feasible in a consumer-grade headset. Beyond that AR, VR, and XR headsets are generally still quite bulky compared to, for example, conventional sunglasses. And, to the extent such headsets are reduced to the size of conventional sunglasses, cameras attached to such sunglasses-sized headsets will be limited in how much of the face they can view. For example, they cannot view underneath the chin from any part of sunglass-sized headsets. Further, as input devices, cameras typically consume a large amount of power (e.g., in comparison to other wearable input devices like microphones and touch sensors) and transfer large quantities of data during the continuous use required during a video call (e.g., potentially 10s or 100s of megabytes per second) that must be processed, which also consumes a large amount of power. Wearables operate with very limited power budgets. For example, for wearables in the form of conventional sunglasses to be fashionable and comfortable to wear, they must be small and lightweight, constraining them to very small batteries, and for such wearables to be practical, they need to operate long enough between charges to be convenient for typical use cases. For example, if a user uses a wearable during a 1 hour walk or bike ride, they might find it impractical, let alone inconvenient, to recharge during the walk or bike ride. A user who uses a wearable for much or all of the day might accept the inconvenience of periodically recharging the wearable, but the fewer recharge times required, the more useful and convenient the wearable will be. As such, the power consumption required to operate cameras and process data for facial capture is a significant and undesirable burden to a wearable's power budget.

An example of a technology that is practical to use in a large number of scenarios (using prior art for only audio applications) is earphone technology (and similarly, headphone technology). While earphone/headphone technology used for audio applications does not provide any facial capture capability, the apparatus is much less intrusive and more convenient technology than any of the above-mentioned facial capture technologies. Earphones/headphones are available in a wide range of configurations and styles, including in-ear (e.g., Apple AirPods Pro, Google Pixel Buds Pro, etc.), earhooks (e.g., Beats Powerbeats Pro, etc.), over-ear headphones (e.g., Beats Studio Pro, Bose QuietComfort, etc.) and also built into the stems of glasses and sunglasses, such a Bose® Frames and Ray-Ban® Meta® smart glasses. Users are able to use earphones/headphones without holding them in their hands or holding them before their face. Some people now wear earphones all day long, making phone calls, asking audio-based smart assistants to perform tasks or ask questions, and joining in conference calls. Even with small, lightweight batteries, earphones cans operate for many hours without recharge. In contrast, it generally would not be realistic or practical for a user to have a camera pointed at their face all day long, whether using a mobile phone camera or a helmet-mounted apparatus. And, even if very small cameras were embedded within wearables, the continuous power consumption required for facial capture would place a significant load on the small, lightweight wearable batteries.

It would be desirable to have a technology that is practical to use in as many scenarios as earphones, yet provides as good or better facial capture results as Contour.

### SUMMARY

A system and method are described for performing motion capture on a subject by analysis of wireless channel state information. For example, a system according to one embodiment of the invention the 3D motion of the performer is captured during a range of motions (within the confines of one or more prior art motion capture systems) while simultaneously RF energy is repeatedly transmitted in pulses toward the user's face and the channel state information (CSI) resulting from each transmission is measured. The captured 3D position and the measured CSI for each given moment of the capture are stored. The performer then moves freely outside of the confines of the prior art motion capture system, but the RF energy is still repeatedly transmitted in pulses into the user's face and the channel state information (CSI) resulting from each transmission is measured. The measured CSI is then matched to similar previously stored CSI and its associated captured 3D position. This 3D position is then output as the 3D position of the performer outside the confines of the prior art motion capture system.

### BRIEF DESCRIPTION OF THE DRAWINGS

A better understanding of the present invention can be obtained from the following detailed description in conjunction with the drawing, in which:

FIG. 1 illustrates a prior art motion capture system for tracking the motion of a performer's body using retro-reflective markers and cameras.

FIG. 2 illustrates a prior art motion capture system for tracking the motion of a performer's face using head mounted cameras.

FIG. 3 illustrates a prior art motion capture system for tracking the motion of a performer's face and/or body using a rig with cameras and lights in a half-circle around the performer.

FIG. 4 illustrates various stages of facial capture and tracking using the prior art MOVA Contour facial motion capture system.

FIG. 5A illustrates exemplary embodiments of the invention with RF transceivers and antennas incorporated into temple arms, and lights, cameras and microphones used to capture the performance of a subject.

FIG. 5B illustrates exemplary embodiments of the integration of RF transceivers and antennas into temple arms in exemplary embodiments of the invention.

FIG. 5C illustrates exemplary embodiments of the invention with RF transceivers and antennas incorporated into earbuds, and lights, cameras and microphones used to capture the performance of a subject.

FIG. 5D illustrates exemplary embodiments of the invention in which a plurality of diverse subjects are captured.

FIG. 6A illustrates exemplary embodiments of the invention with RF transceivers and antennas incorporated into temple arms of end-user smart glasses.

FIG. 6B illustrates exemplary embodiments of the integration of RF transceivers and antennas into the temples of end-user smart glasses.

FIG. 6C illustrates exemplary embodiments of the integration of RF transceivers and antennas into end-user earbuds.

FIG. 7A-E illustrate exemplary embodiments of the invention wherein Capture Data is captured and placed into one of more capture databases.

FIG. 8A illustrates exemplary embodiments of user onboarding.

FIGS. 8B-C illustrate exemplary embodiments of live facial capture.

FIG. 9A-B illustrate exemplary embodiments of integrated RF transceivers and antennas and their calibration.

FIGS. 9C-D illustrate exemplary embodiments of various RF antenna and signal transmission configurations.

FIG. 10 illustrates exemplary embodiments of RF directional beams from RF transceivers and antenna elements oriented towards a user's head and away from environmental clutter.

FIG. 11 illustrates exemplary embodiments of the reduction in the number of I/Q samples in the time-domain representation of channel state information depending on the maximum operating range required to receive transmissions that contact the user's face.

FIGS. 12A-B illustrate exemplary embodiments of the invention where CSI matching and texture maps and 3D tracked mesh retrieval are performed prior to 3D rendering for two facial expression examples.

FIGS. 13A-B illustrate exemplary embodiments of the invention where CSI matching and texture maps and 3D tracked mesh retrieval are performed prior to retargeting and 3D rendering for two facial expression examples.

FIG. 14 illustrates exemplary embodiments of the invention where RF CSI captured with transceivers and antennas integrated into wearable smart glasses is used to infer expression labels that trigger actions in downstream hardware or software subsystems.

FIG. 15 illustrates exemplary embodiments of how a pose classifier model is used to automatically extend each Frame Data Record in a capture database with an inferred class label.

FIG. 16 illustrates exemplary embodiments of the training of an RF CSI classification machine learning model to infer facial expression labels from RF CSI.

FIG. 17 illustrates exemplary embodiments of the invention that uses a trained multi-domain translation model to map live captures of RF CSI from transceivers and antennas integrated in a wearable device onto user avatar views.

FIG. 18 illustrates exemplary embodiments of the training of the multi-domain translation model used in exemplary embodiments of the invention.

FIG. 19 illustrates exemplary embodiments of the invention where the input to the trained multi-domain translation model is a plurality of time-sequential input feature vectors.

FIG. 20 depicts exemplary embodiments of the invention that uses an RF CSI embedding model, a CSI and pose vector database, and an embedding matching and pose retrieval unit to map live captures of RF CSI from transceivers and antennas integrated in a wearable device onto user avatar views.

FIG. 21 illustrates exemplary embodiments of a pre-trained embedding model used to automatically extend each RF CSI and pose data entry in a data repository with an RF CSI embedding vector.

FIG. 22 illustrates how the embedding model in exemplary embodiments of the invention is constructed and trained.

FIG. 23 depicts exemplary embodiments of the invention that uses a trained CSI encoder and a pre-trained face image generator to map live captures of RF CSI from transceivers and antennas integrated in a wearable device onto user avatar views.

FIG. 24 illustrates exemplary embodiments of training of the CSI encoder by shaping its output to the output of pre-trained face image encoder part of a pre-trained face image encoder/generator pair.

FIG. 25 illustrates exemplary embodiments of the invention that uses an expression CSI encoder, and the output of a pre-trained identity face image encoder from an identity face image input to map live captures of RF CSI from transceivers and antennas integrated in a wearable device onto user avatar views.

FIG. 26 illustrates exemplary embodiments of training the expression CSI encoder jointly with an identity CSI encoder by shaping their joint output to the disentangled identity-expression output of a pre-trained facial identity image and pre-trained facial expression image encoder pair.

FIG. 27 depicts exemplary embodiments of the invention where a conjunction of live captures of RF CSI from transceivers and antennas integrated in a wearable device together with other environmental and user-provided contextual inputs are used to generate a tracking user avatar view.

FIG. 28 illustrates exemplary embodiments of the invention where the RF transceivers and antennas are integrated in a wearable device that is connected to a data center and other user devices through a user mobile device on a Public Land Mobile Network to implement distribution of data ultimately rendered in the form of avatar views with the live expression of the user operating the wearable device.

FIG. 29 illustrates exemplary embodiments of the invention where the RF transceivers and antennas are integrated in a wearable device that is connected to a data center and other user devices through a Public Land Mobile Network to implement the distribution of data ultimately rendered in the form of avatar views with the live expression of the user operating the wearable device.

FIG. 30 illustrates exemplary embodiments of the invention where the RF transceivers and antennas are integrated in a wearable device that is connected to a data center and other user devices through home networking devices to implement the distribution of data ultimately rendered in the form of avatar views with the live expression of the user operating the wearable device.

FIG. 31 shows a flow chart that illustrates the process of maintaining and deploying an embodiment of the facial capture system using CSI in exemplary embodiments of the invention.

FIG. 32 shows a flow chart that describes events on a user's end when they turn on the wearable device in exemplary embodiments of the invention.

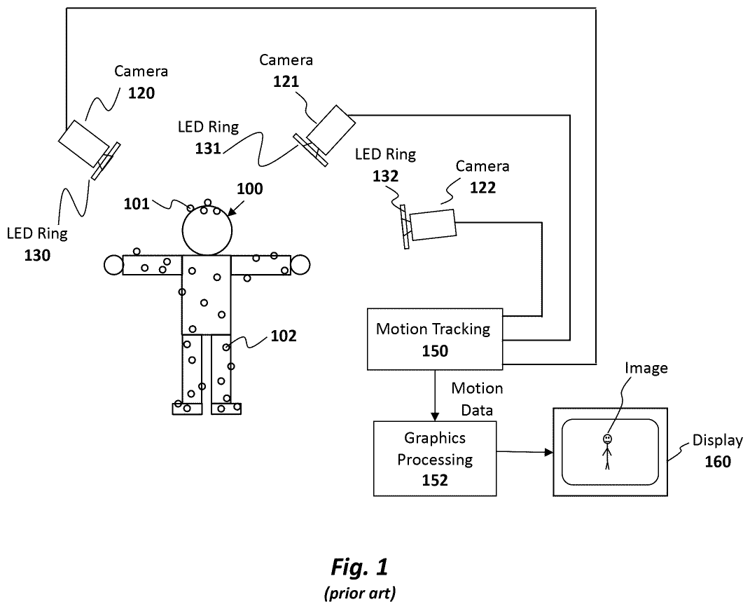

### DETAILED DESCRIPTION OF PREFERRED EMBODIMENTS

Wearable devices, such as Apple AirPods Pro, Google Pixel Buds Pro earphones; Bose Frames, XReal®, and Ray-Ban Meta smart glasses; and Meta Quest® and Apple Vision Pro augmented reality (“AR”) and virtual reality (“VR”), collectively “XR”, are increasingly coming into wider use, supporting increasingly more advanced features that both augment and replace capabilities previously only available on smartphones, tablets, laptops, desktop computers, and videogame consoles. Among these capabilities are videoconferencing and facial capture for XR 3D avatars. Wearable devices typically are extremely small and lightweight, but nonetheless typically require reasonably long battery life to be useful. As a result, it is essential to minimize wearable weight and power consumption. Capturing a user's face in real-time for videoconferencing and high-resolution facial capture for 3D avatars typically requires at least one high-resolution video camera pointed at the user's face. This is challenging for a wearable device for several reasons: (a) earbuds at best have oblique views of the side of the face, and smart glass or XR headsets have very limited oblique views of the parts of the face around the smart glasses or XR headsets (e.g., they have no view of the underside of the chin); (b) using video cameras to capture facial expressions consumes a large amount of power (potentially hundreds of milliwatts), impacting wearable battery life; and (c) wearables are often used in environments with poor lighting, limiting the effectiveness of video cameras in capturing the face. There is a strong need for a facial capture solution for wearable devices that does not require a view of the face, is very lightweight and very low power, and operates in poor lighting or even in total darkness.

Described below are systems and methods for performing facial capture where, in an exemplary embodiment, there are one or a plurality of human subjects, each of which perform a wide range of facial expressions before one or a plurality of cameras recording successive frames of images while one or a plurality of radio frequency (“RF”) transceivers and antennas, synchronously with the camera frame rate, transmit sounding reference signals (“SRS”) that contact the subject's face, and then are received by one or a plurality of the RF transceivers and antennas. A processor estimates channel state information (“CSI”) from the received SRS waveform(s). The same or different processor uses the image(s) captured by the one or plurality of cameras to derive one or more texture maps and/or 3D tracked meshes of subject's face. For each frame, the CSI and texture maps and/or 3D tracked meshes are stored in a capture database for each subject, which in turn are stored in a capture database for a plurality of subjects. The capture databases for each subject are used to train a base machine learning model to associate for each captured frame received CSI with the texture maps and 3D tracked meshes of a subject's face. Next, wearable devices, such as smart glasses, integrate RF transceivers and antennas, for example, in the temples of the smart glasses. To onboard a new user, the user wears the smart glasses while they use the camera of their smartphone (or computer) to observe their face as they perform a variety of facial expressions while the RF antennas and receivers transmit SRS waveforms that contact the user's face. A processor in the smart glasses (or in a connected smartphones, computer or data center) estimates the CSI for each frame and associates it with the recorded facial expression in a refined capture database, which is used to refine the base machine learning model. After this, the user wears the smart glasses (without any camera pointed at their face) and as they perform facial expressions, for example, in a videoconference. The RF antennas and receivers transmit SRS waveforms that contact the user's face, and a processor in the smart glasses (or in a connected smartphones, computer or data center) estimates the CSI and infers a texture map and/or 3D tracked mesh that corresponds to the user's expression, and from this generates a 2D image or a 3D tracked mesh of the user's face showing that expression. The smart glasses continue to do this each frame time, resulting in a live 2D video and/or a live 3D avatar of what the user's face looks like during each frame time. The 3D avatar can be seen in a shared virtual space from any angle, and the tracked mesh of the user's face can be retargeted using 3D processing to look older, younger, or as a different person or character altogether, while still reflecting the fine details of the user's facial expression.

The systems and methods described in the prior paragraph overcome the aforementioned problems wearables face in performing facial capture, including (a) the RF transceivers and antennas do not need to have a view of the user's face because the radio waves propagate through and around the face, (b) the RF transceivers and antennas are very small and lightweight, and they consume very little power, 1 milliwatt or less, and (c) the system and methods works in any lighting conditions, including complete darkness, since radio waves, not light, are used to capture the face.

Described below is systems and methods for performing facial and motion capture on a subject by analysis of wireless CSI. In the following description, for the purposes of explanation, numerous specific details are set forth in order to provide a thorough understanding of the present invention. It will be apparent, however, to one skilled in the art that the present invention may be practiced without some of these specific details. In other instances, well-known structures and devices are shown in block diagram form to avoid obscuring the underlying principles of the invention.

The assignee of the present application previously developed systems and methods for performing color-coded motion capture and a system for performing motion capture using a series of reflective curves painted on a performer's face. These systems are described in the previously filed applications entitled “APPARATUS AND METHOD FOR CAPTURING THE MOTION AND/OR EXPRESSION OF A PERFORMER,” Ser. No. 10/942,609, Filed Sep. 15, 2004, and U.S. Pat. No. 8,194,093 issued Jun. 5, 2012. These applications/patents are assigned to the assignee of the present application and are incorporated herein by reference.

The assignee of the present application also previously developed systems and methods for performing motion capture of random patterns applied to surfaces. This system is described in the previously filed patent entitled “APPARATUS AND METHOD FOR PERFORMING MOTION CAPTURE USING A RANDOM PATTERN ON CAPTURE SURFACES,” U.S. Pat. No. 8,659,668, issued Feb. 25, 2014. This patent is assigned to the assignee of the present application and is incorporated herein by reference.

The assignee of the present application also previously developed systems and methods for performing motion capture using shutter synchronization and phosphorescent paint. This system is described in the previously filed patent entitled “APPARATUS AND METHOD FOR PERFORMING MOTION CAPTURE USING SHUTTER SYNCHRONIZATION,” U.S. Pat. No. 7,605,861, issued Oct. 20, 2009 (hereinafter “Shutter Synchronization” application). Briefly, in the Shutter Synchronization application, the efficiency of the motion capture system is improved by using phosphorescent paint or makeup and by precisely controlling synchronization between the motion capture cameras' shutters and the illumination of the painted curves. This application is assigned to the assignee of the present application and is incorporated herein by reference.

The assignee of the present application also previously developed systems and methods for performing motion capture using infrared (“IR”) makeup. This system is described in the previously filed application entitled “SYSTEM AND METHOD FOR PERFORMING MOTION CAPTURE AND IMAGE RECONSTRUCTION WITH TRANSPARENT MAKEUP,” Ser. No. 12/455,771, filed Jun. 5, 2009 (hereinafter “IR Makeup” application). Briefly, in the IR Makeup application, the efficiency of the motion capture system is improved by using paint or makeup that emits IR light. This application is assigned to the assignee of the present application and is incorporated herein by reference.

The assignee of the present application also previously developed systems and methods for wireless communications that precisely tracks the concurrent positions of multiple antennas in space using RF feedback and channel state information. This system is described in previously filed applications listed in “Related Patent and Applications”, and it has been commercially introduced as Artemis® pCell® technology, which is described at www.artemis.com, and www.artemis.com/pcell. Further, certain aspects of the technology have been described in the academic paper, A. Forenza, S. Perlman, F. Saibi, M. Di Dio, R. van der Laan and G. Caire, “Achieving large multiplexing gain in distributed antenna systems via cooperation with pCell technology,” 2015 49th Asilomar Conference on Signals, Systems and Computers, 2015, pp. 286-293, doi: 10.1109/ACSSC.2015.7421132. Other aspects of the technology have been described in the White Paper, S. Perlman, et al. “An Introduction to pCell”, Feb. 24, 2015, available at http://www.rearden.com/artemis/An-Introduction-to-pCell-White-Paper-150224.pdf. In addition to discussing communications applications, the White Paper also discusses tracking the position of user devices in motion in section 6.6, Location Positioning, and it further discusses tracking head motion, for example, in virtual reality applications, in section 7.2.1 pCell VR. There are large number of embodiments of pCell technology, but briefly, in exemplary embodiments, each of a plurality of user devices distributed through a pCell Radio Access Network (“RAN”) coverage area simultaneously uplink a sounding reference signal (“SRS”) in the same frequency band (e.g., 20 MHz), then a plurality of pCell RAN base transceiver stations (“BTSs”) receive the overlapping SRSs, and communicate the overlapping SRSs to a central processor (“CP”) that exploits reciprocity to determine the channel state information (“CSI”) at the location of each user device, and then uses that CSI to precode a plurality of downlink baseband waveforms, which are then simultaneously transmitted in the same frequency band. The precoding results in the summation of all the RF downlink transmissions arriving at a given user device location such that it is the waveform intended for that user device, while simultaneously the summation of all of the signals at the location of each other user device is the waveform intended for each other user device. In this way, all user devices are able to concurrently receive data transmissions utilizing the full bandwidth of the spectrum, thus multiplying the spectral efficiency of the spectrum by the number of concurrent user devices. In actual commercial deployments, pCell supports 29 or more concurrent user devices, all utilizing the full capacity of the channel at once, but there is no inherent upper limit to the number of concurrent user devices. As the user devices move, the user devices continue to uplink SRS signals periodically (e.g., every 5 milliseconds (msec)), which are received by the BTSs, and processed by the CP, such that the CSI to each user device is continuously recalculated with the latest CSI used for precoding the downlink transmissions. The CSI of a user device changes even in the event of sub-millimeter motion. As such, user devices in motion continue to concurrently each receive independent downlink data transmissions that can utilize the full bandwidth of the spectrum. The pCell patents in the Related Patent and Applications are assigned to the assignee of the present application and are incorporated herein by reference.

### System Overview

As described in the Related Patents and Applications, as well as in other prior art disclosures, the MOVA Contour facial capture technology (and other facial capture technologies) can capture a very high-resolution tracked mesh of the human face as it moves from frame-to-frame with sub-millimeter precision.

Also as described in the Related Patents and Applications, and at the Artemis pCell website at www.artemis.com, and www.artemis.com/pcell, and in the academic paper, A. Forenza, S. Perlman, F. Saibi, M. Di Dio, R. van der Laan and G. Caire, “Achieving large multiplexing gain in distributed antenna systems via cooperation with pCell technology,” 2015 49th Asilomar Conference on Signals, Systems and Computers, 2015, pp. 286-293, doi: 10.1109/ACSSC.2015.7421132, and in the White Paper, S. Perlman, et al. “An Introduction to pCell”, Feb. 24, 2015, available at http://www.rearden.com/artemis/An-Introduction-to-pCell-White-Paper-150224.pdf, the Artemis pCell wireless technology can concurrently determine the CSI of a plurality of user devices at a plurality of locations in space and periodically determine the CSI of the plurality of user devices as they move in space, determining new CSI even if the user device motion is sub-millimeter.

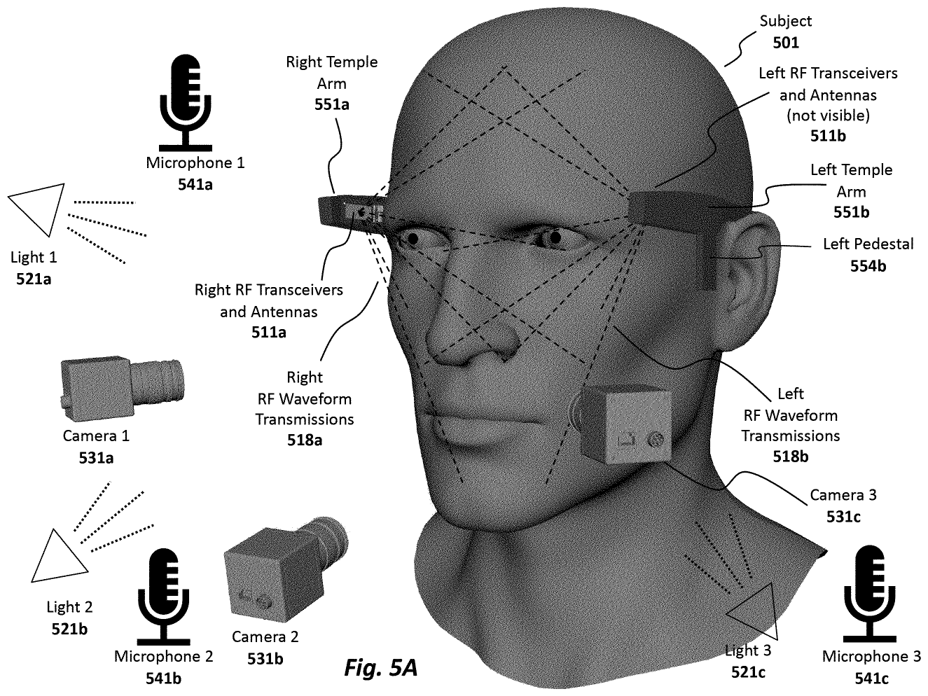

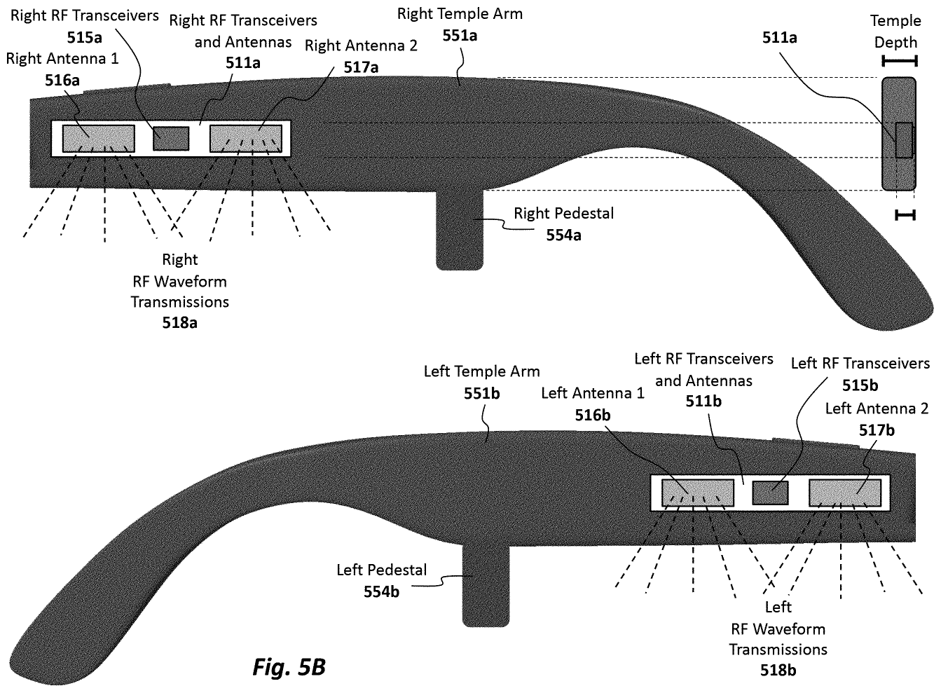

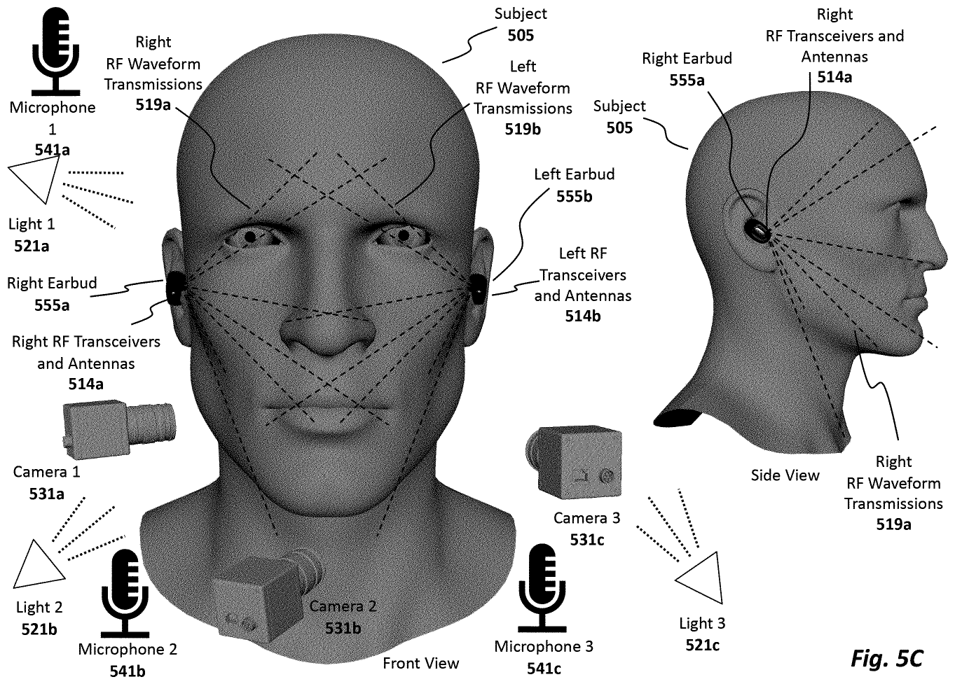

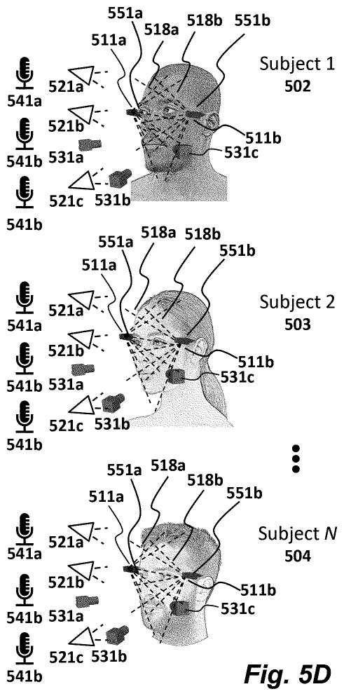

FIG. 5A shows the head of a human subject 501. For purposes of illustration the subject is shown as a hairless smooth-shaded 3D-modeled head with few distinctive features, but a real human subject 501 could be any human subject with any manner of facial characteristics, including but not limited to gender, age, size, and facial features, including but not limited to eye color, nose shape, jaw shape, facial hair, wrinkles, scars, lip types, facial piercings, teeth, tongue, moles, freckles, birthmarks, and abnormalities, including but not limited to a cleft lip or palate and facial palsy. The face of subject 501 shall refer to any human subject with any combination of facial characteristics.

Although FIG. 5A illustrates subject 501 from the shoulder or neck up, the invention described herein is not limited to only these parts of the body, but rather is operable with any part of the subject 501 anatomy including, but not limited to, face, eyeballs, head, hair, ears, lips, inner mouth, teeth, tongue, nostrils, jaw, neck, shoulders, chest, breasts, torso, genitals, buttocks, arms, hands, fingers, legs, feet, toes, body modifications such as piercings, tattoos, scarification, and prostheses, as well all joints and deformable parts of the body. All parts of the subject 501 anatomy shall be referred to collectively as “Subject Anatomy”.

In exemplary embodiments there is a single artificial light 521a (artificial lights are referred to as “lights” herein unless otherwise qualified) illuminating the Subject Anatomy. In exemplary embodiments there are multiple lights illuminating the Subject Anatomy, of which only three are illustrated in FIG. 5A as 521a-c, but each is intended to represent any number of multiple lights illuminating the Subject Anatomy, from a single angle or from multiple angles. Multiple lights 521a-c from multiple angles provides for more uniform illumination on all surfaces of the subject 501 than a single light 521a as well as enabling more variations of lighting and shadows on the surfaces of subject 501.

In exemplary embodiments the one or multiple lights 521a-c are the same color and brightness. In exemplary embodiments the one or multiple lights 521a-c are of different colors and/or brightnesses. In exemplary embodiments the colors of lights 521a-c include non-visible light colors including but not limited to infrared and ultraviolet wavelengths.

In exemplary embodiments the colors of lights that are illuminated for a given Frame Time (defined below) are changed during one or more different Frame Times to have different lights illuminated and/or different visible and/or non-visible colors illuminated and/or have different brightnesses and/or have some or all lights not illuminated.

In exemplary embodiments the one or multiple lights 521a-c illuminate the Subject Anatomy using structured light, wherein a specific pattern of light is projected onto the Subject Anatomy. In exemplary embodiments the one or multiple lights 521a-c illuminate the Subject Anatomy through an optically opaque or translucent object which optically alters the projected light such as, including but not limited to, a pattern, grating, image, film, mask, wave guide, diffractor or polarizer. In exemplary embodiments, the one or multiple lights 521a-c are phase coherent.

In exemplary embodiments one or more of the lights 521a-c are of a type including, but not limited to, light-emitting diodes (LEDs); lasers; light detection and ranging systems (LiDARs), fluorescent, xenon, argon, or neon lamps; and incandescent lamps. In exemplary embodiments one or more of the lights 521a-c are natural light sources including, but not limited to, sunlight, moonlight, and starlight.

In exemplary embodiments the one or multiple lights 521a-c change state (wherein state includes, but is not limited to, color, brightness, projected pattern, polarization, and phase) synchronously with at least one of (a) images from at least one of the one or multiple cameras 531a-c (discussed in detail below), (b) the radio frequency (RF) or baseband waveforms from at least one of the one or multiple RF transceivers and antennas 511a-b (discussed in detail below), and/or (c) the audio waveforms from at least one of the one or multiple microphones 541a-c (discussed in detail below).

In exemplary embodiments, the apparatus and methods capture one or more 2D images and/or 3D shapes of part or all of the Subject Anatomy using one or multiple cameras 531a-c. In exemplary embodiments there is a single camera 531a, capturing still images or video of part or all of the Subject Anatomy. In exemplary embodiments there are multiple cameras capturing still images or video of part or all of the Subject Anatomy, of which only 3 are illustrated in FIG. 5A as 531a-c. The 3 cameras 531a-c represent either one or any number of multiple cameras, potentially capturing still images or video of part or all of the Subject Anatomy from the same angles or from different angles. Multiple cameras 531a-c provide for better coverage of more surfaces of subject 501 than a single camera 531a and allow more surfaces of subject 501 to be captured without being obstructed by facial features (e.g., by the nose or chin). Also, multiple cameras 531a-c that have overlapping views of the surface of subject 501 allow for triangulation to determine the 3 dimensional (x, y, z) position of points on the surface of subject 501. Multiple cameras 531a-c that have overlapping views of the surface of subject 501 can also have their views aligned and constructively combined to provide more dynamic range and reduce noise in the images.

In exemplary embodiments the one or multiple cameras 531a-c are grayscale and/or color cameras. In exemplary embodiments the one or multiple cameras 531a-c are sensitive to non-visible light wavelengths including but not limited to infrared and ultraviolet wavelengths.

In exemplary embodiments the one or multiple cameras 531a-c are cameras with features including, but not limited to, a global shutter, a rolling shutter, no shutter, a semiconductor sensor, a complementary metal-oxide semiconductor (CMOS) sensor, and/or a charge-couple device (CCD) sensor.

In exemplary embodiments the multiple cameras 531a-c utilize the same or different lens types, including but not limited to, with the same or different focal length, with the same or different aperture openings; a pinhole aperture; a coded-aperture imaging aperture such as that described in U.S. Pat. No. 7,767,949; and/or a diffraction-coded imaging aperture such as that described in U.S. Pat. No. 10,488,535.

In exemplary embodiments the one or multiple cameras 531a-c capture images of part or all of the Subject Anatomy in a given Frame Time synchronously with one or multiple lights 521a-c that are providing specific illumination characteristics during that Frame Time including, but not limited to, using visible or non-visible colors and wavelengths; illuminating with a particular brightness level or not illuminating at all; projecting a particular pattern or not; using a particular polarization or not; using time-of-flight measurement or not; and/or using phase coherent radiation or not. In exemplary embodiments, during certain different Frame Times, the one or multiple lights 521a-c provide different specific illumination characteristics including, but not limited to, those listed in above in this paragraph.

In exemplary embodiments the one or multiple cameras 531a-c capture images of part or all of the Subject Anatomy in a given Frame Time synchronously with at least one of (a) at least one of the other one or multiple cameras 531a-c; (b) the radio frequency (RF) or baseband waveforms from at least one of the one or multiple RF transceivers an antennas 511a-b (discussed in detail below), and/or (c) the audio waveforms from at least one of the one or multiple microphones 541a-c (discussed in detail below).

In exemplary embodiments, the apparatus and methods use one or multiple RF transceivers and antennas 511a-b to capture RF channel state information (“CSI”) from transmitted RF waveforms 518a-b after the RF waveforms have contacted part or all of the Subject Anatomy. In exemplary embodiments there is a single RF transceiver 511a with a single antenna transmitting RF waveform 518a and receiving them after the RF waveform has contacted part or all of the Subject Anatomy. In exemplary embodiments there are multiple RF transceivers and/or antennas (of which only two such units are illustrated in FIG. 5A as 511a-b, but each RF transceivers and antennas 511a-b is intended to represent any number of RF transceivers and/or any number of antennas). In exemplary embodiments the RF transceivers and antennas transmit multiple RF waveforms 518a-b that contact the Subject Anatomy from the same angles or from different angles and/or from the same locations or different locations, and/or receive RF waveforms 518a-b that have made contact with the Subject Anatomy from the same angles or from different angles from the same locations or different locations. In exemplary embodiments some or all of the RF transceiver and antennas of each 511a-b are both used for transmission and reception. In exemplary embodiments some or all of the RF transceivers and antennas of each 511a-b are used for only one of transmission or reception.

RF transceivers and antennas 511a-b can be transmitting and/or receiving RF waveforms 518a-b to/from multiple different angles and/or locations thus increasing the number of independent CSI dimensions that capture the effect of the different physical configurations of a user 501-505 Head Structures on RF waveforms. This increase in the amount of CSI information creates a robust (with respect to noise disturbances) one-to-one mapping between the manifold of facial expressions encoded in the physical configurations of user 501-505 Head Structures and the set of CSI measurements.

The antennas in RF transceivers and antennas 511a-b can be arranged in ways such that they form arrays or other arrangements that transmit and receive SRS synchronously, coherently, and cooperatively to effectively create steerable beams or other interference patterns adapted to the probing of user 501-505 Head Structures thus improving the signal-to-noise ratio of the received SRS and rejecting confounding SRS transformations unrelated to the physical configurations of Head Structures that encode user 501-505 facial expressions. In exemplary embodiments, the term “sounding reference signal” or “SRS” as used herein refers, without limitation, to any RF waveform that is defined at the time of transmission and is repeatable, and typically, without limitation, are radar transmissions.

The location of the one or more RF transceivers and antennas 511a-b can be located anywhere on a device attached to subject 501, or not attached to subject 501, that enables the RF transceivers and antennas 511a-b to transmit right and left RF waveforms 518a-b that come in contact with the subject 501. In the embodiment shown in FIGS. 5A-B, the RF transceivers and antennas 511a and 511b are located embedded within the left and right temple arms 551a-b, respectively, that are similar to the right and left temples of a pair of glasses, but without the rims spanning between them. In exemplary embodiments, right and left pedestals 554a-b in FIG. 5B provide mechanical support for the right and left temple arms 551a-b so they can extend forward without the rims held up by the nose spanning between them, but any method of mechanical support for the right and left temple arms including, but not limited to, clips on the ears and headbands around the head will work as well. Only left pedestal 554b is visible in FIG. 5A. The right and left temple arms 551a-b with right and left pedestals 554a-b are just one embodiment of a device that attaches to subject 501 and incorporates RF transceivers and antennas 511a-b. Any device with a means to attach to subject 501, or not attach to subject 501, that enables the RF transceivers and antennas 511a-b to transmit right and left RF waveforms 518a-b that come in contact with the subject 501, are additional embodiments of the apparatus and methods described herein.

FIG. 5B illustrates close-up views of the right and left temple arms 551a-b. In exemplary embodiments illustrated in FIGS. 5A-B, the RF transceivers and antennas 511a-b are small enough to fit within the width, height and depth dimensions of left and right temples arms 551a-b. The example temple arms illustrated are similar in size to temples of existing glasses frames, such as Ray-Ban Wayfarer® frames for glasses and sunglasses and Ray-Ban Meta Wayfarer smart glasses.

In exemplary embodiments, the RF transceivers and antennas 511a-b are modules that include, but are not limited to, two right RF transceivers 515a, each one coupled to, respectively right RF antenna 516a and 517a, and two left RF transceivers 515b, each one coupled to, respectively left RF antenna 516b and 517b. The right RF transceivers 515a transmit through antennas 516a and 517a RF waveforms 518a toward the head and/or face of subject 501, and the left RF transceivers 515b transmit through antennas 516b and 517b RF waveforms 518b toward the head and/or face of subject 501 from the opposite side of the head. The right and left RF transceivers 515a-b receive RF waveforms from the same antennas 516a-b and 517a-b that they transmitted from or from different antennas than they transmitted from. The RF waveforms received by a given one of the transceivers 515a-b may come from its own transmissions or from the transmissions of the other transceivers 515a-b. Although 4 RF transceivers and antennas are illustrated in this embodiment, there may be only one transceiver and antenna 511a, or any number of multiple transceivers and antennas 511a-b, including but not limited to 10 or 100 transceivers and antennas.

The RF transceivers and antennas 511a-b can be located in other locations, either alternatively or in addition to the temple arms 551a-b, including but not limited to locations on glasses frames worn by subject 501, including but not limited to either rim, and/or either the endpieces/hinges. In exemplary embodiments, the RF transceivers 515a and 515b are separated from their respective antennas 516a-517a and 516b-517b which are located at another location through one or more RF couplings, including, but not limited to coaxial cables and printed circuit board traces. In exemplary embodiments these RF connections are coupled to the RF transceivers and RF antennas with an impedance that matches that of the RF transceiver's RF output and/or RF input.

In different embodiments the RF transceivers and antennas 511a-b transmit in bandwidths ranging from sub-kilohertz to multi-gigahertz in bandwidth, using carrier frequencies ranging from hundreds of kilohertz to thousands of gigahertz. The RF transmissions may be in continuous blocks of spectrum, or an aggregation of multiple blocks of spectrum. Commercial implementations of these various embodiments typically would observe rules set up by regulatory agencies such as the Federal Communications Commission (“FCC”) for RF transmissions. For use in licensed spectrum, typically there would be permission obtained from the spectrum licensee and/or an experimental license from the regulatory agency. For use in unlicensed or shared spectrum, such as, but not limited to, the 900 MHZ, 2.4 GHz, and 5 GHz industrial, scientific, and medical (“ISM”) bands; and the 3.5 GHz Citizen's Band Radio Service (“CBRS”) band, the rules and protocols of such bands typically would be followed. For Ultra-Wideband (“UWB”) use, the transmission typically would follow the rules and protocols for UWB. For products used internationally, the transmissions must limit use of unlicensed and shared spectrum to what is permitted in the countries in which the product is used. For example, while the 900 MHz ISM band is available for unlicensed use in the United States, it is not available for unlicensed use in many other countries in the world. Embodiments must also adhere to applicable human RF exposure limits in the country where they are used to ensure safe operation.

In exemplary embodiments, the apparatus and methods use one or multiple RF transceivers and antennas 511a-b to capture RF channel state information (“CSI”) from transmitted RF waveforms 518a-b after the RF waveforms have made contact with part or all of the Subject Anatomy in the same given Frame Time as at least one of the following: (a) at least one of the RF waveforms 518a-b from at least one of the other one or more RF transceivers or antennas 511a-b is transmitted and comes into contact with the Subject Anatomy and is received; (b) one or more images is captured from at least one of the one or multiple cameras 531a-c; (c) at least one of the one or multiple lights 521a-c is either illuminated or not illuminated, or (d) the audio waveforms from at least one of the one or multiple microphones 541a-c are captured (discussed in detail below). In exemplary embodiments the channel state information or “CSI” are a set of numerical values that characterizes the action of a RF channel on a transmitted RF waveform, for example, without limitation, an SRS transmission.

In exemplary embodiments, the apparatus and methods capture one or more audio waveforms of, including, but not limited to, speech, vocalizations and other sounds produced by the subject 501 using one or multiple microphones 541a-c. In exemplary embodiments there is a single microphone 541a capturing sounds produced by the subject 501. In exemplary embodiments there are multiple microphones (of which only 3 are illustrated in FIG. 5A as 541a-c, and the 3 microphones represent one or any number of multiple microphones, capturing audio from the same location or from multiple locations). In exemplary embodiments the one or multiple microphones 541a-c are attached to a subject 501 or the subject's clothing. In exemplary embodiments the one or multiple microphones 541a-c are not attached to a subject 501 or the subject's clothing. In exemplary embodiments some microphones 541a-c are attached to a subject 501 or the subject's clothing and some are not.

In exemplary embodiments the one or multiple microphones 541a-c have different characteristics including, but not limited to, directionality (e.g., one or more are directional or omni-directional) and frequency response.

In exemplary embodiments the one or multiple microphones 541a-c are part of a spatial sound system including, but not limited to, 5.1 surround sound, 7.1 surround sound, Dolby® Atmos® and/or THX®. In exemplary embodiments the ambient audio characteristics of the capture environment is measured.

In exemplary embodiments the one or multiple microphones of each 541a-c capture audio in a given Frame Time synchronously with at least one of (a) the audio waveforms from at least one of the other one or multiple microphones 541a-c; (b) the images captured by at least one of the one or multiple cameras 531a-c; (c) the radio frequency (RF) or baseband waveforms transmitted or received from at least one of the one or multiple RF transceivers 511a-b, and/or (d) the multiple lights 521a-c being illuminated, changed, or not illuminated.

In exemplary embodiments, one or more of the previous described embodiments is used to capture at least one of camera images, audio waveforms, and RF waveforms 518a-b from subject 501, by one or more of (a) illuminating part or all of the Subject Anatomy by natural light, ambient light, or one or more of multiple of lights 521a-c; (b) capturing one or more of images of part or all of the Subject Anatomy by at least one of the one or multiple cameras 521a-c; (c) capturing the radio frequency (RF) or baseband waveforms from at least one of the one or multiple RF transceivers and antennas 511a-b to capture RF channel state information (“CSI”) from transmitted RF waveforms 518a-b after the RF waveforms have made contact with part or all of the Subject Anatomy; and (d) capturing audio waveforms from at least one of the one or multiple microphones 541a-c that is spoken or vocalized by, or a sound created by, the subject 501.

In exemplary embodiments illustrated in FIG. 5C subject 505 is wearing right and left earbuds 555a-b that incorporate right and left RF transceivers and antennas 514a-b to transmit and receive right and left RF waveforms 519a-b. A front view and side view of subject 505 is shown in FIG. 5C. The lights 521a-c, cameras 531a-c, and microphones 541a-c in FIG. 5C correspond to the same devices with the same numbers as FIG. 5A and have the same function and purpose, and the only difference between FIGS. 5A and 5C is that the RF transceivers and antennas 511a-b incorporated into right and left temple arms 551a-b of FIG. 5A are replaced by right and left transceivers 514a-b incorporated into right and left earbuds 555a-b of FIG. 5C.

In exemplary embodiments, the RF transceivers and antennas 511a-b incorporated into right and left temple arms 551a-b of FIG. 5A are replaced by right and left transceivers 514a-b incorporated into right and left earbuds 555a-b of FIG. 5C, and one or more of the previous described embodiments is used to capture at least one of camera images, audio waveforms, and RF waveforms 519a-b from subject 505 instead of subject 501, by one or more of (a) illuminating part or all of the Subject Anatomy of subject 505 by natural light, ambient light, or one or more of multiple of lights 521a-c; (b) capturing one or more of images of part or all of the Subject Anatomy of subject 505 by at least one of the one or multiple cameras 531a-c; (c) capturing the radio frequency (RF) or baseband waveforms 519a-b from at least one of the one or multiple RF transceivers and antennas 514a-b to capture RF channel state information (“CSI”) from transmitted RF waveforms 519a-b after the RF waveforms have made contact with part or all of the Subject Anatomy of subject 505; and (d) capturing audio waveforms from at least one of the one or multiple microphones 541a-c that is spoken or vocalized by, or a sound created by, the subject 505.

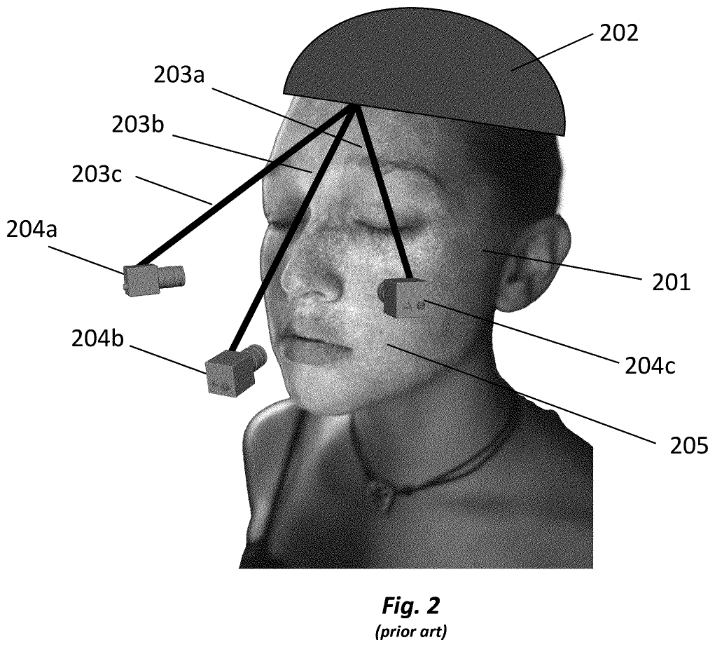

FIGS. 5A-C illustrate exemplary embodiments where right and left temple arms 551a-b and right and left earbuds 555a-b incorporate RF transceivers and antennas 511a-b and 514a-b, respectively, but this invention is not limited to temple arms 551a-b and earbuds 555a-b to support RF transceivers and antennas. Any structure or device on or near the body of the subject can be used to hold one or any number of RF transceivers and antennas, both with the transceivers and antennas near one another and with them separated from each other with a coupling including, but not limited to, coaxial cable and printed circuit board traces between the RF transceivers and antennas. The structure or devices include, but are not limited to, any manner or ear attachments including headphones, earphones, ear cuffs, hearing aids, over the ear hooks, in ear devices, and devices attached by piercings; any manner of glasses, smart glasses, monocles, goggles, and virtual reality or augmented reality goggles or glasses; any manner of contact lens or other device attached to one or both eyes; any matter of nose attachment; any manner of piercing; any manner of hat, cap, helmet, visor; headband, hair clip; any support extensions mounted to the body, including those illustrated in FIG. 2; attachments to the limbs and digits including but not limited to wrist and ankle bands, bracelets, necklaces, finger and toe rings; any matter of garment, suit, or undergarment; any manner of shoe or glove; microphones and cameras, whether attached to the body or not; phones, smartphones, watches and smart watches; pendants attached to clothing or the body; and/or subcutaneous devices.

For the sake of illustration, subjects 501 and 505 are shown in FIGS. 5A and 5C as a grayscale hairless and largely featureless male head. Actual subjects 501 and 505 are humans with every kind of different characteristic, including but not limited to those listed above, and in this paragraph. FIG. 5D shows the heads of three example subjects 502-504 with different characteristics that include but are not limited to gender, facial hair and scalp hair. Subject 502 is a Black male with facial hair and very short hair in tight curls. Subject 503 is an Asian female with no facial hair and long straight hair. Subject 504 is a white male with facial hair and curly hair on top and short cut hair on the side. Each subject 502-504 is illustrated as being captured by the same apparatus illustrated in FIG. 5A. Each subject 502-504 has right and left RF transceivers and antennas 511a-b incorporated into a right and left temple arms 511a-b, respectively, transmitting and receiving right and left RF waveforms 518a-b, respectively, that come into contact with the Subject Anatomy of each subject 502-504. Each subject 502-504 has one or more lights 521a-c illuminating their Subject Anatomy, with images captured by one or more cameras 531a-c, and audio captured by one or more microphones 541a-c.

The embodiments incorporating each of the numbered elements illustrated in FIG. 5D are the same as those described herein with the same numbered elements in FIGS. 5A and 5B, except with different subjects 502-504. FIG. 5D illustrates subjects 502-504 with particular characteristics to illustrate how the embodiments described herein operate with subject 502-504 that have very different characteristics, but subjects 502-504 are not limited to these particular characteristics.

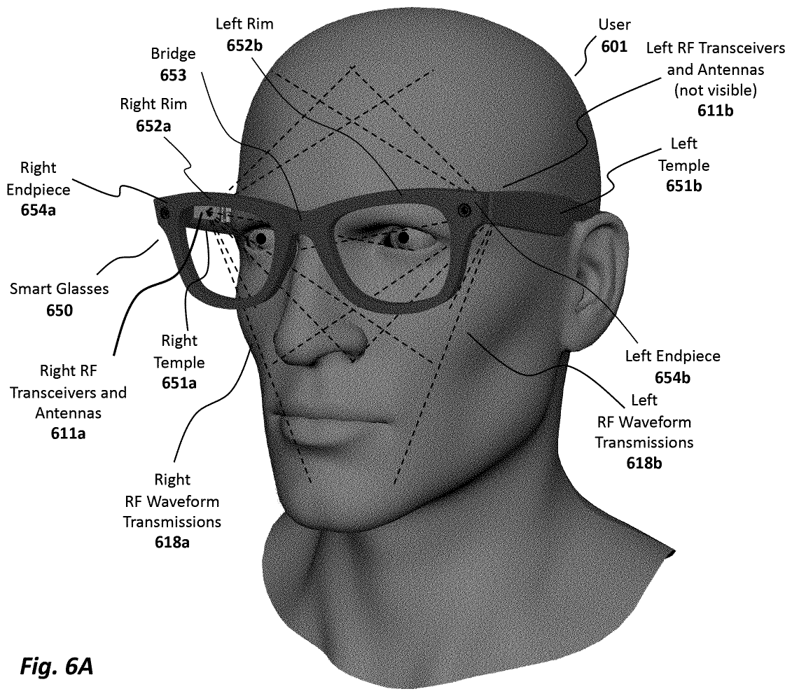

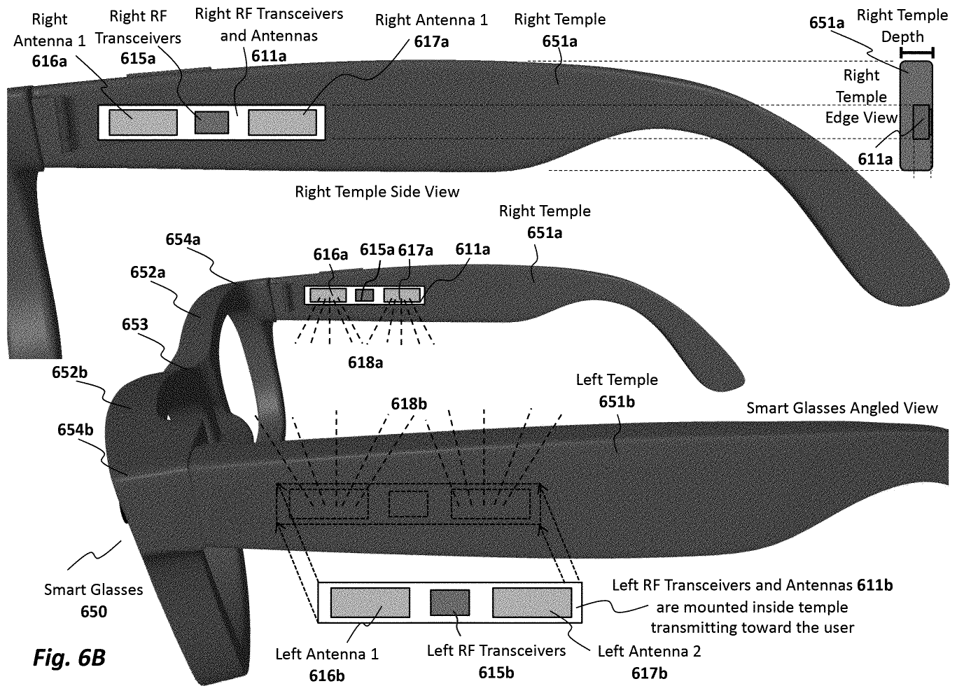

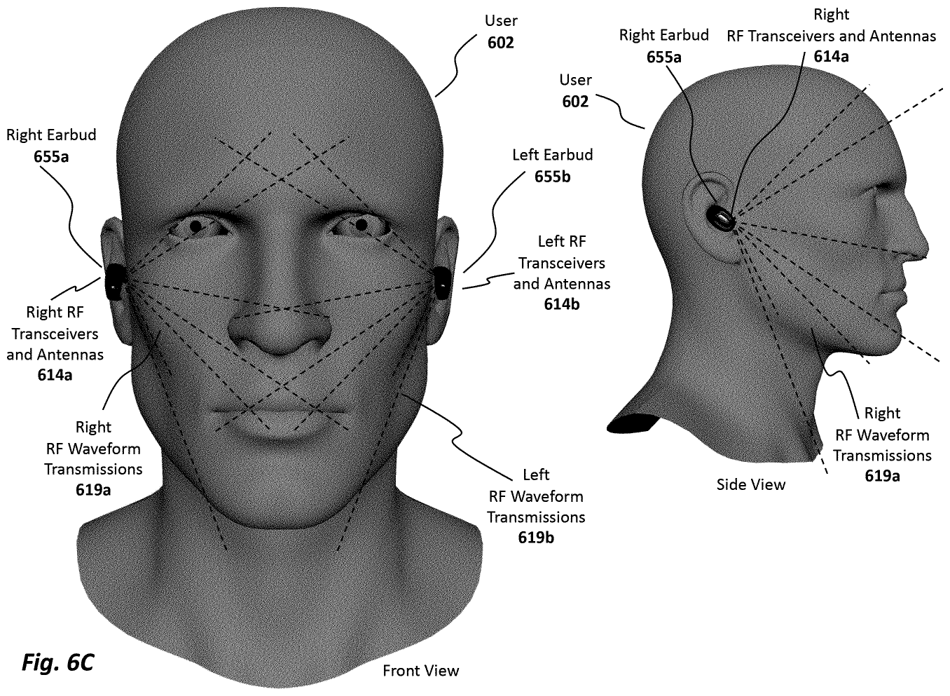

One embodiment shown in FIGS. 6A-B shows a user 601 wearing end-user smart glasses 650 configured with RF transceivers and antennas 611a and 611b located in or on the right temple 651a and left temple 651b, respectively, transmitting toward the user's head and/or face using RF waveform transmissions 618a-b. FIG. 6A shows the head of a user 601 wearing the smart glasses 650. FIG. 6B shows 3 close-up views of smart glasses 650. The top-left illustration shows a right temple side view of right temple 651a, the top-right illustration shows a right temple edge view of right temple 651a, and the middle illustration shows a smart glasses angled view of smart glasses 650. Corresponding numbering is used in FIGS. 6A-B for the same elements in both Figures.

The smart glasses 650, in addition to the facial capture functions and uses described herein, may have a variety of other functions and uses, including but not limited to, correcting the user vision of user 601; functioning as sunglasses; providing audio speaker(s) and/or microphone(s); recording images and/or videos using one or more cameras, including but not limited to, cameras built into one or both endpieces 654a-b; providing images viewable by one or both eyes using a display, including but not limited to, using LCD, OLED, LED or laser-scanned displays with or without a prism, using projectors based on any technology with a waveguide or holographic glasses lens including but not limited to the one described in U.S. Pat. No. 6,353,422; incorporating wired coupling(s), including but not limited to analog audio, any USB version including USB-C, any Thunderbolt version include 1-5, High Definition Multimedia Interface (HDMI), DisplayPort (DP), serial peripheral interface (SPI); incorporating wireless communications, including but not limited to, Bluetooth, Wi-Fi, and mobile communications, including but not limited to, LTE, 5G, 6G and other terrestrial communications, satellite communications, and stratospheric air vehicle communications; providing user controllable switches or surfaces; and/or providing haptic feedback.

The location of the one or more RF transceivers and antennas 611a-b can be located anywhere on a wearable device that enables them to transmit RF waveforms 618a-b that come in contact with the user. In FIGS. 6A-B, the RF transceivers and antennas 611a and 611b are located embedded within the left and right temples, respectively, of the smart glasses. For the purposes of illustration RF transceivers and antennas 611b is illustrated in the smart glasses angled view floating below right temple 651b, with dashed lines showing that the RF transceivers and antennas 611b are actually mounted inside the left temple 651b transmitting RF waveforms 618b (illustrated by dashed lines) inwardly toward the head or face of user 601, opposite RF transceivers and antennas 611a that are in the right temple 651a and transmitting RF waveforms 618a (illustrated by dashed lines) inwardly toward the head or face of user 601. In exemplary embodiments which are illustrated in FIGS. 6A-B, the RF transceivers and antennas 611a-b are small enough to fit within the width, height and depth dimensions of left and rights temples 651a-b. The example temple illustrated are similar in size to temples of existing glasses frames, such as Ray-Ban Wayfarer frames for glasses and sunglasses and Ray-Ban Meta Wayfarer smart glasses.

In exemplary embodiments, the RF transceivers and antennas 611a-b are modules that include, but are not limited to, two right RF transceivers 615a, each one coupled to, respectively, right antenna 616a and 617a, and two left RF transceivers 615b, each one coupled to, respectively left antenna 616b and 617b. The right RF transceivers 615a transmit RF waveforms 618a toward the head and/or face of user 601, and the left RF transceivers 615b transmit RF waveforms 618b toward the head and/or face of user 601 from the opposite side of the head. The right and left RF transceivers 615a-b receive RF waveforms 618a-b from the same antennas 616a-b and 617a-b that they were transmitted from or from different antennas than they were transmitted from. The RF waveforms received by a given one of the transceivers 615a-b may come from its own transmissions or from the transmissions of the other transceivers 615a-b. Although 4 transceivers and 4 antennas are illustrated in this embodiment, there may be only one transceiver and antenna 611a, or any number of multiple transceivers and antennas 611a-b, including but not limited to 10 or 100 transceivers and antennas.

The RF transceivers and antennas 611a-b can be located in other locations, either alternatively or in addition to the temples on the smart glasses, including but not limited on the bridge 653; either rim 652a-b, and/or either endpiece/hinge 654a-b. In exemplary embodiments, the RF transceivers 615a and 615b are separated from their respective antennas 616a-617a and 616b-617b which are located at another location on the wearable device through one or more RF couplings, including, but not limited to coaxial cables and printed circuit board traces. In exemplary embodiments these RF connections are coupled to the RF transceivers and RF antennas with an impedance that matches that of the RF transceiver's RF output and/or RF input.

While FIGS. 6A-B illustrate smart glasses, end-user wearable products include, but are not limited to, earphones, headphones, bone-conduction headphones, smart watches, wrist bands, headbands, necklaces, finger rings, and contact lenses. In exemplary embodiments illustrated in FIG. 6C with a front view and a side view, user 602 is wearing right and left earbuds 655a-b, which contain right and left RF transceivers and antennas 614a-b, respectively, which transmit and receive right and left RF waveforms 619a-b, respectively that are directed inwardly toward the head and the face. RF waveforms 619a-b are illustrated with dashed lines. RF transceivers and antennas 614a-b in this embodiment are embedded within the earbuds and are not visible in the illustrations in FIG. 6C. The earbuds 655a-b may incorporate a single transceiver and single antenna 614a or may incorporate any number of transceivers and antennas 614a-b within one or both earbuds. Also, there may only be a single earbud 655a or 655b that is used.

The earbuds 655a-b may have a variety of other functions and uses in addition to the facial capture functions and uses described herein, including but not limited to, providing audio earphones(s) and/or microphone(s); incorporating wired coupling, including but not limited to analog audio, any USB version including USB-C, any Thunderbolt version including 1-5; incorporating wireless communications, including but not limited to, Bluetooth, Wi-Fi, and mobile communications, including but not limited to, LTE, 5G, 6G and other terrestrial communications; satellite; stratospheric air vehicle communications; providing user controllable switches or surfaces; and/or providing haptic feedback.

In exemplary embodiments, a “Capture Session” is an event in which a subject 501-505, as illustrated in, but not limited to, FIGS. 5A, 5C, and 5D, performs actions involving the Subject Anatomy and/or vocalizations or other sounds while the Subject Anatomy is captured as described above using one or more of the RF transceivers and antennas 511a-b and 514a-b; lights 521a-c; cameras 531a-c; and/or microphones 541a-c. In exemplary embodiments the RF transceivers and antennas 511a-b and 514a-b are located on one or more devices such as temple arms 551a-b or earbuds 555a-b in FIGS. 5A-D at the same or similar location relative to the subjects 501-505 as the RF transceivers and antennas 611a-b and 614a-b are relative to the users 601-602 on end-user wearables such as smart glasses 650 or earbuds 655a-b in FIGS. 6A-6C. As examples without limitations, the temple arms 551a-b can hold the RF transceivers and antennas 511a-b in the same locations as RF transceivers and antennas 611a-b are located on smart glasses temples 651a-b; and the earbuds 555a-b can hold the RF transceivers and antennas 514a-b in the same locations as RF transceivers and antennas 614a-b are located on the end-user earbuds 655a-b.

In exemplary embodiments the RF transceivers and antennas 511a-b (or just the RF antennas 516a, 517a, 516b, and 517b coupled to RF transceivers 515a-b, but at a different location than the RF transceivers 515a-b) are placed at locations where they will avoid obstructing Subject Anatomy features from being captured by cameras 531a-c of FIGS. 5A, 5B, and 5D, including, without limitation, placing them at locations on one or both sides the head, as shown in FIGS. 5A, 5B, and 5D. In exemplary embodiments the RF transceivers and antennas 511a-b, or just the RF antennas 516a, 517a, 516b, and 517b coupled to RF transceivers 515a-b, are placed at locations that obscure some facial features from cameras 531a-c. Note that RF antennas 516a and 517a, together with RF transceiver 515a, and RF antennas 516b, and 517b, together with RF transceiver 515b, are shown in FIG. 5B as part of a RF transceivers and antennas 511a and 511b, respectively. FIGS. 5A and 5D show only RF transceivers and antennas 511a and 511b as modules without showing the detailed RF transceivers and antennas shown in FIG. 5B, but RF transceivers and antennas 511a and 511b are intended to incorporate these details.

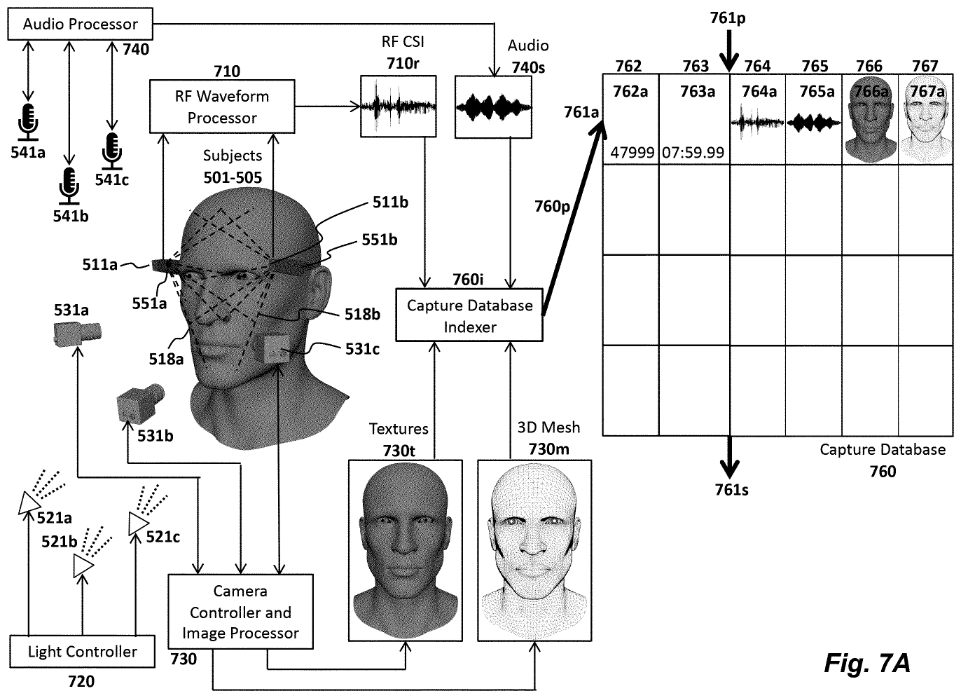

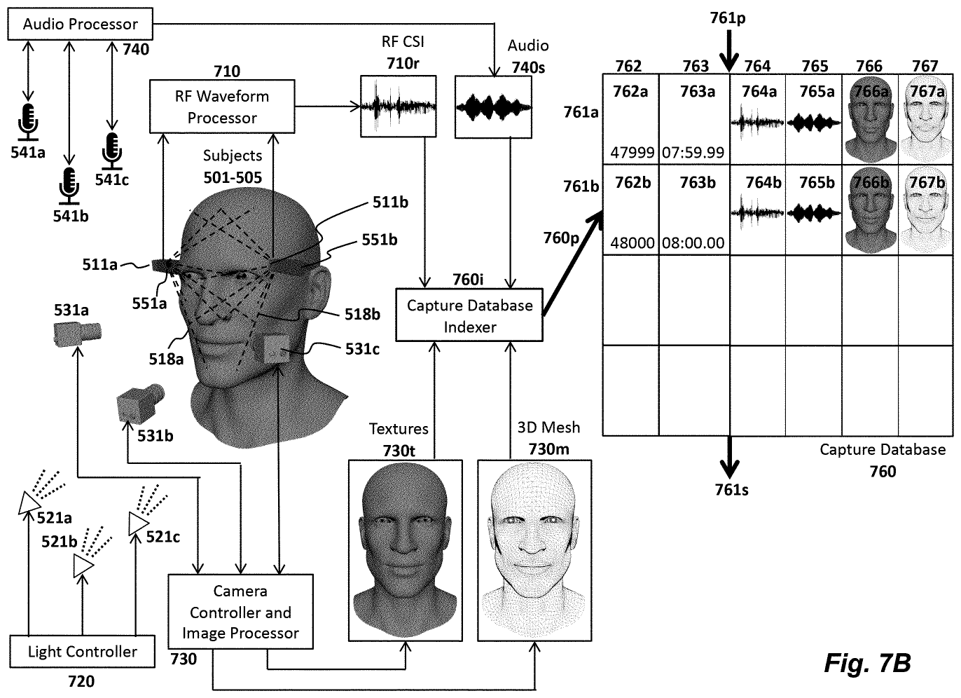

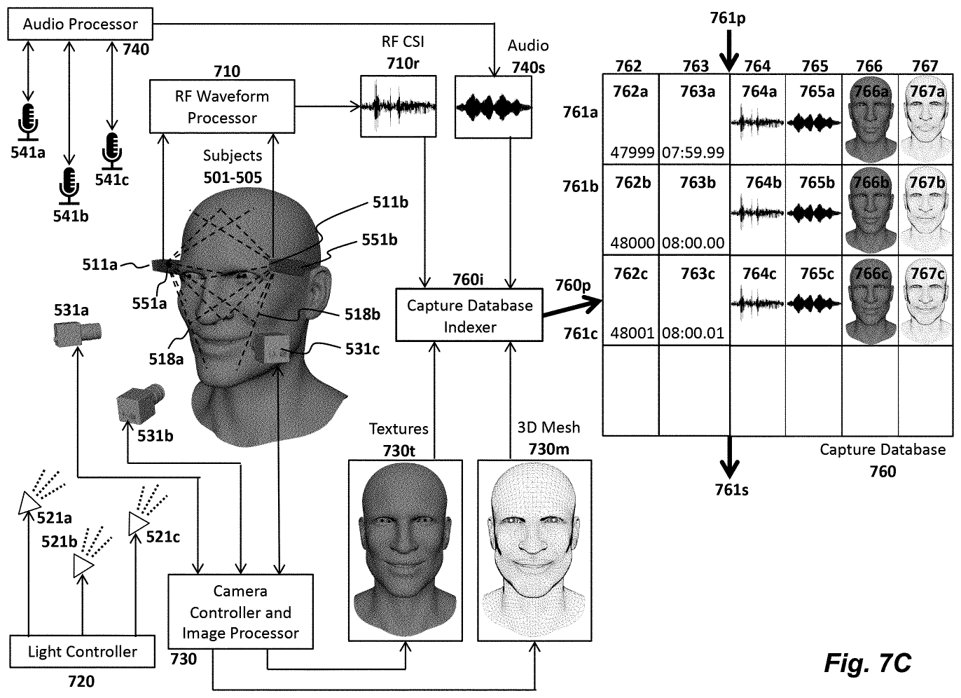

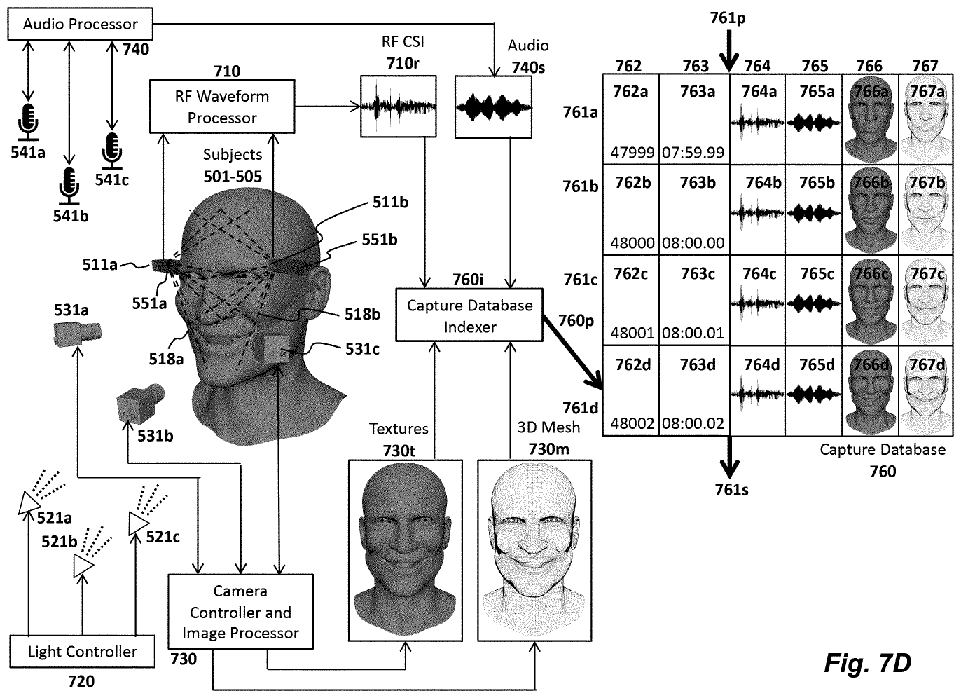

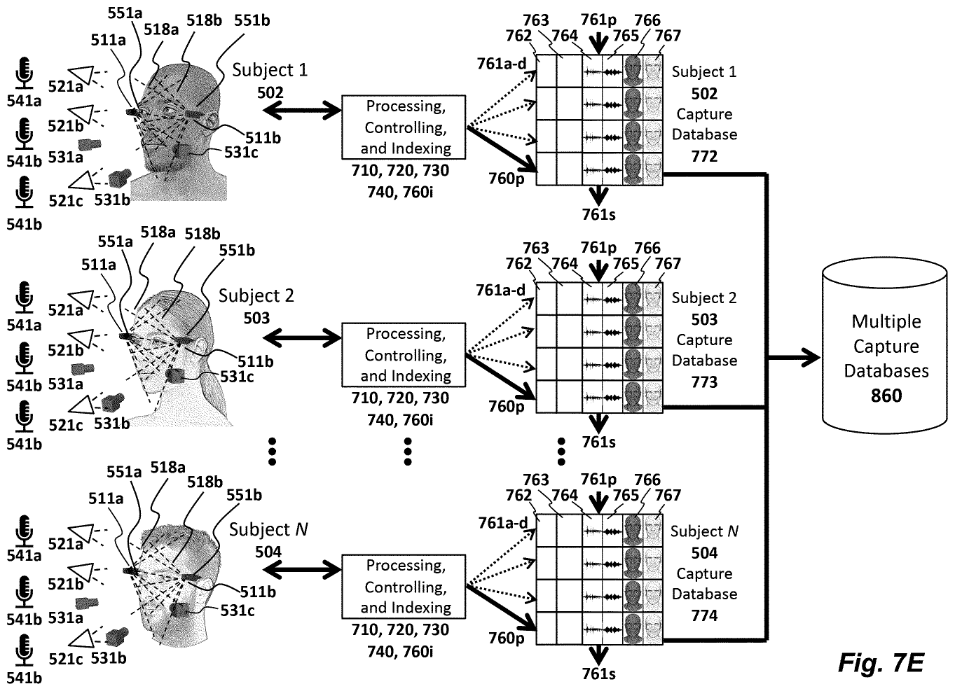

In exemplary embodiments illustrated in FIGS. 7A-D (note that elements in FIGS. 7A-D that have the same numbers as elements in FIGS. 5A-D refer to the same element), successive frames of data (“Capture Data”) are captured at a specified “Frame Rate”, which, in exemplary embodiments, is a uniform Frame Rate, such as 100 frames per second, and in exemplary embodiments is a variable Frame Rate with non-uniform frame durations. Each frame of Capture Data includes the simultaneous capture of one or more types of data, including but not limited to, (a) RF CSI from each transmitter-receiver antenna pair of at least one of the RF transceiver and antennas 511a-b, where some or all transmit-receive antenna pairs may be different or the same, wherein the RF waveform transmissions 518a-b have come into contact with part of all of the Subject Anatomy, (b) one or more images captured by at least one of the one or multiple cameras 531a-c of part or all of the Subject Anatomy under one or more configurations of lights 521a-c, (c) audio waveforms from at least one of the one or multiple microphones 541a-c that is spoken or vocalized by, or a sound created by, a subject 501-505.

Frames of Capture Data are captured successively during each “Frame Time”, which without being limiting, the term may be defined as the interval of time between the start times of successive frames. Frame Time examples for illustration without limitation, are (a) a uniform Frame Time of 1/100th of a second (10 milliseconds (“msec”)) as the result of a uniform Frame Rate of 100 frames per second; and (b) non-uniform Frame Times of 10 msec and 5 msec as the result of a non-uniform Frame Rate, which alternates between 100 frames per second (10 msec Frame Time) and 200 frames per second (5 msec Frame Time).

Each type of Capture Data captured in a given frame is captured for a “Capture Time” that without being limiting may be defined as the amount of time it takes to capture that particular type of data, which may be time interval shorter than, equal to, or longer than the Frame Time. The Capture Time for each type of Capture Data may or may not be of equal duration for each frame. Different types of Capture Data may have very different Capture Times in a given frame. As an example, for illustration without limitation, if a Frame Time is a uniform 10 msec, the Capture Time of various types of Capture Data could be, (a) RF CSI: 10 microseconds (“usec”), (b) image: 5 msec, and (c) audio: 10 msec.

The Capture Time for a given type of Capture Data in a given Frame time expressed as a percentage of the Frame Time which, without being limiting, may be defined as the term “Duty Cycle”. As an example, for illustration without limitation, if the Frame Time is 10 msec, and if the RF CSI data has a 10 μsec Capture Time, then the RF CSI data Duty Cycle is 10 μsec/10 msec=0.1%; if the raw image data has a 5 msec Capture Time, then the raw image Duty Cycle is 5 msec/10 msec=50%; if the audio data has a 10 msec Capture Time (i.e., is captured for the entire Frame Time), then the audio data Duty Cycle is 10 msec/10 msec=100%. In exemplary embodiments the Capture Time for a given type of Capture Data is the same for each frame when the Capture Data is captured. In exemplary embodiments the Capture Time for a given type of Capture Data is not the same for each frame.

In exemplary embodiments a given type of Capture Data is captured every Frame Time. In exemplary embodiments a given type of Capture Data is captured during some frames, but not others.

Without being limiting, the term “Take” may be defined as a continuous capture of multiple successive frames of Capture Data while a subject 501-505 performs by placing the Subject Anatomy into a posed position; moving the Subject Anatomy; and/or speaking, vocalizing or otherwise making sound. A Take can be as short as one Frame Time or can be of any duration (including being of unlimited duration, where the Take continues indefinitely). The number of frames of Capture Data captured during a Take is determined by the Frame Rate and the duration of the Take. As an example, for illustration without limitation, a 60 second Take at a uniform frame rate of 100 frame per second will result in 100 frames per second*60 seconds=6,000 frames of Capture Data.

In exemplary embodiments a Take may include a single continuous performance by a subject 501-505. In exemplary embodiments a Take includes several performances by a subject 501-505 in succession with or without a gap in time between the performances.

In exemplary embodiments a Take is started and stopped by a person's action, including, but not limited to, a keyboard key or command press; a mouse click; a touch screen action; a spoken utterance; a neural brain activity; an activation of a physical switch, or a physical motion. In exemplary embodiments the person starting and stopping the Take is the performing subject 501-505. In exemplary embodiments the person starting and stopping the Take is a person other than the subject 501-505.

In exemplary embodiments a Take is started and/or stopped by (a) the operation of hard-wired logic or (b) a computer with a processor operatively connected to memory wherein in the memory includes instructions stored that, in conjunction with hard-wired logic, when executed causes the Take to start and/or stop. The hard-wired logic or the computer operatively connected to hard-wired logic causes the Take to start and/or stop by controlling one of more of (a) the RF transceivers and antennas 511a-b; (b) the lights 521a-c; (b) the cameras 531a-c; and/or (d) the microphones 541a-c.

Without being limiting, the term “Capture Session” may be defined as one or more Takes of one or more subjects 501-505. A Capture Session may be uninterrupted, or it may have interruptions. As examples without limitation, the subject(s) 501-505 and other people involved with the Capture Session may need breaks to rest, to eat or for any other reason; or breaks may be needed so that equipment used in the capture session can be adjusted or maintained. There can be multiple Capture Sessions, spanning days, weeks, or years, which may involve the same or different subject(s) 501-505.

In exemplary embodiments, the subject 501-505 in a Capture Session performs a variety of actions involving or related to the Subject Anatomy. In exemplary embodiments the actions are facial expressions with or without utterances (e.g., speech and/or vocalizations), wherein the facial expressions and/or utterances performed are determined by one or more of (a) a human director overseeing the Capture Session; (b) a system that prompts the subject 501-505 to perform facial expressions using video audio, haptic, sensory stimulation and/or other means; (c) previously specified instructions that were given to the subject 501-505; (d) independent decisions of the subject 501-505 of which facial expressions to make; or (e) by some other means.

In exemplary embodiments multiple Capture Sessions are carried out, either concurrently or at separate times, with a variety of subjects 502-504 illustrated in FIG. 5D. The subjects 502-504 may have similar or diverse physical attributes, such as, without limitation, gender age, skin type, wrinkles, facial hair or not, etc. In exemplary embodiments, during each of the Capture Sessions, a subject 502-504 performs a wide variety of natural facial expressions and/or performs speech or other vocalizations. The subject 501-505 in FIGS. 7A-D is illustrated as smooth-shaded, hairless and largely featureless male, but is intended to represent any subject, including subjects 502-504, who is captured in a Capture Session.

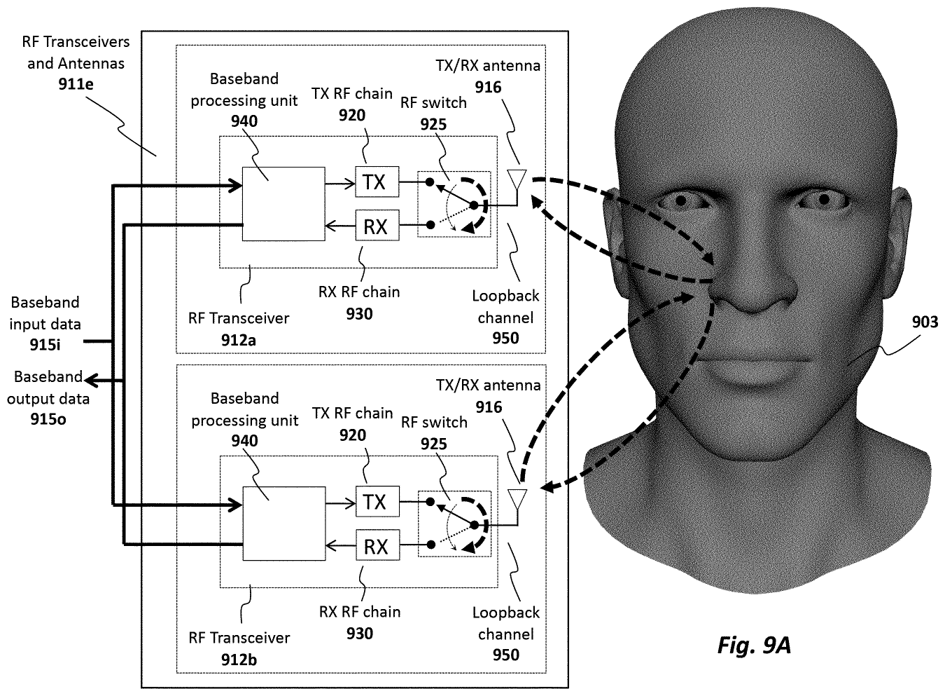

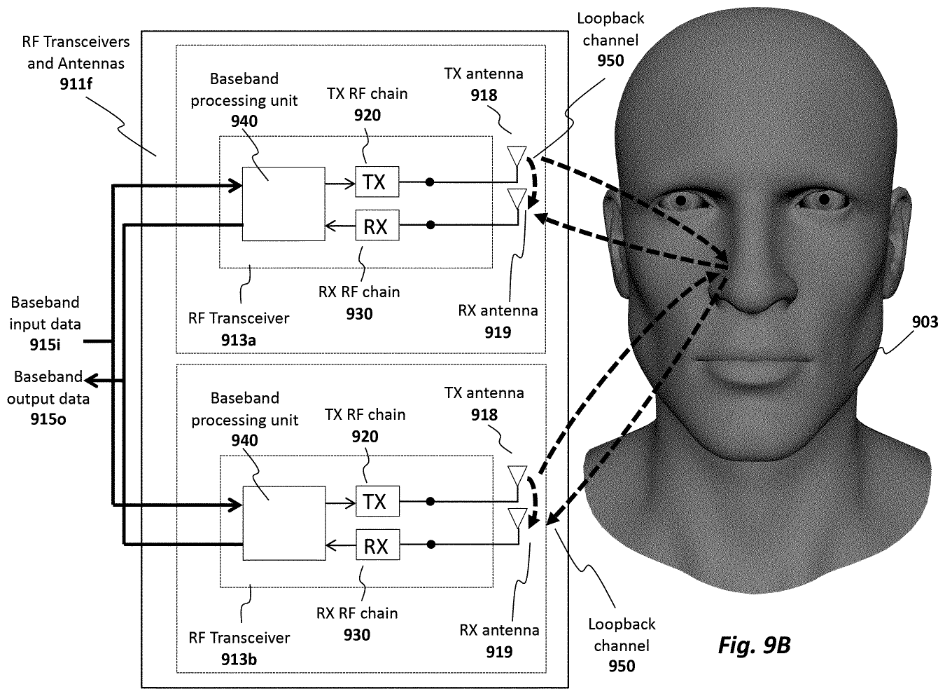

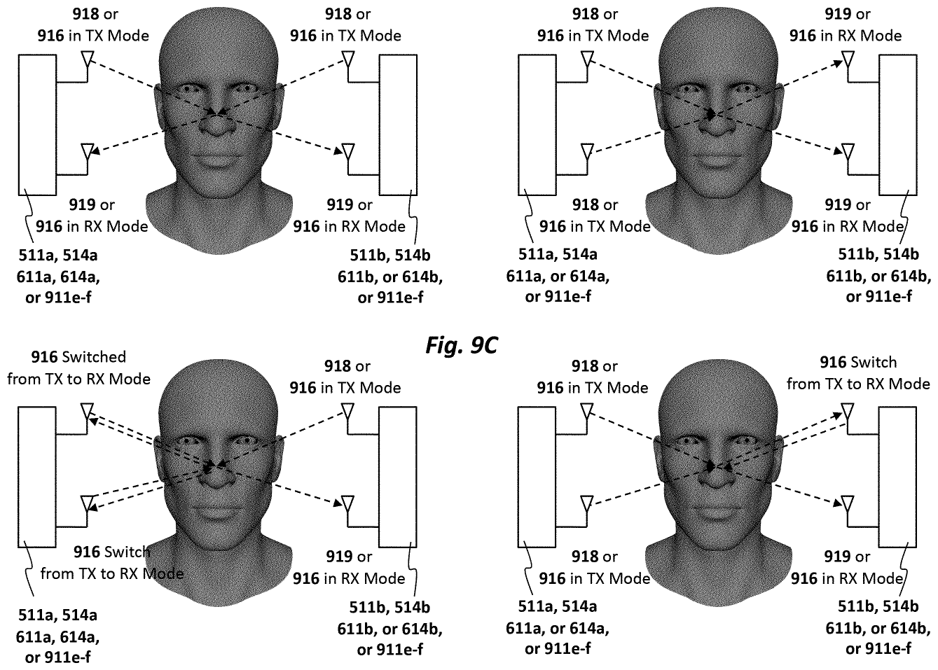

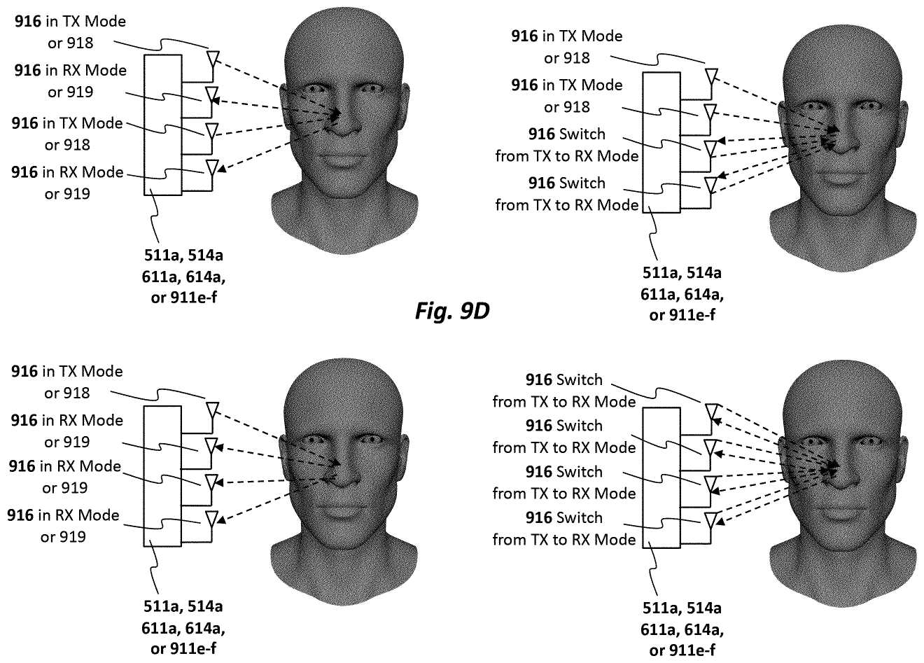

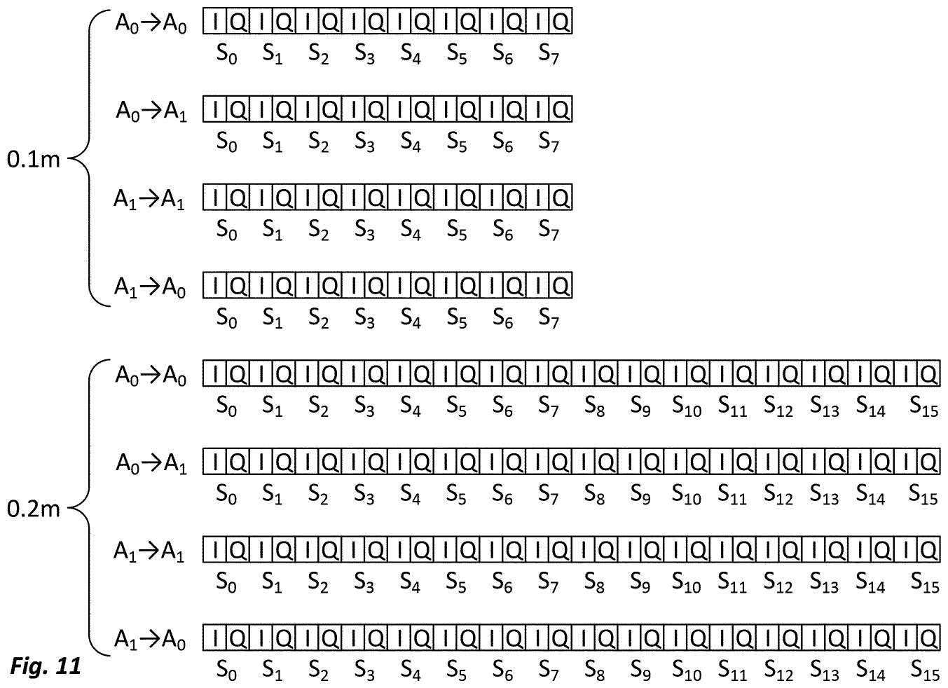

In exemplary embodiments illustrated in FIGS. 7A-D, the RF waveform processor 710 has one or more analog or digital RF input data channels that are coupled to one of more RF transceivers and antennas 511a-b. The RF Processor 710 may provide power to the RF transceivers and antennas 511a-b or they may either not require power or provide their own power. The coupling can be wired or wireless, and either wired or wireless coupling can be analog or digital, and may include RF or baseband waveforms or data derived from such waveforms. In an exemplary embodiment, the input to RF waveform processor 710 is composed at each frame time of one or more finite sequences of baseband complex samples as explained below and illustrated in FIG. 11 and more generally designated as baseband output data 9150 in FIGS. 9A-B. The RF waveform processor 710 first performs decompression if the data coming RF transceivers and antennas 511a-b was compressed, either through lossy or lossless compression, and raw CSI estimation through channel estimation and equalization methods such as non-limiting zero-forcing or mean-square error estimators, either in the frequency domain, the time domain, or the delay-Doppler domain, or other signal representation domains as are known to a person having ordinary skill in the art. In embodiments where the input to RF waveform processor 710 is composed of waveform data from more than one stream, raw CSI instances are combined through both invertible, such as non-limiting projections onto beamforming, wavelet, or other waveform bases, and non-invertible operations to enhance features and reduce the noise of the underlying raw CSI waveforms. The RF waveform processor 710 finally arranges the result for storage and subsequent processing to produce the RF CSI 710r.

For the purposes of illustration, FIGS. 7A-D show a RF CSI waveform 710r as the output from the RF waveform processor 710. The illustration of RF CSI waveform 710r serves purely for illustrative purposes and is not intended to show an actual waveform, and indeed, the same RF CSI 710r is used for all frames in all illustrations herein, wherein actual RF CSI waveforms typically vary by frame.

In exemplary embodiments, a light controller 720 controls the lights 521a-c during Takes and Capture Sessions to change the state of the lights 521a-c as described above, wherein that state includes, but is not limited to, color, brightness, projected pattern, polarization, and phase. The light controller 720 may provide power to some or all lights 521a-c, or they may be self-powered. The light controller 720 may provide clock, timing and/or synchronization to some of all lights 521a-c.

In exemplary embodiments, a camera controller and image processor 730 controls the cameras 531a-c during takes and capture sessions. The camera controller and image processor 730 is coupled to one or more of the cameras 531a-c. The camera controller and image processor 730 may provide power to the cameras 531a-c or they may either not require power or provide their own power. The coupling to the cameras can be wired or wireless, and either wired or wireless coupling can be analog or digital. In exemplary embodiments, the camera controller functions of the camera controller and image processor 730 may include, but are not limited to, configuring the cameras; initiating the capture of one frame or multiple successive frames; controlling the shutters; providing timing, clock and/or synchronization signals; controlling focus; controlling aperture; controlling exposure; and/or providing power. The camera controller may cause the cameras 531a-c to capture one frame during each Frame Time, or it may cause the cameras to capture multiple frames during each Frame Time. As examples without limitation, such multiple frames can be combined to be used to reduce noise or increase dynamic range using prior art techniques, and/or such multiple frames can be synchronized with changing states of the lights to capture multiple frames during a frame time during different lighting conditions. As examples without limitation, such different lighting conditions may include (a) capturing alternating light and near ultraviolet light (e.g., “black light”) frames to support the operation of MOVA Contour or similar systems and/or (b) capturing different illumination scenarios of subjects 501-505, such as, without limitation, (x) simulating different angles of lighting, (y) simulating different ambient lighting such as indoor, outdoor, bright sunlight, dusk, etc.

In exemplary embodiments, the camera image processor functions of the camera controller and image processor 730 may include, but are not limited to, automatic gain control; dynamic range enhancement; color correction; noise reduction; image and/or temporal filtering; 2D and 3D texture generation; 3D surface capture; 3D tracked mesh generation; eye tracking; and compression including but not limited to lossless and lossy compression. As described above, prior art systems such as MOVA Contour and other technologies can be used to implement 3D surface capture and generate 3D tracked meshes. The output of the camera image processor may include, without limitation, (a) the frame image(s) from cameras 531a-c; (b) one of more 2D or 3D texture maps of the Subject Anatomy of subjects 501-505; (c) one or more 3D surface meshes or 3D tracked meshes. For the purposes of illustration, FIGS. 7A-D show 2D texture map 730t and 3D tracked mesh 730m as the outputs from the camera image processor.

In exemplary embodiments, the audio processor 740 has one of more analog or digital audio input channels that are coupled to one of more microphones 541a-c. The audio processor 740 may provide power to the microphones 541a-c or they may either not require power or provide their own power. The coupling to the microphones can be wired or wireless, and either wired or wireless coupling can be analog or digital. The audio processor 740 functions may include, but are not limited to, automatic gain control; dynamic range enhancement; noise reduction; equalization; channel balancing; stereo or surround sound processing, including but not limited to 5.1 and 7.1 surround sound, THX, and spatial processing such as Dolby Atmos; analog to digital conversion; resampling; filtering; and compression, including but not limited to lossless and lossy compression. In exemplary embodiments, the output of audio processor 740 includes, but is not limited to, 24-bit audio samples at a 48 kilohertz (kHz) sample rate during the entire Frame Time of each frame from one or more of the microphones 541a-c. For the purposes of illustration, FIGS. 7A-D show the audio data 740s in the form of a waveform file as the output from the audio processor 740. The illustration of audio data 740s serves purely for illustrative purposes and is not intended to show an actual waveform, and indeed, the same audio waveform is used for all frames in all illustrations herein, wherein actual audio waveforms typically vary by frame.

In exemplary embodiments, the frames of Capture Data are captured and stored in a capture database 760, shown in FIGS. 7A-D. Each of FIGS. 7A, 7B, 7C, and 7D illustrate an exemplary successive frame that has been captured with its Capture Data processed and placed in the capture database 760, where the illustrated subject 501-505 gradually transitions from a neutral expression to a smile expression. Each frame of Capture Data is stored as a “Frame Data Record”, labeled for each successive frame as 761a, 761b, 761c, and 761d, that includes the Capture Data of each type of data captured during that Frame Time in either the form in which the data was captured or in processed form. A capture database indexer 760i advances a pointer 760p to point to the next Frame Data Record 761a-d in the capture database 760 concurrent with each successive frame, and transfers the Capture Data to each Frame Data Record 761a-d. There may be prior Frame Data Records 761p that precede the 4 frames illustrated in FIGS. 7A-D and subsequent Frame Data Records 761s that follow them. There may well be 100s of thousands, millions or even more Frame Data Records 761p, 761a-b, and 761s in a given Take and/or Capture Session.

In exemplary embodiments, the Frame Data Record includes, without limitation, data that indicates a frame number of the Take and/or the Capture Session, including but not limited to, the sequential frame number, placed into fields 762a-d, and frame timing information, placed into fields 763a-d, including but not limited to the current date; the current time of day; elapsed time during the capture; and Society of Motion Picture and Television Engineers (SMPTE) timecode. In exemplary embodiments there are as many Frame Data Records in a Take as there are frames in a Take. As illustrated in FIGS. 7A-D as examples, but not as limitations, sequential frame numbers of 47999, 48000, 48001, and 48002 are placed in fields 762a-d, and frame timing information of timecode 07:49:99, 08:00:00, 08:00:01, and 08:00:02 are placed in fields 763a-d in the capture database 760 as each successive frame is shown captured in FIGS. 7A-D and the capture database indexer 760i advances the pointer 760p to point to each successive Frame Data Record 761a-d in the Capture Database. Each subsequent FIGS. 7A, 7B, 7C, and 7D has an additional Frame Data Record 761a-d with frame numbers 762a-d and frame timing information 763a-d. The timecode in this example is advancing uniformly by 1/100th of a second, indicating a uniform Frame Time of 1/100th of a second (i.e., 10 msec).

In exemplary embodiments, the Frame Data Records 761a-d include, without limitation, RF CSI data 710r from each frame captured during the Take and/or the Capture Session as described above. The capture database indexer 760i advances the pointer 760p with each successive frame to point to the next Frame Data Record 761a-d in the Capture Database, and the RF CSI data 710r from each frame is successively placed into each Frame Data Record 761a-d into each field 764a-d.

In exemplary embodiments, the Frame Data Record includes, without limitation, audio data 740s from each frame captured during the Take and/or the Capture Session as described above. The capture database indexer 760i advances the pointer 760p with each successive frame to point to the next Frame Data Record 761a-d in the capture database 760, and the audio data 740s from each frame is successively placed into each Frame Data Record 761a-d into each field 765a-d.

In exemplary embodiments, each Frame Data Record 761a-d includes, without limitation, texture maps 730t and tracked 3D mesh data 730m from each frame captured during the Take and/or the Capture Session as described above. The capture database indexer 760i advances the pointer 760p with each successive frame to point to the next Frame Data Record 761a-d in the capture database 760, and texture data 730t and tracked 3D mesh data 730m from each frame is successively placed into each Frame Data Record 761a-d into each field 766a-d and 767a-d, respectively.

FIG. 7E illustrates multiple Capture Sessions such as those described above and illustrated in FIGS. 7A-D. Elements numbered in FIG. 7E with the same numbering as elements in FIGS. 5A-D, 6A-C, and 7A-D are the same corresponding elements. The multiple subjects 1-N 502-504 are the same multiple subjects described above and illustrated in FIG. 5D, and although 3 are shown for illustration purposes, subjects 502-504 represent any number of subjects, including a very large number of subjects in the hundreds of thousands or more. Typically, subjects 502-504 will be people with a wide variety of different characteristics, including, but not limited to, gender, age, facial hair and other varying anatomical features, as detailed above. For each subject 502-504, the respective processing, controlling and indexing 710, 720, 730, 740, 760i box illustrated corresponds to the processing, controlling and indexing elements with the same numbering in FIGS. 7A-D coupled to 511a-b, 521a-c, 531a-c, and 541a-c, and other elements as illustrated in FIGS. 7A-D. For each subject 502-504, the respective capture database indexer 760i shown in FIGS. 7A-D advances a pointer 760p with each successive frame to place a Frame Data Record 761a-d containing Capture Data 762-767 into a capture database 772-774 for each user, respectively. For purposes of illustration, the pointer 760p is illustrated with 3 dotted lines and 1 solid line to convey that it points to a different Frame Data Record 761a-d with each successive frame. For each subject 502-504, the respective capture database 772-774 has far more Frame Data Records than 761a-d, and arrow 761p indicates preceding, and arrow 761s illustrates successive, Frame Data Records. The illustrations of the CSI waveforms 764, audio waveforms 765, texture maps 766 and 3D tracked mesh 767 do not show actual Capture Data, nor do they vary as they typically would from frame to frame, as they are just for illustration purposes. No numbers are illustrated for the Capture Data of frame numbers 762 and frame timing information 763 since the text would be too small.

The Subject Anatomy of each of multiple subjects 502-505 illustrated in FIG. 7E is captured in Capture Sessions such as those described above and illustrated in 7A-D, capturing Capture Data including one or more of, but not limited to, RF CSI 710r; texture maps 730t, 3D meshes 730m; audio 740s; and said Capture Data for each Take of each subject 501-505 and storing the Capture Data in Frame Data Records 761a-d in respective capture database 772-774 for each subject 502-504 as shown in FIGS. 7A-D with capture database 760, but with capture databases 772-774 instead. The Capture Sessions for each user 502-504 may be quite extensive, potentially lasting hours or multiple days with breaks in between, thoroughly capturing each user's performance of the Subject Anatomy in a wide range of poses and utterances. With the same subject 502-504 (or other subjects 501 and 505 or any number of additional subjects), multiple Capture Sessions can be repeated with same, similar, different or even slightly different fittings of the device holding the RF transceivers and antenna 511a-b or 514a-b, whether using temple arm(s) 551a-b; earbud(s) 555a-b; or (c) other devices, to account for slight variations in the real-life fitting of a wearable device such as the smart glasses 650, earbuds 655a-b, or other wearable devices. Each capture database 772-774 created from the Capture Data of each subject 502-504, respectively, is then aggregated into multiple capture databases 860. Multiple capture databases 860 can hold capture databases 772-774 from Capture Sessions of any number of subjects, including but not limited to, a very large number of subjects 502-504, potentially hundreds of thousands or millions of subjects 502-504.

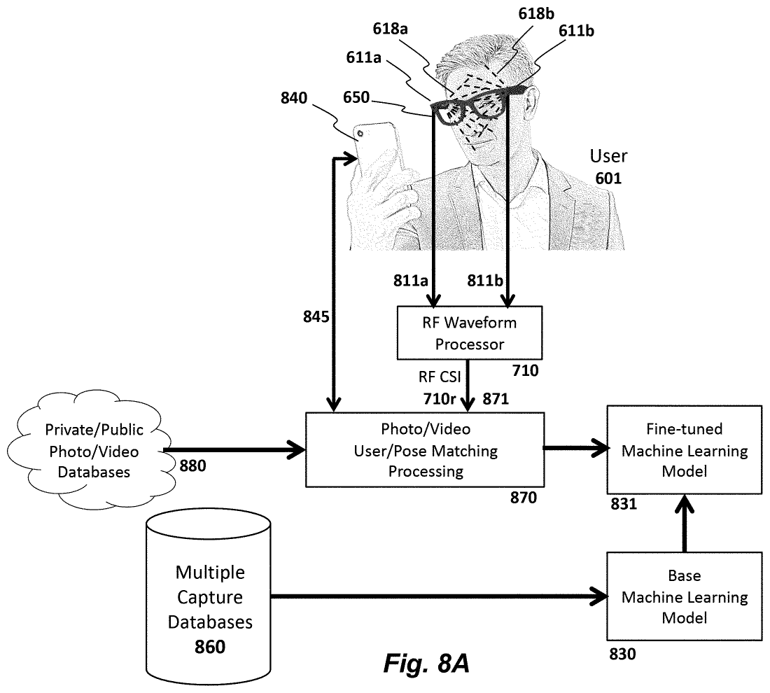

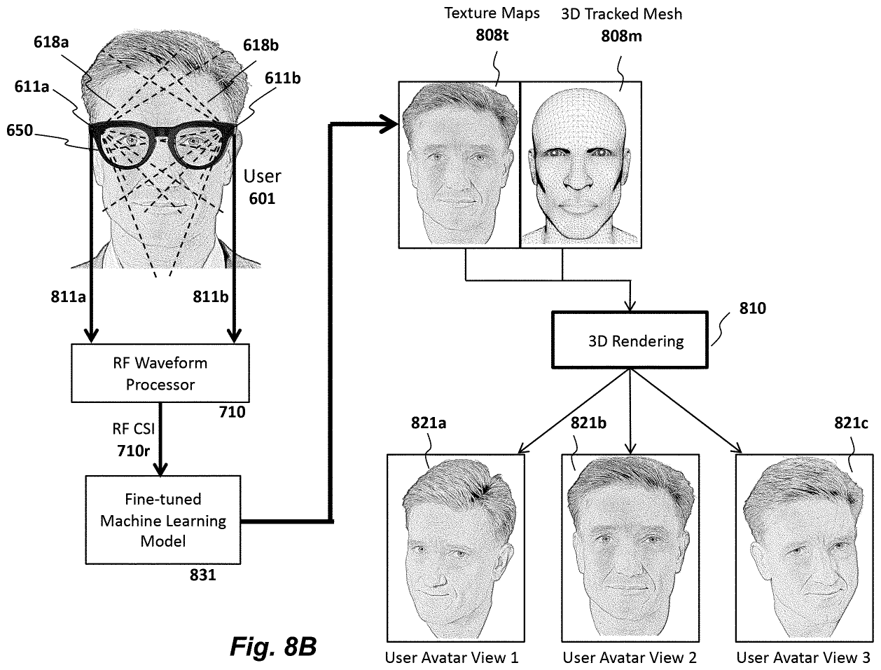

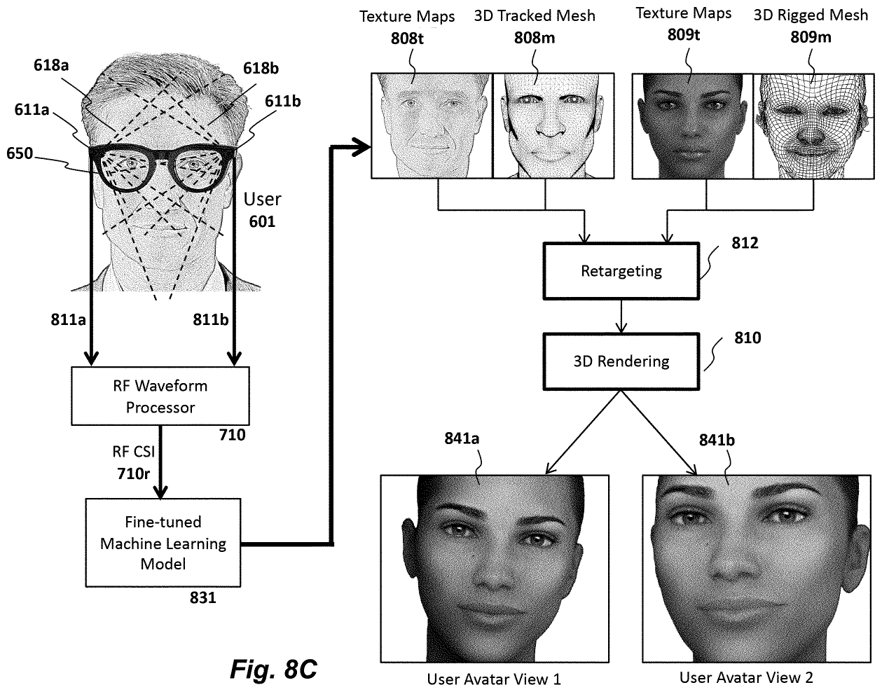

FIGS. 8A-C illustrates an exemplary embodiment of the present invention. Elements numbered in FIG. 8A-C with the same numbering as elements in FIGS. 5A-D, 6A-C, and 7A-E are the same corresponding elements. Multiple capture databases 860 is used to train a base machine learning model 830 (detailed below) to associate RF CSI 710r with particular poses of the Subject Anatomy. By capturing a wide variety of subjects 501-505 with different characteristics, including, but not limited to, gender, age, facial hair and other varying anatomical features, the base machine learning model 830 is trained to associate RF CSI 710r with particular poses of the Subject Anatomy across a wide range of body types.

The multiple capture databases 860 is subsequently partitioned into training, dev, and test data sets and is used to further train and validate the base machine learning model 830. After training is complete to the point where tested accuracy metrics are sufficient for an end-user product, the base machine learning model now can take RF CSI 710r as an input and output corresponding texture maps 808t and 3D tracked mesh 808m, as illustrated in FIGS. 8B-C, thus capturing the general correspondence between the RF CSI 710r captured by RF transceivers and antennas 511a-b and 514a-b, it infers the texture maps 808t and 3D tracked mesh 808m based on output from RF transceivers and antennas 611a-b and 614a-b integrated into end user products, such as, but not limited to, wearable smart glasses 650 and earbuds 655a-b, and then output a representation of the tracked 3D texture maps 808t and geometry 808m of the surface of the Subject Anatomy, such as a face.

In exemplary embodiments, the RF transceivers and antennas 611a-b and 614a-b are integrated into a wearable device including, but not limited to, smart glasses including, but not limited to, Ray-Ban Meta, Snap® Spectacles™, and Meta Orion smart glasses; virtual reality (“VR”) and augmented reality (“AR”) goggles including, but not limited to, Meta Quest®, Apple® Vision Pro® AR goggles; and earphones including, but not limited to, Apple AirPods®, Bose QuietComfort® Ultra Earbuds, Google Pixel Buds® Pro. The RF transceivers and antennas 611a-b and 614a-b transmit RF waveforms 618a-b and 619a-b that contact the Subject Anatomy, including, but not limited to that subject's face, and receive RF CSI 710r from the received waveform.

In exemplary embodiments, wearable devices such as those described above, are distributed, through sales or other means, to a population of end-users 601-602. The wearable devices are coupled to a data center (not shown in FIGS. 8A-C) through a user's mobile phone 840 through a wireless or wired communication link, including, but not limited to, Bluetooth, Wi-Fi, and mobile, and USB-C. The RF transceivers and antennas 611a-b and 614a-b capture RF CSI from the RF waveforms 618a-b and 619a-b, which is transferred over the communication link to the mobile phone 840, which uses the base machine learning model 830 combined with a fine-tuned machine learning model 831 (detailed below) to compute an inference of a user's facial expression that associates texture maps 808t and/or a 3D Mesh 808m. Real-time 3D rendering 810 (detailed below) then renders 3D views of user avatars 821a-c, presenting a 3D character whose expression corresponds to that of user 601. The user avatars 821a-c can be ones that resemble the user 601, or the real-time 3D animation processing can retarget the facial expression of user 601 to a different 3D character, including but not limited to a character that looks like the user 601 at a different age or with different styling, or a character that is different than the user 601 in appearance, including looking like a different person, changing gender (as illustrated in FIG. 8C), or becoming a non-human character. As the facial expression of the user 601 changes, the captured CSI will change and the base machine learning model and fine-tuned machine learning model will compute an inference of the user's new facial expression and associate new texture maps 808t and a 3D Mesh 808m, which will then be used by the real-time 3D rendering 810 to change the expression of the user avatars 821a-c. The user avatars 821a-c can be used for any purpose including but not limited to, presenting a user avatar 821a-c for (a) the videoconference face of user 601 over videoconferencing such as Zoom®, Microsoft® Teams® or Apple FaceTime®; (b) videogame avatars; (c) a CG character performance in a motion picture or television show; or (d) a CG character over social network or live broadcast.

In exemplary embodiments, prior to live operation such as that described in the preceding paragraph with a given user 601, the base machine learning model 830 is fine-tuned for that particular user 601. This is done through a user onboarding process illustrated in FIG. 8A, in which the user 601 wears the wearable device, such as smart glasses 650, in conjunction with their smartphone 840 collects RF CSI data while the user 601 follows instructions on the smartphone 840 to which the wearable device is connected. These instructions typically would direct the user to go through a range of natural facial expressions in an environment with adequate illumination for the smartphone to capture the appearance of the face by acquiring video frames and depth information such as provided by an iPhone® front-facing camera, TrueDepth® and LiDAR sensors. This user-specific data is used to fine-tune and customize the base machine learning model 830 using, as a non-limiting example, a Low-Rank Adaptation (“LoRA”), thus generating a user-specific fine-tuned machine learning model 831. The user can judge of the quality of the fine-tuning by wearing a wearable such as smart glasses 650 and running an application on their smartphone 840 in communication with the wearable 650 so that an avatar view of the user's face as a result of the fine-tuning is displayed in real time. Once the user is satisfied with the quality of the avatar view of the face, the user is then prompted to end the onboarding phase and proceed with normal operation. If the user is not satisfied, the smart glasses 650 and smartphone 840 application continue to capture RF CSI and video and/or depth information of the face of user 601 to make a more robust fine-tuned machine learning model 831.

In an exemplary embodiment of the invention illustrated in FIG. 8A, photo/video user/pose matching processing 870 supports the user onboarding process by prompting the user to perform particular expressions and receives video and/of depth information from the smartphone 840 user-facing camera and processes the video and/depth information to determine what facial expression the user is performing and evaluate whether it conforms to the prompted expression within acceptable limits. The photo/video user/pose matching processing 870 is coupled to the smartphone 840 through a wireless or wired link 845 or is built into the smartphone 840. The photo/video user/pose matching processing 870 is coupled to the RF transceivers and antennas 611a-b of wearable device 650 coupled through wireless or wired connections 811a-b to RF waveform processor 710, which is coupled through wireless or wired link 871 (through which it receives RF CSI 710r), or is built into the wearable device 650 with or without RF waveform processor 710. The photo/video user/pose matching processing 870 further processing the video received from the smartphone 840 to remove the any obstructions of the user's face caused by the wearable device 650, including but not limited to, the smart glasses rims and bridge. Widely available photographic image cleanup software, such that is built into modern smartphones or available in software like Adobe Photoshop, are capable of “erasing” such obstructions from faces. Photo/video user/pose matching processing 870 can further utilize video or photos of the user 601 on their smartphone, typically by obtaining their permission to access their videos and photos, and can use built-in capabilities of modern smartphone or widely available software to find videos and photos of the user 601 that correspond to the expressions that the user is performing as prompted by the photo/video user/pose matching processing 870. Similarly, the photo/video user/pose matching processing 870 can utilize video or photos of the user 601 in private or public photo/video databases in the cloud or otherwise stored at another location, typically by obtaining their permission to access their videos and photos as needed, and can use built-in capabilities of modern smartphone or widely-available software to find videos and photos of the user 601 that correspond to the expressions that the user is performing as prompted by the photo/video user/pose matching processing 870. The videos and photos obtained through this process can potentially provide texture maps of the appearance of user 601 from a variety of different angles under a variety of different lighting conditions, and potentially also provide stereoscopic image if such information is available. The collective video and photos gathered as described in this paragraph is then provided along with CSI associated with the expressions to change the base machine learning model 830 into the fine-tuned machine learning model 831. This process can be implemented using a low-rank adaption (“LoRA”).

In an exemplary embodiment of the invention, user onboarding consists of the single step of the user providing a single identity face image with a neutral expression or some other known facial expression in adequately lit, non-occluded conditions.

Once the on-boarding process is complete, normal end-user operation for the user 601 can commence, as illustrated in exemplary embodiments in FIGS. 8B-C. The user 601 can wear the smart glasses 650 throughout the day or even at night as they go through their daily life activities. When in a video conference call, they do not need to use a front-facing camera, either from a computer, front-facing phone, or standalone camera. Rather, they will be represented to the other participants (from one or more points of view) through their user avatars 821a-c, illustrated in the exemplary embodiments of FIG. 8B, which can provide a 3D character that is a faithful rendition of all the subtleties of their live facial expressions. As the user 601 converses, their facial expression will vary as the system repeatedly acquires RF CSI. In exemplary embodiments of this invention, the user avatar 821a-c looks almost exactly like the expression of user 601 at that moment and in real-time, regardless of the lighting conditions, thus effectively eliminating the need for video camera facing the user 601 for videoconferencing. As illustrated in the exemplary embodiments of FIG. 8C, the user 601 can choose to use a user avatar character that looks very different from them, including different gender, as illustrated in FIG. 8C, or different age, or a character of any appearance they choose, including a non-human character.

In exemplary embodiments illustrated in FIGS. 8B-C, after the facial expression catalog is created in capture database 760, 772-774, or multiple capture databases 860, as described above and illustrated in FIGS. 7A-E, the camera-based facial capture system of FIGS. 7A-E is no longer used, and only the RF transceivers and antennas 611a-b or 614a-b are used, integrated within end-user devices including, but not limited to, smart glasses 650 and earbuds 655a-b as illustrated in FIGS. 6A-C, with the same or similar RF configuration and same SRS transmission and reception configuration as the facial capture system illustrated in FIGS. 7A-E. The user 601 then makes whatever facial expression the user 601 wishes to make, whether it is for a performance or as user 601 goes through their daily life, for example, making a video conference call, such as a FaceTime or Zoom call. The RF transceivers and antennas 611a-b transmit and receive SRSs RF waveforms 618a-b at a periodic rate, as a non-limiting example, at 100 frames as second (each periodic SRS transmission, reception and CSI processing thereof is called herein, without limitation, a frame, as defined above in connection with FIGS. 7A-E), as the user is changing their facial expressions. As one or more SRSs transmissions are received in a given Frame Time (as defined, without limitation, above in connection with FIGS. 7A-E) after contacting the Head Structures of user 601 and going through RF Transformation, the RF CSI 710r derived from the received SRS transmissions is input to the fine-tuned machine learning model 831 to output texture maps 808t and/or 3D tracked mesh 808m to show the 2D and 3D appearance of user 601 in FIG. 8B. Using widely-available 3D rendering tools 810, such as, but not limited to, Autodesk Maya or Blender, or by using proprietary 3D rendering software, the 3D tracked mesh 808m and texture maps 808t can be used to render a 3D face viewable from any angle that will likely resemble what the user 601 looks like when making the neutral expression in FIG. 8B in the form of User Avatar Views 821a-c.

In an exemplary embodiment illustrated in FIG. 8C, the 3D tracked mesh 808m, and potentially the texture maps 808t, can be used to retarget the expression of the user to a different character face, such as a creature face, or to look older or younger, or to look like a different person, using a 3D retargeting system 812, including without limitation, Autodesk Maya and Blender, prior to using the 3D rendering tools 810. If the 3D tracked mesh does not capture all features of the face that are required for the retargeting, for example without limitation, if it does not capture the eyes, then in exemplary embodiments the texture maps 808t can be used with further processing to identify other features, for example, the position of the eyes by, without limitation, tracking the pupil, or the position of the teeth and tongue, to the extent they are visible, by, without limitation, triangulation from multiple camera views, depth estimation, or other means. As illustrated in FIG. 8C, vertices from the 3D tracked mesh 808m, potentially with additional vertices derived from the texture maps 808t, are mapped to corresponding vertices on a 3D rigged mesh 809m of the target character, such that the 3D rigged mesh 809m of the target character 3D vertices are repositioned based on the relative positions of the 3D tracked mesh 808m. For example, without limitation, the vertices at the corners of the mouth in the 3D tracked mesh 808m would be mapped to vertices at the corner of the mouth of the female character 3D rigged mesh 809m, and as a result, then the corners of the mouth in 3D tracked mesh 808m, showing a neutral mouth. The texture maps 809t of the target character is then used in combination with the 3D rigged mesh 809m for the rendering of the target character, resulting in the 3D User Avatar Views 841a-b, rendered with 2 viewpoints each with different angles and distances. The resulting retargeted User Avatar Views 841a-b can be a similar or, as illustrated by the female User Avatar View character 841a-b in FIG. 8C, an entirely different 3D character than the user 601, yet still performing the subtle details of the expression of user 601 (as illustrated in FIG. 8C, the neutral expression performed by user 601 is also performed by the female character shown in the User Avatar Views 841a-b), viewable from any angle, as well as from any distance, with any focal length. In summary, CSI 710r from SRSs received by RF transceivers and antennas 611a-b is input to fine-tuned machine learning model 831 to output texture maps 808t and 3D tracked mesh 808m corresponding to the expression of user 601, and then a wide range of tools can take the 3D tracked mesh and texture maps from the Frame Data Record for that expression and recreate a same or similar face as the user 601 in 2D or 3D performing the expression of user 601, or retarget the user 601 to a similar or entirely different character face with the same expression as illustrated by User Avatar Views 841a-b, or use the expression identification for another purpose.

The present invention provides several significant advantages over prior art video cameras used for videoconferencing and other facial capture applications. Firstly, it is highly adapted to consumer use cases given that it is lightweight and discrete and can be integrated into devices that can be worn all day long and in a wide variety of conditions: while driving, on crowded public transportation, while walking or running, or at a desk while typing on a keyboard. It is completely hands-free as it does not require the user to hold a capturing device such as a mobile phone in front of their face when in a conversation. It also can operate while in the dark or in poorly-lit conditions. It can also properly operate when one's face is partially or completely occluded such as with a surgical-type mask. Secondly, it is highly practical as the RF transceivers operate at very short range and very low RF power levels are necessary. Thus, it consumes very little power, on the order of a milliwatt or less. RF transceivers and antennas 611a-b and 614a-b capture short range RF CSI that results in the generation of a very low data rate even at high capture cycle rates such as 100 frames per second or more that provide very high temporal resolution. Thus, power consumption related to local processing is very low while power consumption related to the transmission of the data for remote processing in a Data Center, if that is required or preferred instead of local processing on the smartphone 840, remains very low as well. This preserves the battery life of the wearable device and the other devices involved in RF CSI data processing and communication. Additionally, it generates texture maps 808t and 3D tracked meshes 808m that enable real-time 3D animation of the User Avatar 821a-c and 841a-b that can present a user view from any angle, illuminated in any way the user prefers, showing the user's face in any way they prefer, including changing age, gender, appearance, styling or even presenting a non-human character.

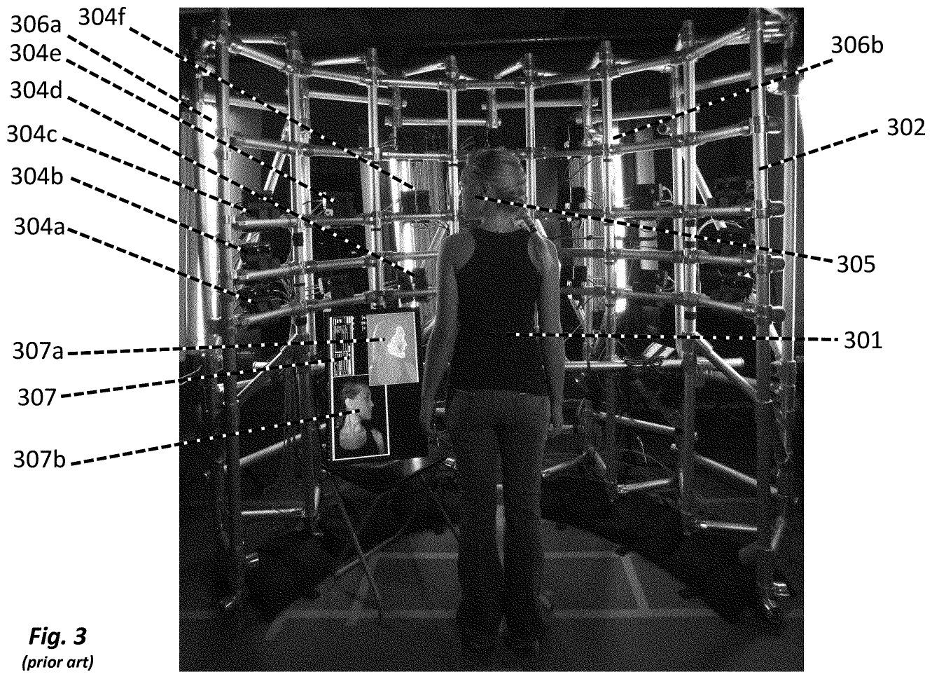

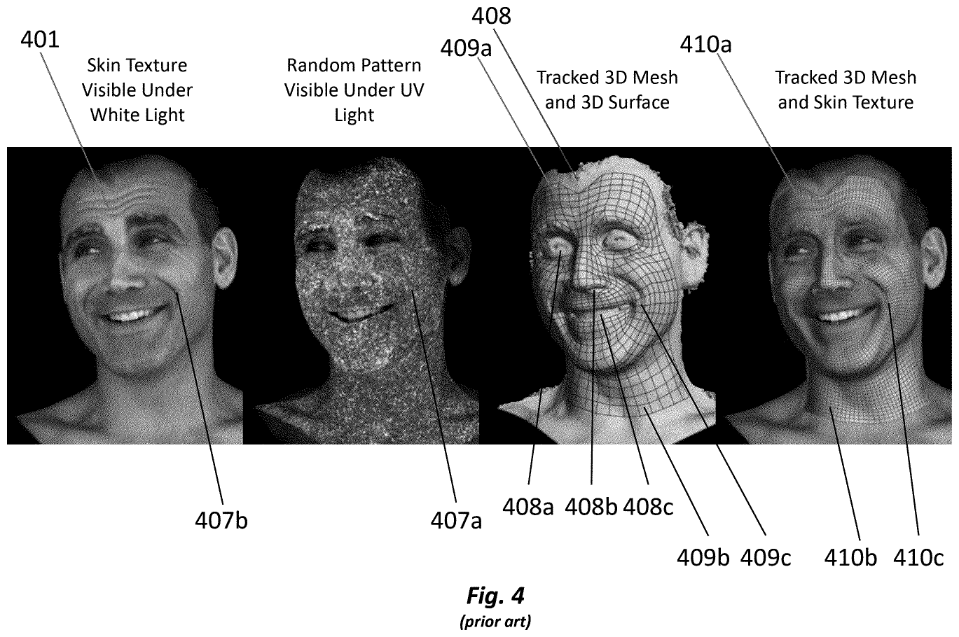

In exemplary embodiments of the present invention, a facial capture user, whether an actor or a consumer, uses a high-resolution facial capture system, whether MOVA Contour (e.g., as illustrated in FIGS. 2-4) or another technology, to capture a tracked mesh of their face in a wide range of facial expressions, such as a neutral facial expression, a smile, a look of surprise, a look of fear, etc., and the 3D tracked mesh configurations from each of these wide range of facial expressions is stored in a catalog of facial expressions (e.g., a capture database 760, 772-774 or multiple capture databases 860), in a first memory (such as, without limitation, volatile memory such as RAM or cache, or non-volatile memory such as Flash memory, solid-state drives (“SSDs”) or magnetic storage such a hard disks or tape, collectively, “Memory”). A prior art facial catalog of facial expressions, such as the Facial Action Coding System (“FACS”, see, e.g., https://en.wikipedia.org/wiki/Facial_Action_Coding_System), can be used or a catalog with more or fewer facial expressions can be used. In addition to capturing the 3D tracked mesh for each facial expression, the MOVA Contour system, or another high-resolution facial capture technology, can also concurrently capture images through one or more cameras of the user's face from one or more angles. Such images can capture images of structures on the face that may not be captured as part of the 3D mesh such as, without limitation, the eyeballs and visible parts of the teeth or tongue. Such images can also capture the appearance of the face when illuminated with a uniform white light, or when illuminated by any other color of light, including non-visible light such as infrared and ultraviolet light. In another embodiment a rapid series of images can be captured of the user's face in a given expression, with each image in the sequence illuminated with a different color. In another embodiment, one or more images can be taken with light sources of one or more than one color capturing the face from different angles so as to result in different shadowing patterns on the face. The images taken for a given expression (collectively, “texture maps”) are also stored in a catalog of expressions (e.g., a capture database 760, 772-774 or multiple capture databases 860) in a second Memory, and in exemplary embodiments texture maps are stored for each expression in the catalog of expressions in the second Memory. In exemplary embodiments the first and second Memories are the same Memory, e.g., a capture database 760, 772-774 or multiple capture databases 860.

While each frame of the facial capture user's facial expressions are captured with the MOVA Contour or other facial capture system and stored in a catalog of facial expressions, e.g., a capture database 760, 772-774 or multiple capture databases 860, simultaneously, RF transceivers with antennas 511a-b or 514a-b, one or more locations within range of the user's face transmit RF sounding reference signals (SRSs) in RF waveforms 518a-b and 519a-b, that reach the surface of the user's face, and RF transceivers with antennas 511a-b or 514a-b at one or more locations within range of transmitted SRSs after they reach the face receive the SRSs. Further, the SRSs will also go through other natural structures in or on the user's head, including but not limited to the eyes, the bones, the cartilage, the teeth, the tongue, hair, mucus, and so forth. The SRSs will also go through non-natural structures in or on the user's head, including dental fillings, dentures, piercings, glasses, contact lenses, makeup, and so forth. The natural and non-natural structures in or on the user's head are collectively “Head Structures”. Such SRS transmissions will reach the Head Structures and will undergo whatever reflection, absorption, refraction, fading, and other RF transformations (collectively “RF Transformations”) are caused by the Head Structures to the SRS, depending on the frequencies; the transmit antenna locations, polarizations, angles, and radiation patterns; the power levels and other configurations of the RF transceivers and antennas 511a-b or 514a-b (collectively “RF Configurations”)

In an exemplary embodiment illustrated in FIGS. 9A-B, the RF transceivers and antennas 511a-b or 514a-b in FIGS. 5A-D and 7A-E, and the RF transceivers and antennas 611a-b or 614a-b in FIGS. 6A-C and 8A-C are illustrated as RF transceivers and antennas 911e-f in FIGS. 9A-B. In an exemplary embodiment illustrated in FIG. 9A, RF transceivers and antennas 911e include, but are not limited to, 2 RF transceivers 912a-b, each including but not limited to a baseband processing unit 940, transmit (“TX”) RF chain 920, receive (“RX”) RF chain 930, RF Switch 925, and TX/RX antenna 916. In the case of 911e, each transceiver RF switch 925 electrically couples TX/RX antennas 916 to either the TX RF chain 920 or the RX RF chain 930, causing the antennas 916 to be used for either transmission or reception at different times. In an exemplary embodiment illustrated in FIG. 9B, RF transceivers and antennas 911f include, but are not limited to, 2 RF transceivers 913a-b, each including but not limited to a baseband processing unit 940, TX RF chain 920, RX RF chain 930, TX antenna 918, and RX antenna 919. In an exemplary embodiment illustrated in FIG. 9B, TX antenna 918 is always coupled to TX RF chain 920 and used only for transmission, and RX antenna 919 is always coupled to RX RF chain 930 and used only for reception. While RF transceivers and antennas 911e illustrates 2 RF transceivers 912a-b that each have a single TX/RX antenna 916, RF transceivers and antennas 911f illustrates 2 RF transceivers 913a-b that each have 1 TX and 1 RX antenna 918 and 919, respectively, this is just for purposes of illustration, RF transceivers and antennas 911e-f each may have one or any number (including, but limited to 10s or 100s) of transceivers 912a-b and 913a-b, and each of RF transceivers and antennas 911e-f may have any combination of transceivers 912a-b and 913a-b that have either a single TX/RX antenna 916 or separate TX and RX antennas 918 and 919, respectively.

In exemplary embodiments, the RF transceivers and antennas 511a-b or 514a-b in FIGS. 5A-D and 7A-E, and the RF transceivers and antennas 611a-b or 614a-b in FIGS. 6A-C and 8A-C may consist of single or multiple RF transceivers and antennas configured as either RF transceivers and antenna 912a-b or 913a-b, or of multiple RF transceivers and antennas configured as combinations of RF transceivers and antenna 912a-b and 913a-b. Right and left transceivers 515a-b and 615a-b of FIGS. 5B and 6B, respectively may correspond to any of the RF transceivers 912a-b or 913a-b.

The antennas of the RX RF chain 930, whether via TX/RX antennas 916 when switched to the RX chain 930 or via RX antennas 919 at all times, will receive the SRSs transmitted from the RF transmitters, in a given RF configuration through the Head Structures, from which the SRSs will each undergo RF Transformations,

In exemplary embodiments, the SRS transmissions happen simultaneously and can be orthogonal to each other, such as, without limitation, Zadoff-Chu sequences. In another embodiment, the SRS transmissions are not orthogonal, but rather intentionally interfere with one another. In another embodiment, some parts of SRS transmissions are orthogonal, and some parts are not. In another embodiment, there is more than one sequential SRS transmission in sequence and the subsequent SRS transmissions are different in one or more of the ways previously described in this paragraph. In another embodiment, the sequential SRS transmissions in the previous sentence each include a different set of RF TX chains 920 and/or antennas 916 or 918 and/or include a different set of RF RX chains 930 and/or antennas 916 or 919. In another embodiment, the SRS transmission can be continuous-wave, pulsed, amplitude-modulated, frequency-modulated, phase-modulated, polarization-modulated, or chip-modulated. In another embodiment, the SRS transmissions are coherent pulse trains, pulsones (pulse trains modulated by a tone) or more general Orthogonal Time Frequency Space (“OTFS”) signals.

In exemplary embodiments illustrated in FIG. 9C, some or all of the RF transmitter antennas 916 (in TX mode) or 918 are at different locations than some or all of the RF receiver antennas 916 (in RX mode) or 919, and in some cases antennas 916 switch from TX to RX mode. The 4 examples illustrate, without limitation, a variety of transmit and receive antenna configurations of one or multiple antennas 916, 918 and 919 from RF transceivers and antennas 511a-b, 514a-b, 611a-b, 614a-b, and 911e-f.

In exemplary embodiments illustrated in FIG. 9D, some or all of the RF transmitter antennas 916 (in TX mode) or 918 are at the same or nearby locations as some or all of the RF receiver antennas 916 (in RX mode) or 919, and in some cases antennas 916 switch from TX to RX mode. The 4 examples illustrate, without limitation, a variety of transmit and receive antenna configurations of one or multiple antennas 916, 918 and 919 from RF transceivers and antennas 511a, 514a, 611a, 614a, and 911e-f.

In an exemplary embodiment, some or all of the RF transmitter antennas 916 or 918 are at different locations than some or all of the RF receiver antennas 916 or 919 for a given SRS transmission, but then for a subsequent SRS transmission, some or all of the previous transmission's RF receiver antennas 916 are used for an SRS transmission by changing RF switch 925 to couple antenna 916 to the TX RF chain 920. In another embodiment, some or all of the RF transmitter antennas 916 or 918 are at different locations than some or all of the RF receiver antennas 916 or 919 for a given SRS transmission, but then for a subsequent SRS transmission, some or all of the RF transmitter antennas 916 are used for SRS reception by changing RF switch 925 to couple antennas 916 to the RX RF chain 930. In another embodiment, some or all of the RF transmitter antennas 916 or 918 are at different locations than some or all of the RF receiver antennas 916 or 919 for a given SRS transmission, but then for a subsequent SRS transmission, some or all of the RF receiver antennas 916 are used for SRS transmission and some or all of the RF transmitter antennas 916 are used for SRS reception.

In exemplary embodiments illustrated in FIG. 9A, each antenna 916 is electrically coupled to a TX RF chain 920 and an RX RF chain 930, which are both electrically coupled to a baseband unit 940. Each antenna 916 is electrically coupled to a TX RF chain and an RX RF chain through an RF switch 925 so the same antenna can alternately be used for RF transmission or for RF reception, respectively. Alternatively, each RF antenna can be electrically coupled to a TX RF chain and an RX RF chain with a fixed connection to the TX RF chain and a variable attenuator to the RX RF chain. When the variable attenuator is enabled or the switch connects the TX chain to the antenna, the RX chain does not receive any signal above the thermal noise floor through the antenna but receives an attenuated version of the RF SRS signal transmission from the TX chain thus creating a loopback channel 950 independent of external factors, such as a configuration of physical elements that can reflect RF signals in a similar way as Head Structures 903. A loopback CSI can thus be derived at controlled time intervals. From the comparison of the loopback CSI at different times to loopback CSI at a reference time, calibration coefficients can be derived such as in the form of a ratio of complex frequency response values at different frequencies stored in the form of a frequency domain response and thus capturing the effect of drift in the RF response of TX and RX RF chains due to static and time-varying external environmental factors including, but not limited to, temperature, humidity, and air pressure, or internal factors, including, but not limited to, manufacturing variances and component aging. The calibration coefficients are applied to subsequent RF channel CSI derived from SRS transmissions and receptions through the antenna to remove the effect of drift in the RF response of TX and RX RF chains. Through this calibration method the CSI is made independent of static and time-varying external and internal factors affecting the RF transceiver TX chain and RX chain response so their confounding effects are removed thus making the CSI only dependent upon the configuration of Head Structures 903.

In exemplary embodiments illustrated in FIG. 9B, each pair of RF antennas has an TX antenna 918 that is electrically coupled to a TX RF chain 920 and an RX antenna 919 that is electrically coupled to an RX RF chain 930, which are both connected to a baseband unit 940. Under normal operation, when the RF transceiver transmits an RF SRS signal through TX antenna 918, some of that signal couples directly into the RX antenna 919 that is connected to the RX chain and some of that signal is reflected back by the Head Structures 903. That direct coupling effectively creates a Loopback Channel 950 distinguishable from the channel formed by reflections on Head Structures 903 and thus only dependent on factors affecting the RF transceiver TX and RX responses. A loopback CSI can thus be derived at each RF SRS signal transmission cycle. From the comparison of the loopback CSI at different times to loopback CSI at a reference time, calibration coefficients can be derived such as in the form of a ratio of complex frequency response values at different frequencies stored in the form of a frequency domain response and thus capturing the effect of drift in the RF response of TX and RX RF chains due to static and time-varying external and internal factors. The calibration coefficients are applied to RF channel CSI derived from SRS transmissions through TX antenna 918, transformation by the Head Structures 903, and receptions through RX antenna 919 to remove the effect of drift in the RF response of TX RF chain 920 and RX RF chain 930. Through this calibration method the CSI is made independent of static and time-varying external factors such as temperature affecting the RF transceiver TX chain and RX chain response so their confounding effect is removed and the CSI is only dependent upon the configuration of Head Structures 903.

In exemplary embodiments, RF transceivers 912a-b with antennas 916, respectively 913a-b with antennas 918-919, are monostatic or multistatic coherent radar modules, which operate in a non-limiting synchronized fashion or a non-limiting non-synchronized fashion either in non-limiting continuous-wave, pulsed, amplitude-modulated, frequency-modulated, phase-modulated, polarization-modulated, or chip-modulated modes.

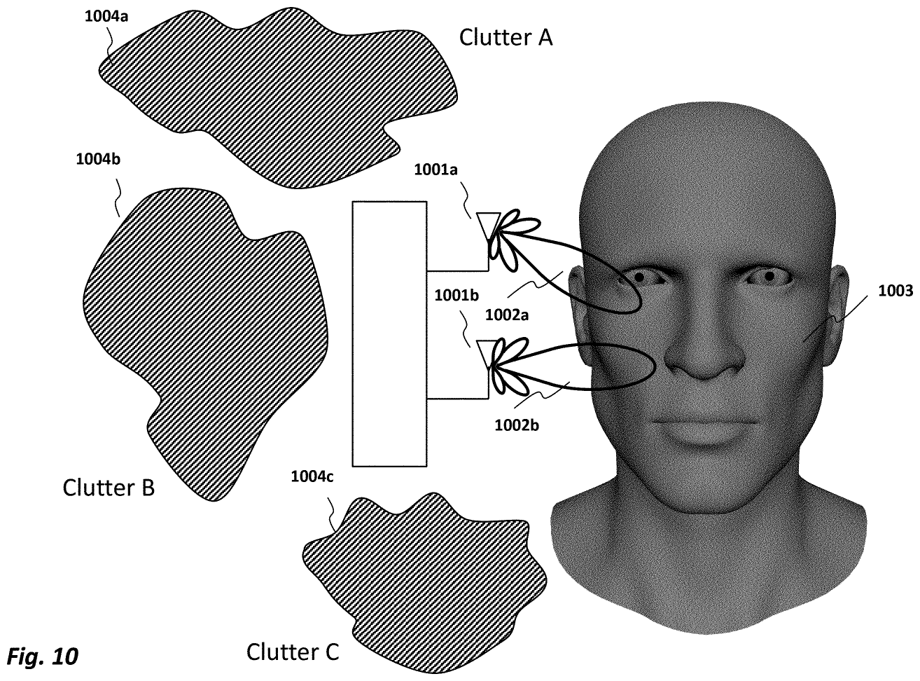

In exemplary embodiments, as shown in FIG. 10, some or all of the antennas 1001a-b are directional antennas creating RF beams 1002a-b aimed at areas of a user's face 1003 and away from environmental clutter 1004a-c. By way of example, but not limitation, environmental clutter is any RF reflective or absorbent objects in the environment around the user that are within range of the right or left RF waveform transmissions shown in FIGS. 5A-D, 6A-C, 7A-E and 8. In an exemplary embodiment, some or all of the antennas 1001a and 1001b are formed of multiple antenna elements so as to form an array that generates a steerable transmit (TX) or receive (RX) beam 1002a-b for the SRS signal aimed at areas of a user's face 1003. In an exemplary embodiment, the beams 1002a or 1002b could be the same or different from transmission to transmission. In another embodiment the beams 1002a-b are set or steered away from environmental clutter.

In an exemplary embodiment in FIGS. 7A-E, concurrent with the subjects 501-505 making facial expressions captured as texture maps 730t and tracked 3D meshes 730m, using a high-resolution facial capture system such as MOVA Contour or others, and recorded in a catalog of expressions capture database 760 or 772-774, the RF transceivers and antennas 511a-b will make one or more SRS transmissions that go through the Head Structures of the subjects 501-505, and will undergo RF Transformations, and then will be received by RF transceivers and antennas 511a-b. The RF channel state information (“CSI”) 710r received by each of the RF transceivers and antennas 511a-b will then be stored in capture database 760, 772-774 or multiple capture databases 860 as 764a-d, which in exemplary embodiments will also store the texture maps 730t and 3D surface meshes 730m of the facial expression of subjects 501-505 as 766a-d and 767a-d, respectively. Thus, after the user has completed all of the facial expressions for the catalog of facial expressions stored in capture database 760, 772-774 or multiple capture databases 860, there will be a catalog of a texture maps 766a-d and tracked 3D surface meshes 767a-d stored for each facial expression in capture database 760, 772-774 or multiple capture databases 860, and there will be corresponding CSI 764a-d from each of the SRSs received by the RF receivers concurrently with each facial expression stored in capture database 760, 772-774 or multiple capture databases 860.

In an exemplary embodiment, the SRS transmissions go through the Head Structures, which are arranged in a unique configuration for each unique facial expression. As the SRS signals go through the Head Structures in such a configuration, they undergo RF Transformations and are received by the RF transceivers and antennas 511a-b. Hard-wired logic or a processor operatively connected to memory are operatively connected to the RF transceivers and antennas 511a-b and compare the original SRS signals to the SRS signals after they have undergone RF transformations, from which they derive the corresponding RF CSI in the domain most appropriate to its representation, such as a frequency-domain response, a time-domain impulse response, a delay-doppler representation, or other RF feature representation commonly known by a person having ordinary skill in the art.

In exemplary embodiments illustrated in FIGS. 9A-B, the SRS transmissions are formed from baseband input data 915i, which consists in a succession of finite-length sequences of complex baseband values in the time domain passed to the baseband processing unit 940 that up-samples, performs Tx pulse shaping and performs digital to analog conversion. The output of baseband processing unit 940 is then passed to the TX RF chain 920 that up-converts the baseband analog signal by modulating it with an RF carrier produced by a local oscillator at the transceiver RF frequency and amplifying it, resulting in the SRS RF signal presented to the antenna feed for transmission and radiation through antenna 916 in FIG. 9A or 918 in FIG. 9B. Conversely, SRS receptions through antenna 916 in FIG. 9A or 919 in FIG. 9B, are converted to baseband output data 9150 by first going through the RX RF chain 930, which first amplifies the signal by means of a low-noise amplifier (LNA) and down-converts it by demodulating it with a carrier signal produced by a local oscillator at the transceiver RF frequency. The result of down-conversion is subsequently passed to the baseband processing unit 940, which first carries out waveform correction using the non-limiting calibration methods described above that make use of the loopback channel illustrated in FIG. 9A-B so the waveform is made independent of static and time-varying external factors such as temperature affecting the RF transceiver TX chain and RX chain response so their confounding effect is removed and the waveforms are only dependent upon the configuration of Head Structures 903. Baseband processing unit 940 subsequently performs sampling, analog to digital conversion, match filtering, and down-sampling to produce baseband output data 9150 in the form of a finite sequence of digital complex samples with q bits of resolution, exemplary embodiments of which are illustrated in FIG. 11. In addition, baseband processing unit 940 may include, without limitation, automatic gain control, dynamic range enhancement, noise reduction, resampling, filtering, timing and synchronization functions, and compression/decompression, including but not limited to lossless and lossy compression.

In exemplary embodiments, RF transceivers 912a-b or 913a-b can internally generate the baseband input data 915i according to a pre-programmed pattern stored in non-volatile memory logically coupled to the baseband processing unit 940.

In other exemplary embodiments, baseband input 915i consists in a succession of finite-length sequences of complex baseband digital values in the frequency domain, which are converted to their time-domain representation in the baseband processing unit 940.

In other exemplary embodiments, the baseband processing unit 940 includes digital mixers to up-convert the transmit signal to an intermediate frequency (IF) before passing it to the TX RF chain 920 that subsequently up-converts it to the carrier frequency. Conversely, the baseband processing unit 940 takes the output of the RX RF chain 930 at the IF frequency, and performs sampling, analog to digital conversion, and down-conversion to baseband using digital mixers before proceeding with match filtering and down-sampling.

In exemplary embodiments illustrated in FIG. 11, the plurality of antennas is composed of a set of two (2) antennas A0 and A1. For each antenna pair, the corresponding CSI component is derived from the baseband complex envelope in the time domain of the received SRS signal transmitted from one antenna, as a non-limiting example, A0, and received by a second antenna, as a non-limiting example, A1. Each CSI component is represented in the form of finite sequence of complex samples. Each complex sample is formed of an I real component (in-phase component or the real part of the complex sample) and a Q component (in-quadrature component or the imaginary part of the complex sample). The length N of the sequence of I-Q samples thus depends on the system sampling rate F_{S}, its maximum range R_{MAX}, and the speed of light c (299,792,458 m/s in vacuum). (Although the speed of light is slightly slower in air than c, the difference has no impact on the functionality of these exemplary embodiments.) The maximum range sets a limit on the round-trip time of the SRS signals transmitted and received by the set of RF transceivers and antennas 911e-f from FIGS. 9A-B in such a way that all transformations due to nearby Head Structures are included and the transformations due to other possible surrounding environmental clutter 1004a-c from FIG. 10 located further away than the Head Structures are excluded. In this way the length N of complex samples (or I-Q pairs) is given by N=2·R_{MAX}·F_{S}/c. In particular, the length N of complex samples is proportional to R_{MAX}. This is illustrated in FIG. 11 where, as a non-limiting example, F_{S}=12 GHz and for each of the 4 possible pairs of antennas used for SRS transmission and reception the sequence of complex samples is of length 8 (complex samples S₀-S₇) when, as a non-limiting example, R_{MAX} is 0.1 m and it is of length 16 (complex samples S₀-S₁₅) when, as a non-limiting example, R_{MAX} is 0.2 m.

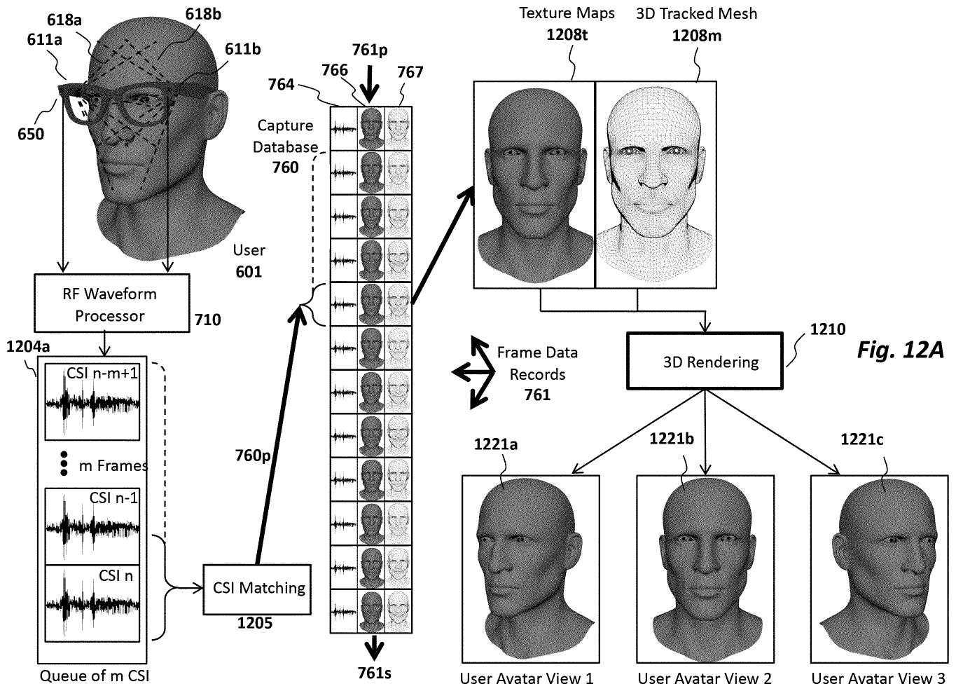

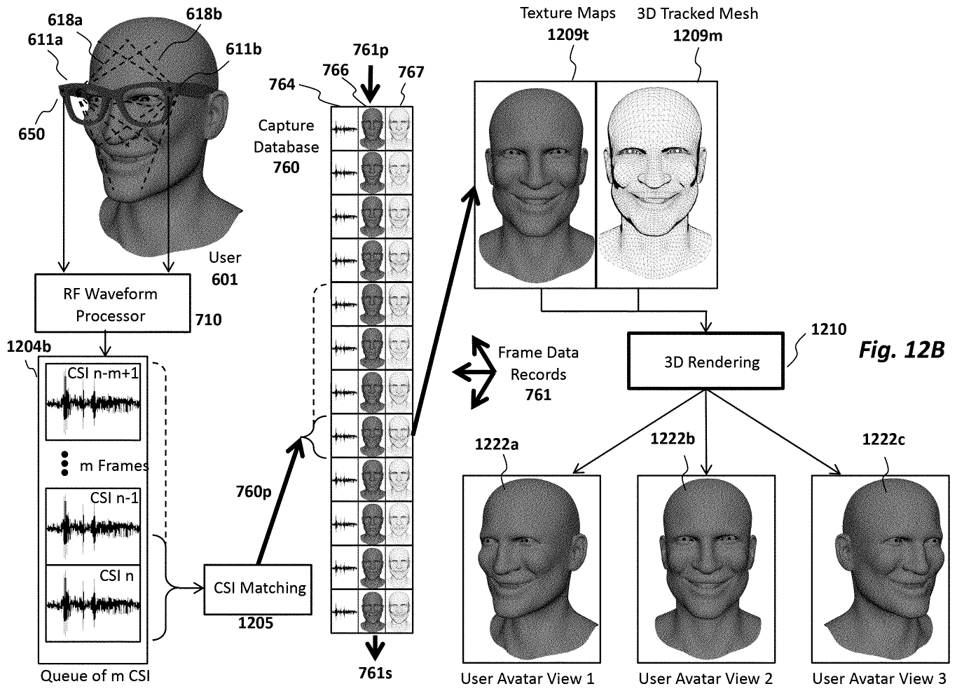

In exemplary embodiments illustrated in FIG. 12A-B, after the facial expression catalog is created in capture database 760, 772-774, or multiple capture databases 860, as described above and illustrated in FIGS. 7A-E, the camera-based facial capture system of FIGS. 7A-E is no longer used, and only the RF transceivers and antennas 611a-b or 614a-b are used, integrated within end-user devices including, but not limited to, smart glasses 650 and earbuds 655a-b as illustrated in FIGS. 6A-C, with the same or similar RF configuration and same SRS transmission and reception configuration as the facial capture system illustrated in FIGS. 7A-E. The user 601 then makes whatever facial expression the user 601 wishes to make, whether it is for a performance or as they go through the daily life of user 601, for example, making a video conference call, such as a FaceTime or Zoom call. The RF transceivers and antennas 611a-b transmit and receive SRSs RF waveforms 618a-b at a periodic rate, as a non-limiting example, at 100 frames as second (each periodic SRS transmission, reception and CSI processing thereof is called herein, without limitation, a frame, as defined above in connection with FIGS. 7A-E), as the user is changing their facial expressions. As one or more SRSs transmissions are received in a given Frame Time (as defined, without limitation, above in connection with FIGS. 7A-E) after contacting the Head Structures of user 601 and going through RF Transformation, the one or more CSI 1204a derived from the received SRS transmissions is compared in CSI matching unit 1205 with each of the many captured one or more CSI 764 in the Frame Data Records 761 stored in the capture database 760, 772-774 or multiple capture databases 860. For the sake of illustration, FIG. 12A-B illustrates only 12 Frame Data Records 761, and only illustrates Capture Data types of CSI 764, texture maps 766, and 3D tracked meshes 767, but there are typically many more (potentially millions or far more) Frame Data Records, as illustrated by 761p showing previous, and 761s showing subsequent Frame Data Records, with more Capture Data types, including, but not limited to, audio, time code and metadata such as but limited to identifying or descriptive information related to capture subject 501-505. When the one or more CSI 1204a matches the one or more CSI 764 in a Frame Data Record in the capture database 760, 772-774 or multiple capture databases 860, then the CSI matching unit 1205 provides a pointer 760p to the Frame Data Record with the matched CSI 764, which identifies a correlation between the neutral expression performed by subject 501-505 during that Frame Data Record's Frame Time and the expression currently performed by the user 601. The Capture Data from that Frame Data Record is then identified from the capture database 760, 772-774 or multiple capture databases 860, including, but not limited to, texture maps 766, labeled as texture maps 1208t, and 3D tracked mesh 767, labeled as 3D tracked mesh 1208m. Texture maps 1208t and 3D tracked mesh 1208m show the 2D and 3D appearance of the subject 501-505's face during the Frame Time when the same or a similar one or more CSI 1204a was captured in FIGS. 7A-E, and as a result will likely correlate to a same or similar appearance as the expression of user 601 in FIG. 12A. Using widely-available 3D rendering tools 1210, such as, but not limited to, Autodesk Maya or Blender, or by using proprietary 3D rendering software, the 3D tracked mesh 1208m and texture maps 1208t can be used to render a 3D face viewable from any angle that will likely resemble what the user 601 looks like when making the neutral expression in FIG. 12A in the form of User Avatar Views 1221a-c.

In exemplary embodiment illustrated in FIG. 12B, the user has changed the performed expression from the neutral expression in FIG. 12A to a smile expression. The RF transceivers and antennas 611a-b transmit and receive SRSs RF waveforms 618a-b during the Frame Time of FIG. 12B after contacting the Head Structures of user 601 and going through RF Transformation, and the one or more CSI 1204a derived from the received SRS transmissions is compared in CSI matching unit 1205 with each of the many captured one or more CSI 764 in the Frame Data Records 761 stored in the capture database 760, 772-774 or multiple capture databases 860. When the one or more CSI 1204a matches the one or more CSI 764 in a Frame Data Record in the capture database 760, 772-774 or multiple capture databases 860, then the CSI matching unit 1205 provides a pointer 760p to the Frame Data Record with the matched one or more CSI 764, which identifies a correlation between the expression performed by subject 501-505 during that Frame Data Record's Frame Time and the smile expression currently performed by the user 601. The Capture Data from that Frame Data Record is then identified from the capture database 760, 772-774 or multiple capture databases 860, including, but not limited to, texture maps 766, labeled as texture maps 1209t, and 3D tracked mesh 767, labeled as 3D tracked mesh 1209m. Texture maps 1209t and 3D tracked mesh 1209m show the 2D and 3D appearance of the subject 501-505's face during the Frame Time when the same or a similar one or more CSI 1204a was captured in FIGS. 7A-E, and as result will likely correlate to the same or a similar appearance as user 601 expression in FIG. 12B. Using widely-available 3D rendering tools 1210, such as, but not limited to, Autodesk Maya or Blender, or by using proprietary 3D rendering software, the 3D tracked mesh 1209m and texture maps 1209t can be used to render a 3D face viewable from any angle that will likely resemble what the user 601 looks like when making the smile expression in FIG. 12B in the form of User Avatar Views 1222a-c.

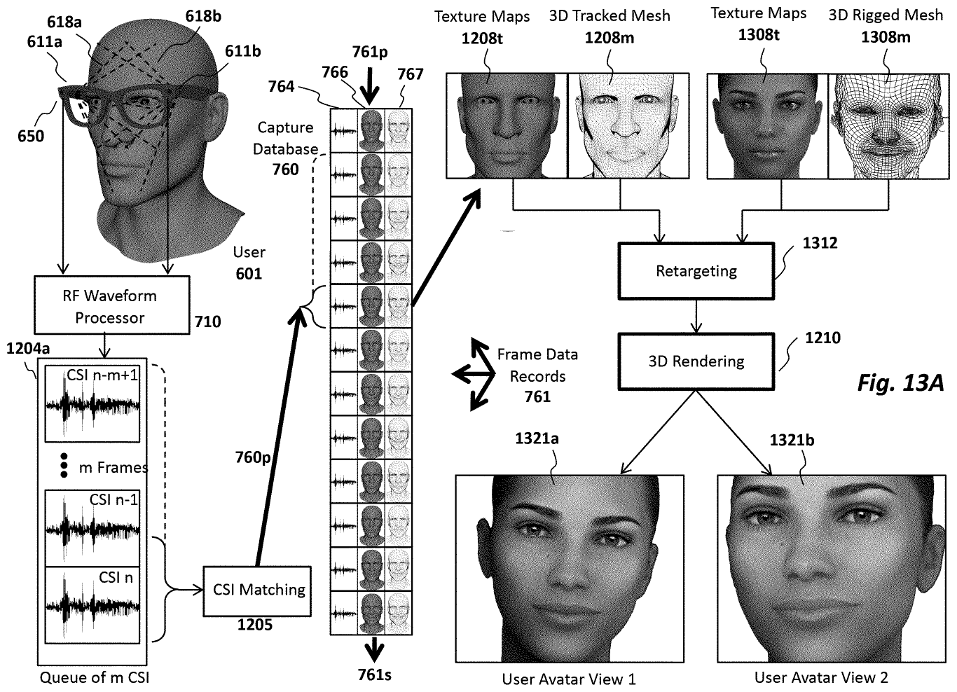

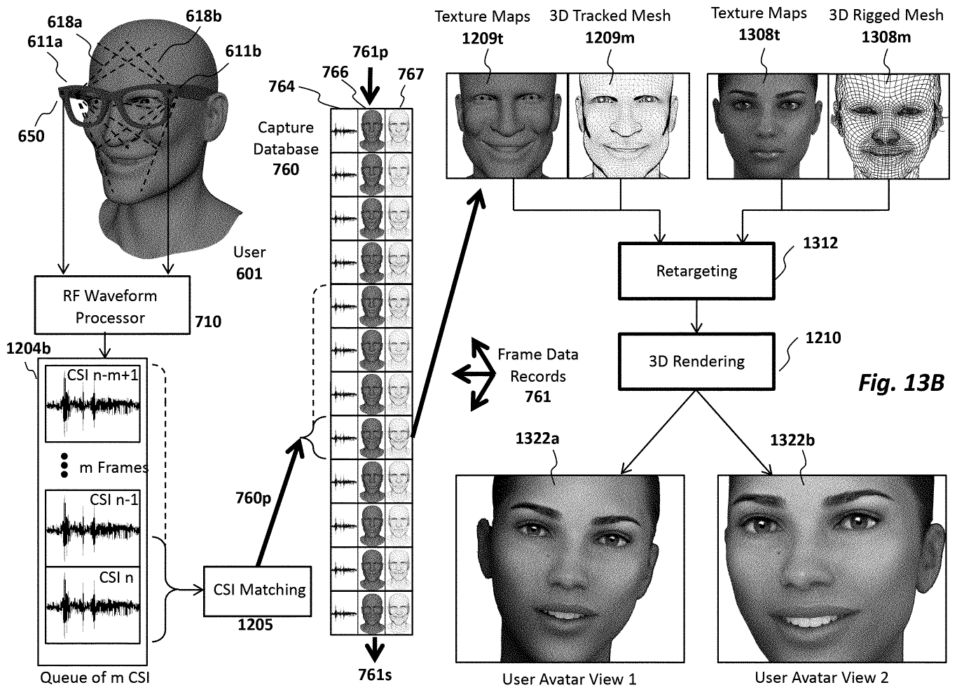

In an exemplary embodiment illustrated in FIG. 13A-B, the 3D tracked meshes 1208m and 1209m, and potentially the texture maps 1208t and 1209t, can be used to retarget the expression of the user to a different character face, such as a creature face, or to look older or younger, or to look like a different person, using a 3D retargeting system 1312, including without limitation, Autodesk Maya and Blender, prior to using the 3D rendering tools 1210. If the 3D tracked mesh does not capture all features of the face that are required for the retargeting, for example without limitation, if it does not capture the eyes, then in exemplary embodiments the texture maps 1208t and/or 1209t can be used with further processing to identify other features, for example, the position of the eyes by, without limitation, tracking the pupil, or the position of the teeth and tongue, to the extent they are visible, by, without limitation, triangulation from multiple camera views, depth estimation, or other means. As illustrated in FIG. 13A, vertices from the 3D tracked mesh 1208m, potentially with additional vertices derived from the texture maps 1208t, are mapped to corresponding vertices on a 3D rigged mesh 1308m of the target character, such that the 3D rigged mesh 1308m of the target character 3D vertices are repositioned based on the relative positions of the 3D tracked mesh 1208m. For example, without limitation, the vertices at the corners of the mouth in the 3D tracked mesh 1208m would be mapped to vertices at the corner of the mouth of the female character 3D rigged mesh 1308m, and as a result, then the corners of the mouth in 3D tracked mesh 1208m, showing a neutral mouth. The texture maps 1308t of the target character is then used in combination with the 3D rigged mesh 1308m for the rendering of the target character, resulting in the 3D User Avatar Views 1321a-b, rendered with 2 viewpoints each with different angles and distances. The resulting retargeted User Avatar Views 1321a-b can be a similar or, as illustrated by the female User Avatar View character in FIG. 13A, an entirely different 3D character than the user 601, yet still performing the subtle details of the expression of user 601 (as illustrated in FIG. 13A, the neutral expression performed by user 601 is also performed by the female character shown in the User Avatar Views 1321a-b), viewable from any angle, as well as from any distance, with any focal length. In summary, matching one or more of the CSI 1204a from SRSs received by RF transceivers and antennas 611a-b to a CSI Frame Data Record in the capture database 760, 772-774 or multiple capture databases 860 correlates to the expression of user 601, and then a wide range of tools can take the 3D tracked mesh and texture maps from the Frame Data Record for that expression and recreate a same or similar face as the user 601 in 2D or 3D performing the expression of user 601, or retarget the user 601 to a similar or entirely different character face with the same expression as illustrated by User Avatar Views 1321a-b, or use the expression identification for another purpose.

In the exemplary embodiment illustrated in FIG. 13A, the user 601 was performing a neutral expression, and the 3D tracked mesh 1208m, and the texture maps 1208t as previously described, reflected that neutral expression, and the retargeted female 3D character performed the same neutral expression when rendered from the two viewpoints in User Avatar Views 1321a-b. In an exemplary embodiment illustrated in FIG. 13B, the user 601 is performing the same smile expression as in FIG. 12B, the 3D tracked mesh 1209m, and the texture maps 1209t reflect that smile expression, and as a result, the retargeted female 3D character appears to have the same smile expression when rendered from two viewpoints in User Avatar Views 1322a-b. This change in the retargeting female character's expression is due to the change in the positions of some or all of the vertices from 3D tracked mesh 1208m to 1209m and/or the changes in the texture maps 1208t to 1209t, which in turn changes the positions of vertices of 3D rigged mesh 1308m of the female target character, which, when rendered with texture maps 1308t results in the retargeted female character smiling just like user 601 is smiling in FIG. 12B.

In an exemplary embodiment, in accordance with above descriptions illustrated by FIGS. 12A-B and FIGS. 13A-B, as the user 601 changes expression the RF transceivers and antennas 611a-b will periodically transmit SRS RF waveforms 618a-b that goes through RF Transformation when it contacts the face and are received by the RF transceivers and antennas 611a-b, and the one or more CSI 1204a-b that is derived from the received RF waveforms is matched to one or more CSI 764 in a Frame Data Record 761 in the capture database 760, 772-774 or multiple capture databases 860 and texture maps 766 and/or 3D tracked meshes 767 from that Frame Data Record are output as texture maps 1208t or 1209t and 3D tracked meshes 1208m or 1209m, which are then used to render a 2D or 3D User Avatar View 1221a-c or 1222a-c and/or used to retarget to a different character with texture maps 1308t and 3D rigged mesh 1308m and render a 2D or 3D User Avatar View 1321a-b or 1322a-b.

In exemplary embodiments either the same system or a different system will render the face of the user or the face of a retargeted character using the 3D texture maps and/or 3D meshes for one or more of the facial expressions identified by CSI. In another embodiment, either the same system or a different system will render the face of the user or the face of a retargeted character using texture maps and/or 3D tracked meshes for one or more of the facial expressions, and will also render intermediate facial expressions between the facial expressions identified by CSI. Such intermediate facial expressions can be generated by techniques such as, without limitation, blend shapes, or interpolations in 3D under some interpolation criteria between the 3D tracked mesh of sequential facial expressions. In exemplary embodiments the faces will be rendered in real time as the user is changing their expression. In another embodiment, the faces will be rendered in non-real time.

As the user's surrounding environment changes, the CSI from SRSs that reach the surrounding environment will change, potentially impacting the system's ability to match the one or more CSI 1204a-b from the user's expression in the new environment to the one or more CSI 764 in the capture database 760, 772-774 or multiple capture databases 860. Further, if the user moves their head relative to the antennas of RF transceivers and antennas 611a-b if they are not attached to the head, the CSI may also change. In exemplary embodiments as shown in FIG. 6A-C, the RF transceivers and antennas 611a-b are attached to the head by a means such as, without limitation, placing the RF transceivers and antennas 611a-b in one or more parts of smart glasses 650, including the temples 651a-b, rims 652a-b, endpieces 654a-b, and bridge 653; in earbuds 655a-b, earphones or headphones; in one or more parts of virtual reality, augmented reality, or extended reality headsets; in hats; in over-the-ear clips; in ear studs or earrings; in tooth caps; and/or implanted in the head.

In another embodiment, the CSI from the user's environment beyond the extent of the user's face and head is limited by the system only storing CSI that has a time of flight within a limited time range after the SRS transmission. Given that the SRS transmission will travel at close to the speed of light, this constraint can disregard CSI that is from further away than the distance of the user's face and head as shown in FIG. 11 and explained in a previous paragraph. Thus, changes in the environment around the user will not affect the CSI measured from the user's face and head.

In another embodiment, the facial capture and CSI capture process illustrated in FIGS. 7A-E will be carried out more than once with one or more subjects, with a subject 501-505 adding or removing objects that they may attach to their head such as, without limitation, glasses or earphones. In this way, capture databases 760, 772-774 or multiple capture databases 860 are created with CSI 764, texture maps 766 and 3D tracking meshes 767 for circumstances where the user 601 has other objects attached to their head. Thus, if the user puts on objects which affect the CSI 710r, the systems and methods described above and illustrated by FIGS. 12A-B and 13A-B will have a higher likelihood of correctly identifying the expression of user 601.

In another embodiment, ISM band spectrum, such as, but not limited to, 900 MHz, 2.4 GHz, and 5 GHz spectrum, is used for the SRSs. In another embodiment, reserved spectrum such as the 3.5 GHZ CBRS band in the United States is used for the SRSs. In another embodiment, ultra-wideband spectrum is used for the SRSs. In another embodiment, licensed spectrum is used for the SRSs. In another embodiment, unlicensed spectrum is used for the SRSs. In another embodiment, more than one of the bands referenced in this paragraph are used for the SRSs.

In another embodiment, part, but not all of the CSI 710r spectrum is used to identify expressions. For example, if 20 MHz of spectrum is used, and the CSI 710r matches for part of the band, but does not match for another part of the band, then it could be due to some object that is attached to or near the face that is changing the CSI 710r at some frequencies, but not others. This is especially true in the case of ultra-wideband, where a very wide range of frequencies are used for the SRS and CSI 710r.

In another embodiment, structures within the head such as, without limitation, the jaw, the tongue and the eyes, are tracked during Capture Sessions described above and illustrated by FIGS. 7A-E and the position of these structures is stored as a type of Capture Data in Frame Data Records 761 in the capture database 760, 772-774 or multiple capture databases 860. For example, a sensor such as, without limitation, an inertial sensor can be attached to a lower tooth (which is attached to the jaw), and as user moves their jaw, the sensor would track the motion of the jaw, and the system would record the CSI 710r of that motion, creating a capture database 760, 772-774 or multiple capture databases 860 that includes Frame Data Records 761, which includes CSI 764 and Capture Data for jaw motion.

In another embodiment, after the expressions of multiple users are captured into the multiple capture database 860 with 3D tracked meshes 767 and texture maps 766, and CSI 764, the multiple capture database 860 is used to train machine learning algorithms to learn CSI 764 patterns that can be used to identify user facial expressions, and associated 3D tracked meshes 767 and texture maps 766 in general, without requiring the process of using a high-resolution facial capture system like MOVA Contour or another technology in order to associate CSI 710r with a facial expression. The machine learning system can be trained on the CSI 710r in accordance with any of the embodiments mentioned previously, but it can also be trained using other factors including, without limitation, how the CSI 710r changes between cataloged expressions; how the CSI 710r changes when only certain parts of the face move (e.g., if one eye winks, or if only the mouth moves); how the CSI 710r changes when eyeballs move the direction of their gaze. Over time, as there are increasingly more subjects 501-505 whose facial expressions are captured, the machine learning system can add to its training, becoming increasingly adept at being able to identify human facial expressions from the one or more CSI 1204a, regardless of the user.

Whether using machine learning or not, the systems and methods described above can be built into, without limitation, earbuds 655a-b, earphones; smart glasses 650; virtual reality, augmented reality, and extended reality headsets; hats, etc. Then, the output from such a system, whether it is a face that looks like the user 601, a character whose face is driven by the user 601, or something else, can be used for any purpose where the user's facial expression or appearance could be used. For example, in the case of a videoconference call such as a FaceTime or Zoom call, the user 601 could wear devices such as, without limitation, earbuds 655a-b or smart glasses 650, which include the RF transmitters and antenna 611a-b or 614a-b using the embodiments disclosed herein, and rather than using video from a camera pointed at their face for the videoconference, a video image of their face (together with a head and body, as desired) can be generated in real-time, and used for the videoconference. This not only eliminates the need for using a camera over a monitor or on a smartphone, but it eliminates the need for the user 601 being in a well-lit area. Indeed, this system would show a video of their face as they spoke and changed expressions even if they spoke in complete darkness since their facial expression would be identified by RF, not by light. Further, it would eliminate the need for the video teleconference system to remove undesirable backgrounds. The face of user 601 could be placed into any environment, both two-dimensional (2D) and three-dimensional (3D). Further, because the system would be able to output the expression of the user 601 as a 3D tracked mesh 1208m and 1209m, this would allow for very high-quality retargeting 1312 of the face of user 601 to another face. A user 601 might want to look younger or older. The user 601 might want to look like someone else or a cartoon character, etc. If the user 601 is using automatic translation into another language, they might want the lips of their mouth to be reshaped to look as they should for speaking in the other language. These advantages not only apply to videoconferencing, but they apply to how the user 601 appears as a character in videogames or virtual reality/augmented reality/extended reality (“VR/AR/XR”) worlds. Since their face is captured in 3D with very high resolution, it can be retargeted in real-time to look like any character they want, and the full expressiveness of their character will appear in the game or VR/AR/XR world.

In an exemplary embodiment, this technology can be used to capture motion within the head of the user 601 such as, without limitation, tongue motion. For example, if the user 601 is wearing smart glasses 650 with a heads-up display, then the user 601 can be presented with a selection choice (e.g., “yes” or “no”) on the heads-up display, and the user 601 can make the selection by moving their tongue, for example, to the left for “yes” and to the right for “no”. This would allow the user to interact with smart glasses 650 without having to move their hands. For example, if a user 601 is in a business meeting, if a text arrived and was shown on the heads-up smart glasses 650 display, they could respond to the text without any visible motion to the other attendees in the meeting.

In exemplary embodiments, this facial capture technology can also be used in motion picture and videogame production. Typically, facial capture systems for motion picture and videogame production require a head mounted camera (“HMC”) which is a helmet that holds one or more cameras in front of the face of the performer or a camera view of the performer's face that is unobstructed during the performance. This interferes with the production and, in the case of movies, requires a post-production clean-up step for the HMCs to be removed from the scene. Also, HMCs are typically limited in their resolution and accuracy. With the technology described herein, the videogame or movie performer would not need an HMC, but rather would have small RF transmitters and RF receivers attached to their heads, potentially within earbuds 655a-b or, if a filmmaker wants them completely hidden from view, such as, without limitation, attached behind the ears or underneath a wig. This would allow videogame and motion picture production to have high-resolution facial capture of performers with no visible facial capture equipment.

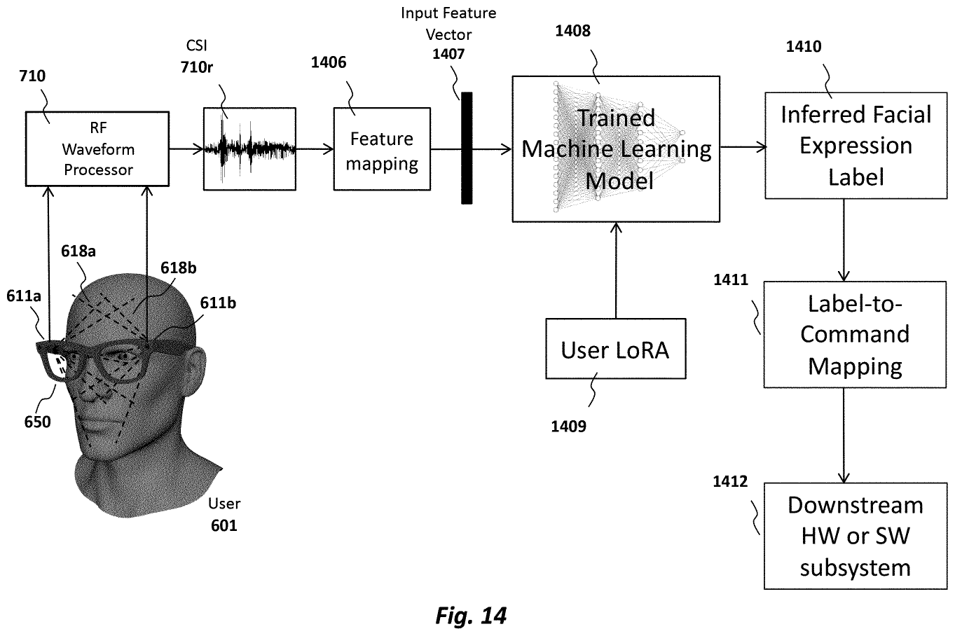

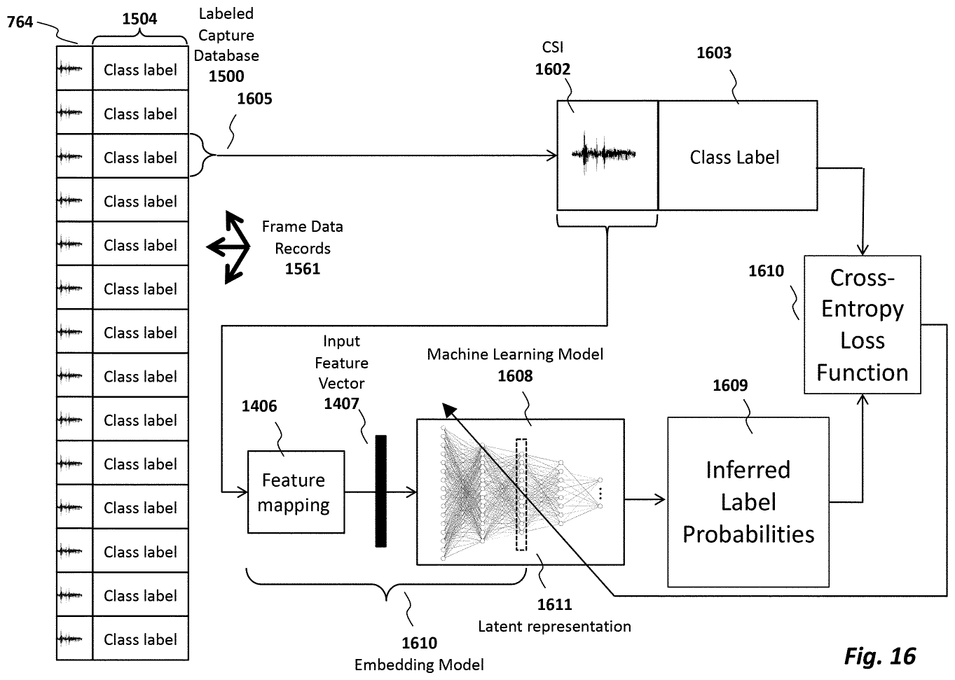

In exemplary embodiments of the invention shown in FIG. 14, the RF CSI-based motion capture system controls the discrete actions of downstream hardware or software subsystems such as mobile phone or a connected watch 1412. The elements numbered in FIG. 14 that have the same numbers in FIGS. 6A-C, 7A-E, 8, 9C-D, 12A-B, and 13A-B are the same elements. The embodiment incorporates RF transceivers 611a-b integrated into a wearable device such as a pair of smart glasses 650. The integrated RF transceivers and antennas 611a-b implement the transmission and reception of SRS signals illustrated as RF waveforms 618a-b that undergo an RF Transformation by their propagation through and reflection on Head Structures of user 601. An RF waveform processor 710 derives from RF waveforms 618a-b the CSI 710r between pairs of transmit and receive antennas, as described above and illustrated in FIGS. 9A-D in the form of CSI RF baseband waveforms. This CSI 710r, which is arranged in a multidimensional real or complex vector, is further processed through a feature mapping unit 1406 to derive an input feature vector 1407. The feature mapping unit 1406 can perform operations that enhance or suppress certain features in the raw CSI 710r. Examples of such feature mapping operations include but are not limited to: 1) impulse response shortening to only retain values corresponding to RF Transformations limited to Head Structures, which are confined within a certain distance from the RF antennas and thus exclude values corresponding to unrelated objects or clutter, as described above and illustrated in FIG. 11; 2) domain conversion such as from time-domain representations to frequency-domain representations; and/or 3) linear or non-linear dimensionality-reduction, which can improve computational efficiency and provide noise reduction benefits, such as through principal component analysis (PCA), t-distributed stochastic neighbor embedding (t-SNE), or uniform manifold approximation and projection (UMAP). Such elementary feature mapping operations can be concatenated to form an overall feature mapping resulting in the input feature vector 1407. The input feature vector 1407 is subsequently input to a trained machine learning model 1408 performing a classification task, which, in exemplary embodiments, is a multilayer perceptron (MLP), the last layer of which has as many logit nodes as the number of class labels and can be followed by a softmax layer to output Inferred facial expression label probabilities. Such a trained machine learning model 1408 was previously trained on a labelled dataset with a variety of subjects as explained below and illustrated in FIG. 16 and fine-tuned by loading, without limitation, a LORA 1409 by a given user 601 of the system as described above and illustrated in FIGS. 8A-C. Trained machine learning model 1408 is designated machine learning model 1608 in FIG. 16 before its training was complete and is exactly the same as trained machine learning model 1408 except for the value of its internal parameters. The trained machine learning model 1408 returns an inferred facial expression label 1410, which can be attached to a specific and localized facial action such as the blinking of an eye or an overall facial expression such as a smile. The label-to-command mapping unit 1411 takes the inferred facial expression label 1410 and maps it to an action resulting in a change of the state of hardwired application-specific logic or a processor, such as through an application programming interface (API) call, triggering changes in the state of downstream hardware or software subsystems 1412. As an example without limitation, when user 601 is alerted by wearable 650, perhaps by a voice stating, “Call from Felix”, indicating that someone named Felix is calling, then user 601 could perform a specific facial action, for example without limitation, blinking or double blinking, that results in an inferred facial expression label 1410, which causes the label-to-command mapping unit 1411 to send a message or make an API call to downstream hardware or software subsystem 1412, in this case, a smartphone of the user 601, causing it to answer Felix's call. As another example without limitation, the temporal sequence of inferred facial expression labels is converted by label-to-command mapping unit 1411 in a sequence of storage actions in the memory of downstream HW or SW subsystem 1412, such as without limitation a personal cell phone, coupled to a processor running an application that analyses the sequence to derive information such as the mood of user 601, and can display cues to make user 601 aware of it as a form of mood-regulating feedback.

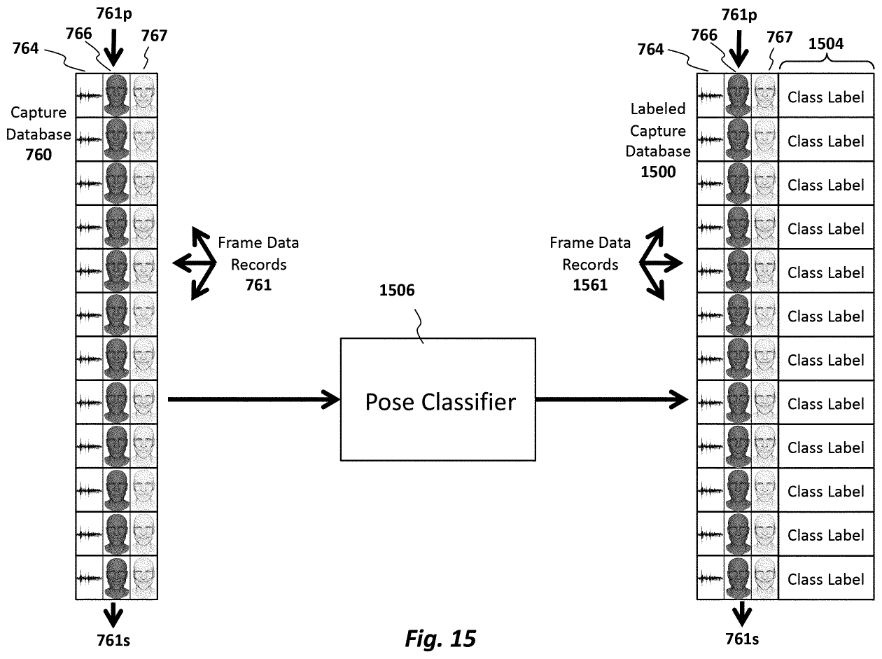

The machine learning model described in the prior paragraph is trained using the data presented in FIG. 15 stored on a mass storage device or in a labeled capture database 1500 where each Frame Data Record 1561 contains, in addition to metadata, CSI data 764 and a class label 1504 that, in exemplary embodiments, is pre-generated from Capture Data in capture database 760, 772-774 or multiple capture databases 860 through a pose classifier 1506 or through manual labelling or crowdsourcing. As illustrated in FIG. 16, the Machine Learning Model 1408 is structured to output an inferred probability for each of the possible class labels given the CSI input 1602 mapped to an input feature vector 1407 through the fixed feature mapping unit 1406. The machine learning model 1408 is thus trained in a supervised fashion using the many (CSI 764, class label 1504) pairs from the labeled capture database 1500 by feeding the model inferred label probabilities 1609, and the one-hot encoded ground-truth class label 1603 into a cross-entropy loss function unit 1610 directing a model parameter training algorithm such as backpropagation (e.g., https://en.wikipedia.org/wiki/Backpropagation).

A by-product of the training procedure is an embedding model 1610 that maps CSI 1602 to a latent representation 1611 in the trained machine learning model 1608 that captures features relevant to the classification task and can also be transferred as a pre-trained input to other tasks.

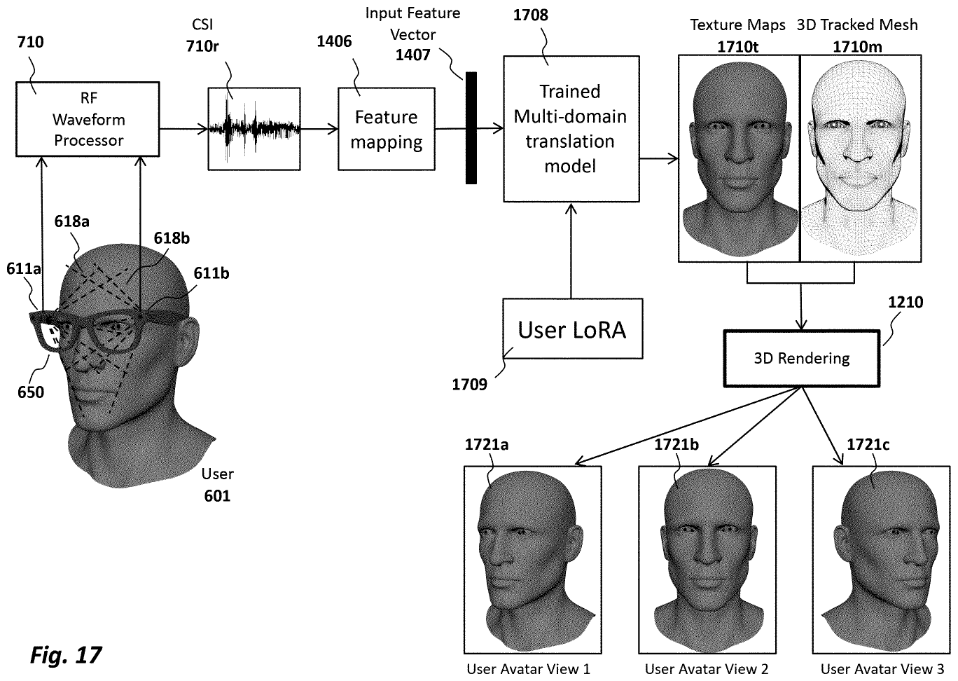

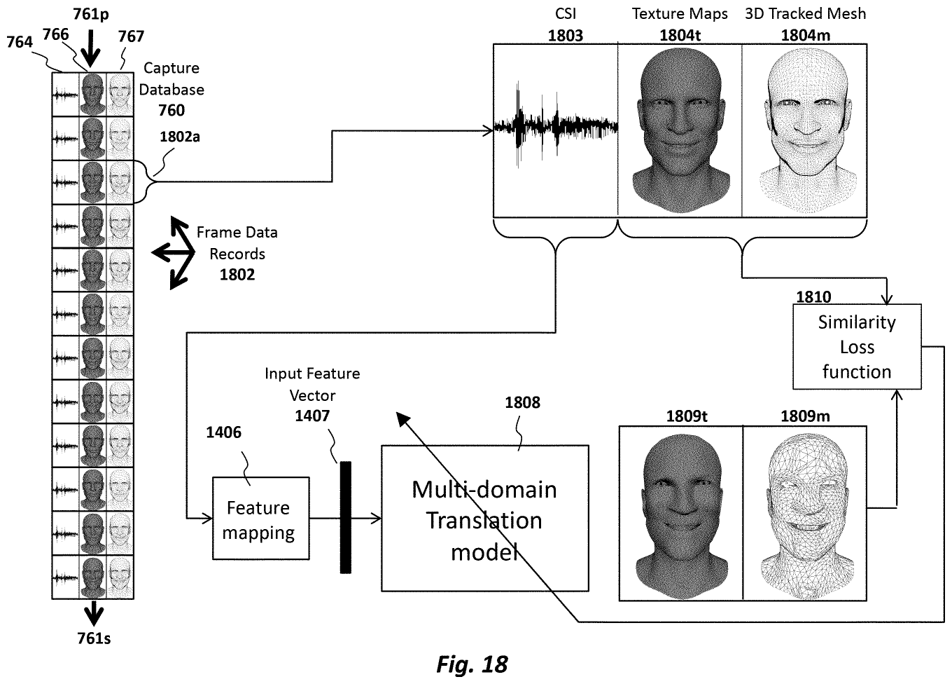

In exemplary embodiments of the invention illustrated in FIG. 17 RF Transceivers and Antennas 611a-b are integrated into a wearable device such as a pair of smart glasses 650. The integrated RF Transceivers and Antennas 611a-b implement the transmission and reception of SRS signals illustrated by RF waveforms 618a-b transformed by their propagation through and reflection on Head Structures of user 601. An RF waveform processor 710 derives from such waveforms the CSI 710r between pairs of transmit and receive antennas as described above and illustrated in FIGS. 9A-D in the form of CSI RF baseband waveforms. This CSI 710r, which is arranged in a multidimensional real or complex vector and is further processed through a feature mapping unit 1406 to derive an input feature vector 1407. The feature mapping unit 1406 can perform operations that enhance or suppress certain features in the raw CSI 710r. Examples of such feature mapping operations include but are not limited: 1) to impulse response shortening to only retain values corresponding to RF Transformations limited to Head Structures of user 601, which are confined within a certain distance from the RF antennas and exclude values corresponding to unrelated objects or clutter as described above and illustrated in FIG. 11; 2) domain conversion such as from time-domain representations to frequency-domain representations, or 3) linear or non-linear dimensionality-reduction, which can improve computational efficiency and provide noise reduction benefits, through principal component analysis (PCA), t-distributed stochastic neighbor embedding (t-SNE), or uniform manifold approximation and projection (UMAP). Such elementary feature mapping operations can be concatenated to form an overall feature mapping resulting in the input feature vector 1407. The input feature vector 1407 is subsequently fed into a trained multi-domain translation model 1708 that was trained as described below and illustrated on FIG. 18 and subsequently fine-tuned for a given user using a LoRA (Low-Rank Adaptation) 1709, as described above and illustrated in FIGS. 8A-C. Trained multi-domain translation model 1408 is designated multi-domain translation model 1808 in FIG. 18 before its training was complete and is exactly the same as trained multi-domain translation model 1708 except for the value of its internal parameters. The multi-domain translation learning model, whether trained 1708 or not yet fully trained 1808, returns a 3D tracked mesh 1710m and texture maps 1710t. In exemplary embodiments, the multi-domain translation model, whether trained 1708 or not yet fully trained 1808, is a multilayer perceptron (MLP) with a large number of layers and with activations in the last layer of the hyperbolic tangent type to allow for both negative and positive scalar values and a number of nodes equal to the number of scalar values needed to completely define a configuration in the space of Texture Maps 1710t and 3D Tracked Mesh 1710m. In other exemplary embodiments, the multi-domain translation model, whether trained 1708 or not yet fully trained 1808, is a recurrent neural network (RNN) with a large number of layers and with activations in the last layer of the hyperbolic tangent type to allow for both negative and positive scalar values needed to completely define a configuration in the space of Texture Maps 1710t and 3D Tracked Mesh 1710m. Using widely available 3D rendering tools 1210, such as Autodesk Maya or Blender, or by using proprietary 3D rendering software, the 3D tracked mesh 1710m and texture maps 1710t can be used to render views of a 3D avatar face 1721a-c that looks almost exactly like what the user 601 looks like when performing a given expression.

As illustrated in FIG. 18, the multi-domain translation model 1808, which only differs from trained multidomain translation model 1708 by the values of its parameters, is trained using the capture database 760, 772-774 or multiple capture databases 860 created, as described above and illustrated in FIGS. 7A-E, using the MOVA Contour facial capture system, or other facial capture system, as a training dataset. It is stored on a mass storage device or in a capture database 760, 772-774 or multiple capture databases 860 where each of the Frame Data Records 1802 contains, as illustrated by Frame Data Record 1802a, in addition to metadata, CSI data 1803 and the corresponding texture maps 1804t and 3D tracked mesh 1804m. The multi-domain translation model 1808 takes the input feature vector 1407 derived through the feature mapping unit 1406 described above from the CSI 1803 and outputs values in the space of texture maps 1809t and 3D tracked mesh 1809m pairs, illustrated as approximations of texture maps 1804t and 1804m. This value pair 1809t and 1809m and the texture maps 1804t and 3D tracked mesh 1804m pair associated with the input CSI instance 1803 are fed into a similarity loss function unit 1810 that computes a similarity loss function value that is used to update the multi-domain translation model 1708 parameters using a training algorithm such as backpropagation. At the beginning of the training of multi-domain translation model 1808, when its parameter values have just been initialized, the output pair 1809t and 1809m for each Frame Data Record instance CSI 1803 in the set of Frame Data Records 1802 used as part of the training, dev, or test set are mostly random and very different from the corresponding texture maps 1804t and 3D tracked mesh 1804m resulting in a high loss function value. As training progresses using batches of instances from the training set, the loss function value for each instance decreases and 1809t and 1809m become very similar to the corresponding 1804t and 1804m. FIG. 18 illustrates in a non-limiting way a single training instance at a point in the training process where convergence is on-going and has gotten to a point where the multi-domain translation model 1808 output pair, 1809t and 1809m, achieves a good but not perfect level of similarity with the instance texture maps 1804t and 3D tracked mesh 1804m.

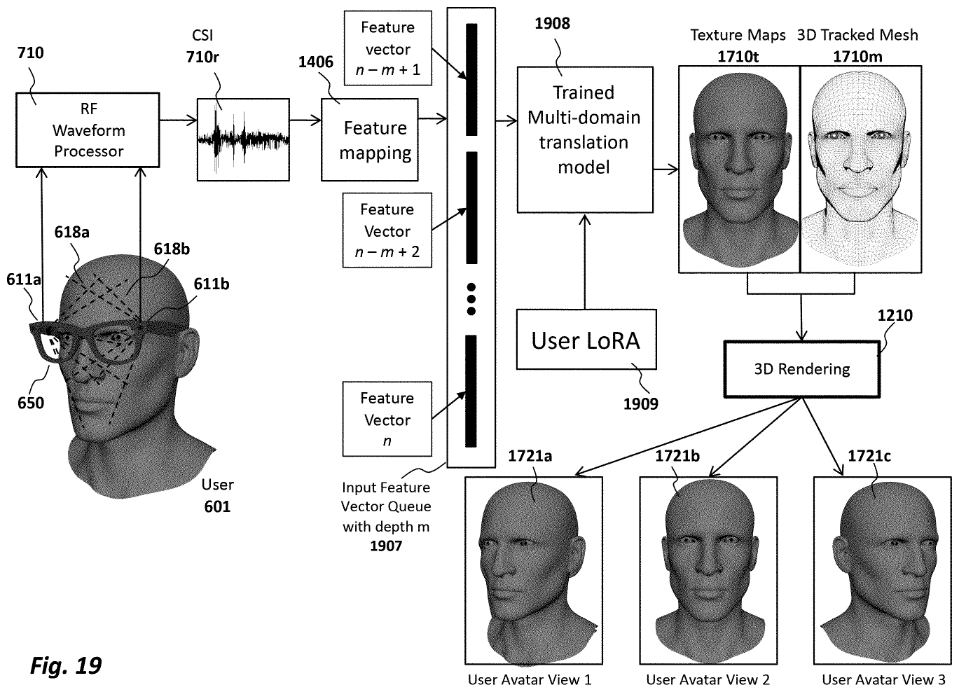

In exemplary embodiments of the invention illustrated in FIG. 19, RF transceivers and antennas 611a-b are integrated into a wearable device such as a pair of smart glasses 650. The integrated RF transceivers and antennas 611a-b implement the transmission and reception of SRS signals 618a-b transformed by their propagation through and reflection on Head Structures of user 601 while the user of the wearable device has a certain facial expression. An RF waveform processor 710 derives from such waveforms the CSI 710r between pairs of transmit and receive antennas as described above and illustrated in FIGS. 9A-D in the form of CSI RF baseband waveforms. This CSI 710r, which is arranged in a multidimensional real or complex vector and is further processed through a feature mapping unit 1406 to derive an input feature vector 1407. The feature mapping unit 1406 can perform operations that enhance or suppress certain features in the raw CSI 710r. Examples of such feature mapping operations include but are not limited: 1) to impulse response shortening to only retain values corresponding to RF Transformations limited to Head Structures of user 601, which are confined within a certain distance from the RF antennas and exclude values corresponding to unrelated objects or clutter as described above and illustrated in FIG. 11; 2) domain conversion such as from time-domain representations to frequency-domain representations, or 3) linear or non-linear dimensionality-reduction, which can improve computational efficiency and provide noise reduction benefits, through principal component analysis (PCA), t-distributed stochastic neighbor embedding (t-SNE), or uniform manifold approximation and projection (UMAP). Such elementary feature mapping operations can be concatenated to form an overall feature mapping resulting in the input feature vector 1407. During each Frame Time, there is an RF sampling cycle transmitting SRS signal RF waveforms 618a-b and receiving RF waveforms that undergo RF Transformation and determining a CSI 710r, and an input feature vector 1407 value is produced and is pushed into a queue of configurable depth of m frames 1907. The input feature vector subsequence contained in the m-deep queue 1907 is subsequently fed into a trained multi-domain translation model 1908 that was trained and subsequently fine-tuned using a user-specific LoRA 1909, as described above and illustrated in FIGS. 8A-C. The trained multi-domain translation model 1908 takes input vector subsequences as input and returns a 3D tracked mesh 1710m and texture maps 1710t. In these exemplary embodiments, the multi-domain translation model 1908, takes the m Feature Vectors at cycle n (i.e., feature vector n, feature vector n−1, . . . , and feature vector n−m+1), maps them to m embedding vectors through an embedding model such as 1610, that forms the input to the encoder of a Transformer model (e.g., https://en.wikipedia.org/wiki/Transformer_(deep_learning_architecture)), the autoregressive decoder of which outputs a 3D tracked mesh 1710m and texture maps 1710t for cycle n. Using widely-available 3D rendering tools 1210, such as Autodesk Maya or Blender, or by using proprietary 3D rendering software, the 3D tracked mesh 1710m and texture maps 1710t can be used to render views of a 3D avatar face 1721a-c that looks almost exactly like what the user 601 looks like when performing a given expression.

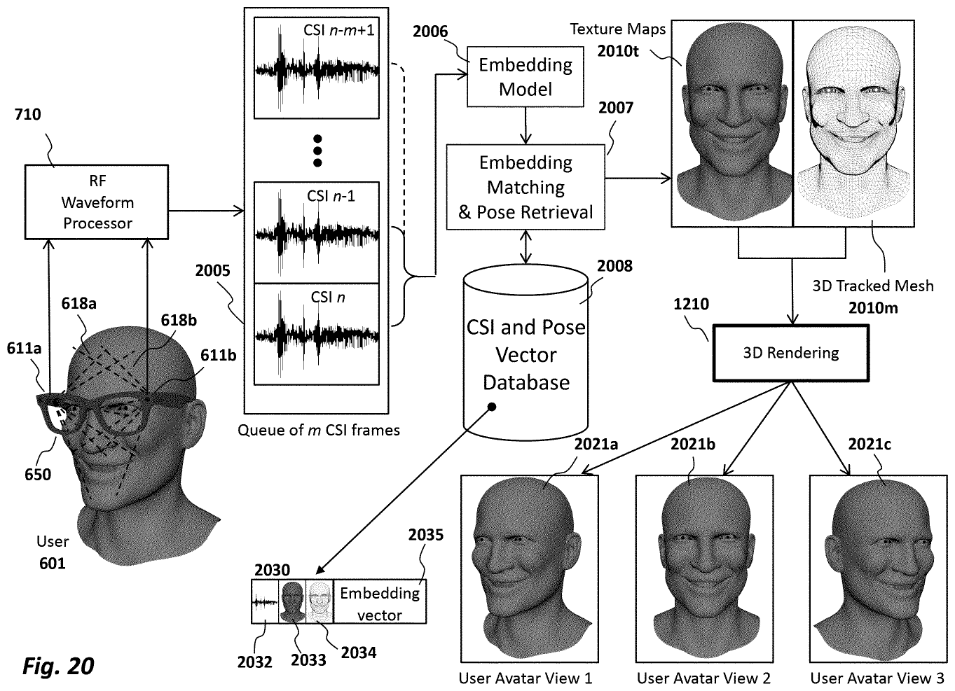

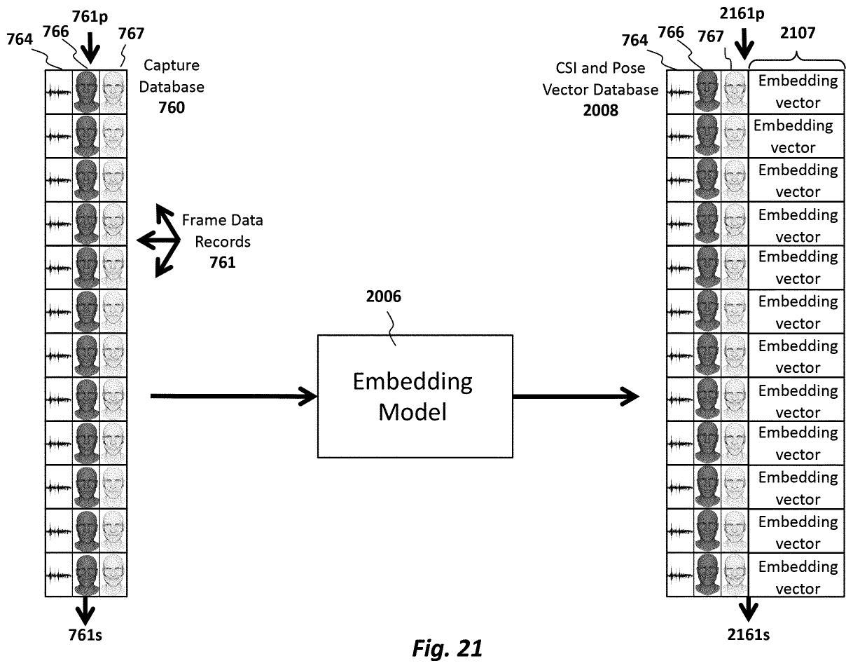

In exemplary embodiments of the invention illustrated in FIG. 20, the system is composed of RF transceivers and antennas 611a-b integrated into a wearable device such as a pair of smart glasses 650. The integrated RF transceivers and antennas 611a-b implement the transmission and reception of SRS signals, illustrated as RF waveforms 618a-b, transformed by their propagation through and reflection on Head Structures of user 601 wearing wearable device 650 while user 601 performs a facial expression. A RF waveform processor 710 derives from such received RF waveforms the CSI 710r between pairs of transmit and receive antennas as described above and illustrated in FIGS. 9A-D in the form of CSI RF baseband waveforms. As described above and illustrated in FIGS. 12A-B and 13A-B, the SRS signals are periodically transmitted and received at a given frame rate, for example without limitation, 100 frames per second. During each Frame Time the CSI 710r is pushed into a queue of configurable depth of m CSI frames 2005. At each Frame Time, the embedding model 1610 described above maps these m CSI frames to an m-dimensional vector of embedding vectors. In exemplary embodiments, the frame depth is 1 and during each Frame Time a single embedding vector value is output from the queue of m CSI frames 2005. This single embedding vector is then passed to an embedding matching and pose retrieval unit 2007 that is coupled to a CSI and pose vector database 2008. The CSI and pose vector database 2008 consists of Frame Data Records 2030 where each Frame Data Record may include, but is not limited to, CSI 2032; Pose data in the form of a texture map 2033 and 3D tracked mesh 2034 pair; and a corresponding embedding vector value 2035. In exemplary embodiments of the invention, the CSI and pose vector database 2008 is generated from a capture database 760, 772-774 or multiple capture databases 860 prior to system operation as shown in FIG. 21, where each Frame Data Record 761, which has CSI 764, and texture maps 766 and 767, is augmented with the addition of an embedding vector value 2107 that is the output of the embedding model 1610, which performs exactly the same mapping as 2006 in FIG. 20 and can be the same functional instance or a different instance. The embedding matching and pose retrieval 2007 unit uses a similarity function to match the embedding vector generated at each cycle to one best-matching embedding vector value 2035 in the CSI and pose vector database 2008. The matching can be done by a brute-force search if the database is small enough to allow the operation to be repeated at the pace of each cycle or it can use approximate nearest neighbor algorithms (e.g., https://en.wikipedia.org/wiki/Nearest_neighbor_search #Approximation_methods) that return a plurality of matching nearest neighbor entries, which can be reduced to a single one after filtering through additional criteria or by computing the centroid of the pose data of these nearest neighbor entries. The similarity function can be, without limitation, a Euclidian distance, a dot product similarity, cosine similarity or other vector database similarity functions. The pose data associated with the best-matching embedding vector, which is composed of a texture maps 2010t and 3D tracked mesh 2010m pair, is then passed to widely-available 3D rendering tool, such as Autodesk Maya or Blender, or proprietary 3D rendering software 1210, to render views of a 3D avatar face 2021a-c that looks almost exactly like what the user 601 looks like when performing a given expression.

In another embodiment, the CSI queue 2005 is of depth m greater than 1 and the embedding model 2006 returns an m-long vector of embedding vectors ordered in a temporal sequence and passed to the embedding matching and pose retrieval unit 2007. The embedding matching and pose retrieval unit 2007 now performs similarity matching on a set of m sequential database entry embedding vector values to identify the best matching m-long sequence of such entries and retrieve the pose data associated with the last entry (the most recent one) in the m-long sequence. Pose data rendering then proceeds as described above.

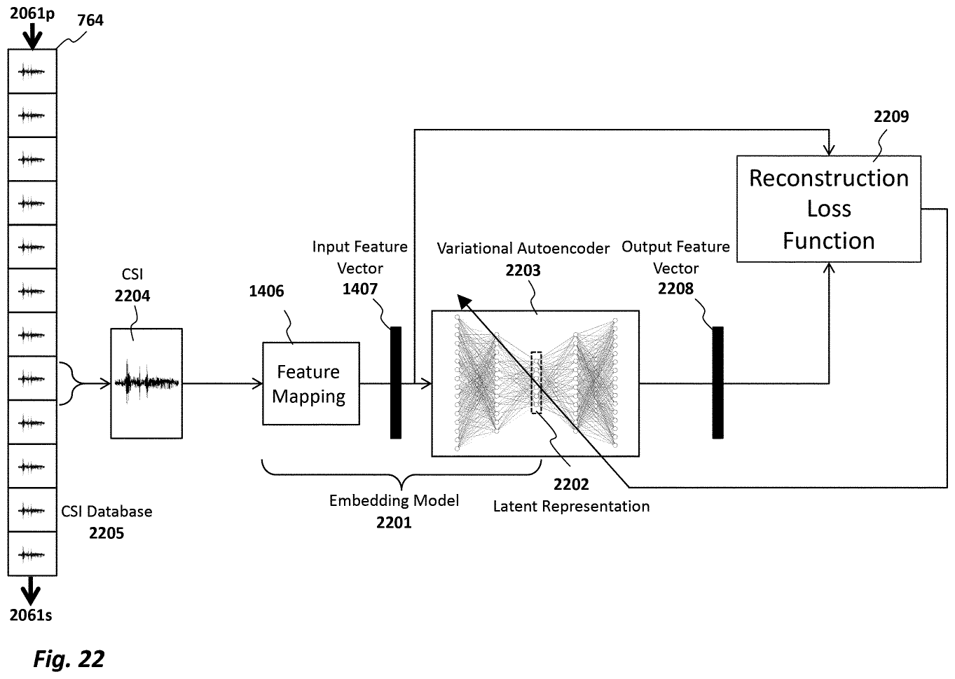

In exemplary embodiments illustrated in FIG. 22, the embedding model 2201 is generated from the latent representation 2202 of a variational autoencoder 2203 that inputs vector values from the input feature vector space and outputs values in the same space as the input feature vector space. The autoencoder 2203 is then trained using a training set of valid CSI values from a catalog created by recording CSI for a variety of subjects and stored as a CSI database 2205. For each CSI database entry, the CSI data 2204 is input into a feature mapping unit 1406 as previously described to produce an input feature vector 1407. The input feature vector 1407 is subsequently fed into the variational autoencoder 2203, which outputs a value 2208 in the feature vector space. For each instance, the input feature vector 1407 value and the output feature vector 2208 value, which the variational autoencoder outputs, are input into a reconstruction loss function unit 2209. The variational autoencoder 2203 is trained by providing training dataset instances or batches of instances and computing for each instance the reconstruction loss function unit 2209 output. That output directs a model parameter training algorithm such as backpropagation. Once training is complete, the sequence of operatively connected sub-units including the feature mapping unit 1406 and all variational autoencoder 2203 layers up to its internal latent representation 2202 form the resulting embedding model 2201.

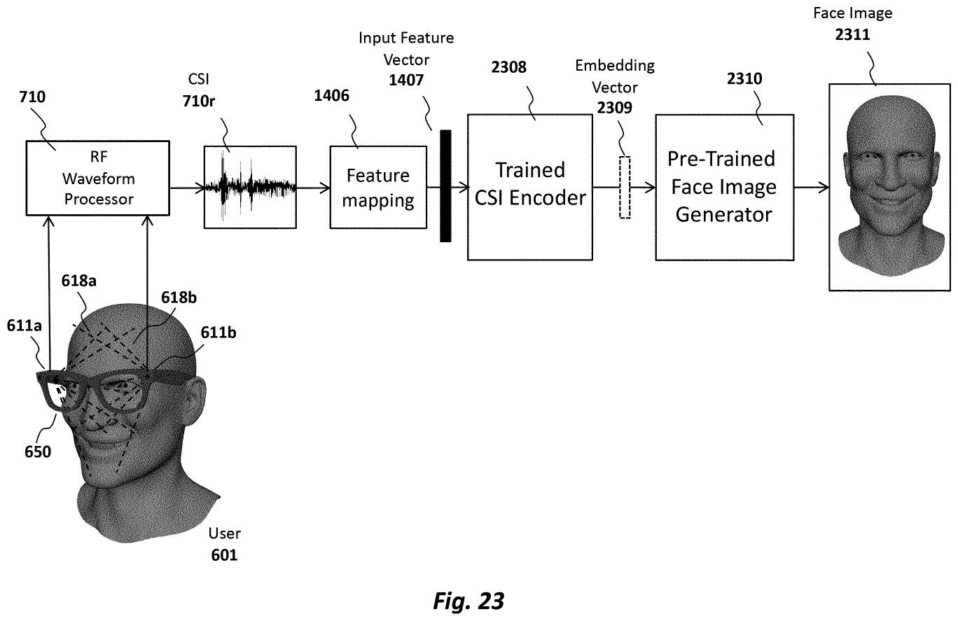

In exemplary embodiments of the invention illustrated in FIG. 23, the system is composed of RF transceivers and antennas 611a-b integrated into a wearable device such as a pair of glasses 650. The integrated RF transceivers and antennas 611a-b implement the transmission and reception of SRS signals, illustrated by RF waveforms 611a-b, transformed by their propagation through and reflection on Head Structures of user 601. An RF waveform processor 710 derives from such waveforms the CSI 710r between pairs of transmit and receive antennas as described above and illustrated in FIGS. 9A-D in the form of CSI RF baseband waveforms. This CSI 710r, which is arranged in a multidimensional real or complex vector, is further processed through a feature mapping unit 1406 to derive an input feature vector 1407. The feature mapping unit 1406 can perform operations that enhance or suppress certain features in the raw CSI 710r. Examples of such feature mapping operations include but are not limited: 1) to impulse response shortening to only retain values corresponding to RF Transformations limited to Head Structures, which are confined within a certain distance from the RF antennas and exclude values corresponding to unrelated objects or clutter as described above and illustrated in FIG. 11; 2) domain conversion such as from time-domain representations to frequency-domain representations, or 3) linear or non-linear dimensionality-reduction, which can improve computational efficiency and provide noise reduction benefits, through principal component analysis (PCA), t-distributed stochastic neighbor embedding (t-SNE), or uniform manifold approximation and projection (UMAP). Such elementary feature mapping operations can be concatenated to form an overall feature mapping resulting in the input feature vector 1407. The input feature vector 1407 is subsequently fed into the trained CSI encoder 2308 that produces an embedding vector value 2309 passed to a pre-trained face image generator 2310. In exemplary embodiments, the pre-trained face image generator 2310 is the decoder in the encoder-decoder pair of a variational autoencoder trained on face images. In exemplary embodiments, the CSI encoder 2308 is a multilayer perceptron (MLP) deep neural network. The pre-trained face image generator 2310 processes the embedding vector value 2309 to output the image of a face 2311 that looks almost exactly like what the user 601 looks like when performing a given expression.

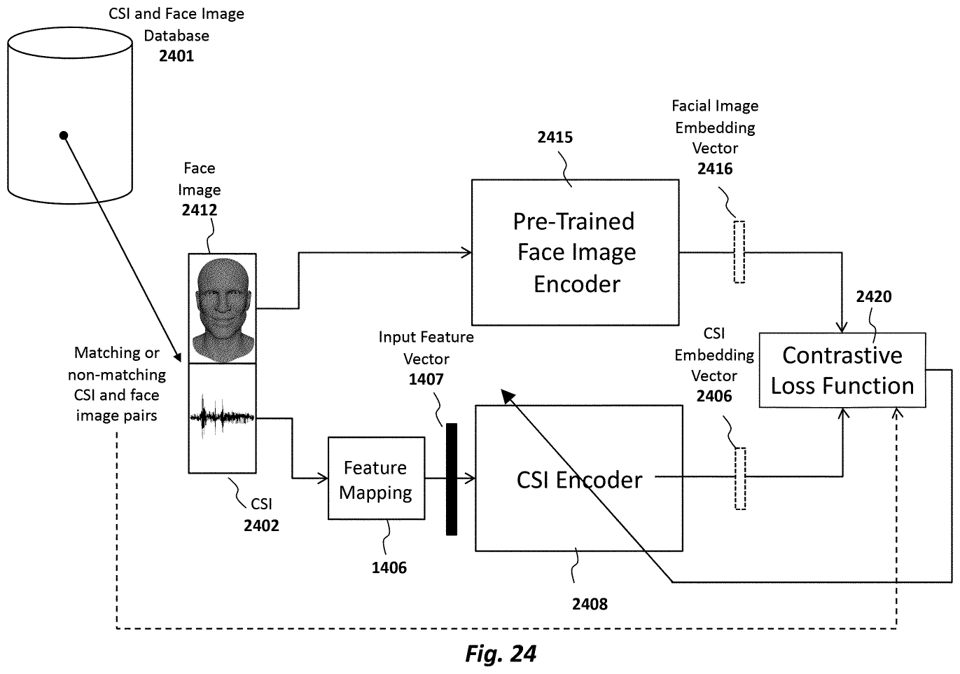

The aforementioned trained CSI encoder 2308 is designated CSI encoder 2408 in FIG. 24 before its training was complete and is exactly the same as trained CSI encoder 2308 except for the value of its internal parameters. CSI encoder 2408 is trained using the catalog created by recording video image frames of facial expressions of user 601 while, simultaneously, the RF transceivers and antennas 611a-b integrated into the above-mentioned wearable device 650 capture the corresponding CSI derived from the transmission and reception of SRS signals transformed by their propagation through and reflection on Head Structures of user 601. As illustrated in FIG. 24, that catalog forms a CSI and face image database 2401 from which the training set is taken by picking pairs of matching CSI 2402 and face image 2412 and non-matching CSI 2402 and face image 2412 pairs and this Boolean information is directly passed to the contrastive loss function unit 2420. A training set instance is processed forward in two parallel branches. In one branch, the instance face image 2412 is input into the pre-trained face image encoder 2415 that outputs a face image embedding vector value 2416. In the other branch, the CSI 2402 is input into a feature mapping unit 1406 as previously described to produce an input feature vector 1407. The CSI encoder 2408 forward-processes that input feature vector 1407 to produce a CSI embedding vector 2406 in a vector space that has the same dimensionality as the vector space of the face image embedding vector 2416. The contrastive loss function unit 2420 takes the output of each branch, which can be viewed as vectors in the same vector space, and computes a contrastive loss value (e.g., https://www.sciencedirect.com/topics/computer-science/contrastive-loss). That contrastive loss value directs a model parameter training algorithm such as backpropagation to update the CSI encoder 2408 parameters. After training, the CSI encoder 2408 maps instances of CSI 2402 to instances of CSI embedding vector 2406 arranged in a way that mimics the semantic structure of the arrangement of the instances of face image embedding vector 2416.

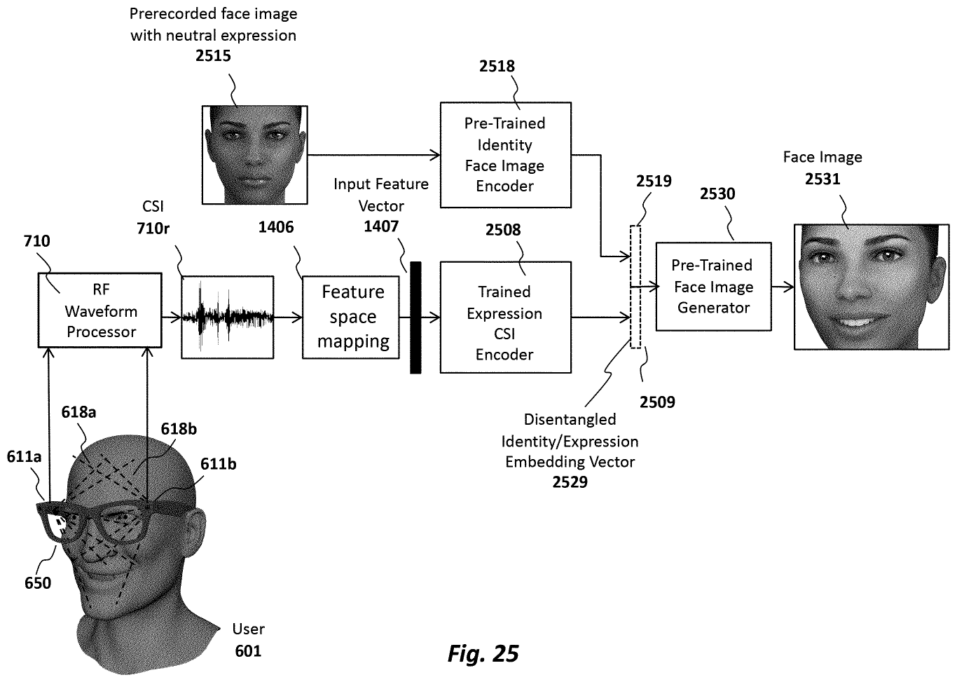

In exemplary embodiments of the invention illustrated in FIG. 25, the system is composed of RF transceivers and antennas 611a-b integrated into a wearable device such as a pair of glasses 650. The integrated RF transceivers and antennas 611a-b implement the transmission and reception of SRS signals, illustrated by 618a-b, transformed by their propagation through and reflection on Head Structures of user 601. An RF waveform processor 710 derives from such waveforms the CSI 710r between pairs of transmit and receive antennas as described above and illustrated in FIGS. 9A-D in the form of CSI RF baseband waveforms. CSI 710r, which is arranged in a multidimensional real or complex vector, is further processed through a feature mapping unit 1406 to derive an input feature vector 1407. The feature mapping unit 1406 can perform operations that enhance or suppress certain features in the raw CSI 710r. Examples of such feature mapping operations include but are not limited: 1) to impulse response shortening to only retain values corresponding to RF Transformations limited to Head Structures, which are confined within a certain distance from the RF antennas and exclude values corresponding to unrelated objects or clutter as described above and illustrated in FIG. 11; 2) domain conversion such as from time-domain representations to frequency-domain representations, or 3) linear or non-linear dimensionality-reduction, which can improve computational efficiency and provide noise reduction benefits, through principal component analysis (PCA), t-distributed stochastic neighbor embedding (t-SNE), or uniform manifold approximation and projection (UMAP). Such elementary feature mapping operations can be concatenated to form an overall feature mapping resulting in the input feature vector 1407. The input feature vector 1407 is subsequently fed into the trained expression CSI encoder 2508 that produces the expression CSI embedding vector 2509. In a parallel branch, a pre-recorded face image of a subject 2515, the user 601 or a different person as illustrated showing a female subject 2515 in FIG. 25, with a neutral expression is passed once through the pre-trained facial identity image encoder 2518 to produce the facial identity embedding vector 2519. The static facial identity embedding vector 2519 and the expression CSI embedding vector 2509 are concatenated to form the disentangled identity-expression embedding vector 2529, which is input into the pre-trained face image generator 2530. The pre-trained face image generator 2530 processes the disentangled identity-expression embedding vector 2529 and outputs a face image 2531 that looks almost exactly like what the subject 2515 looks like when performing the expression performed by user 601. The pre-trained identity face image encoder 2518 and the pre-trained face image generator 2530 are taken from a disentangling pre-trained identity face image encoder, expression face image encoder, and face image generator triplet such as described in prior-art https://github.com/YotamNitzan/ID-disentanglement.

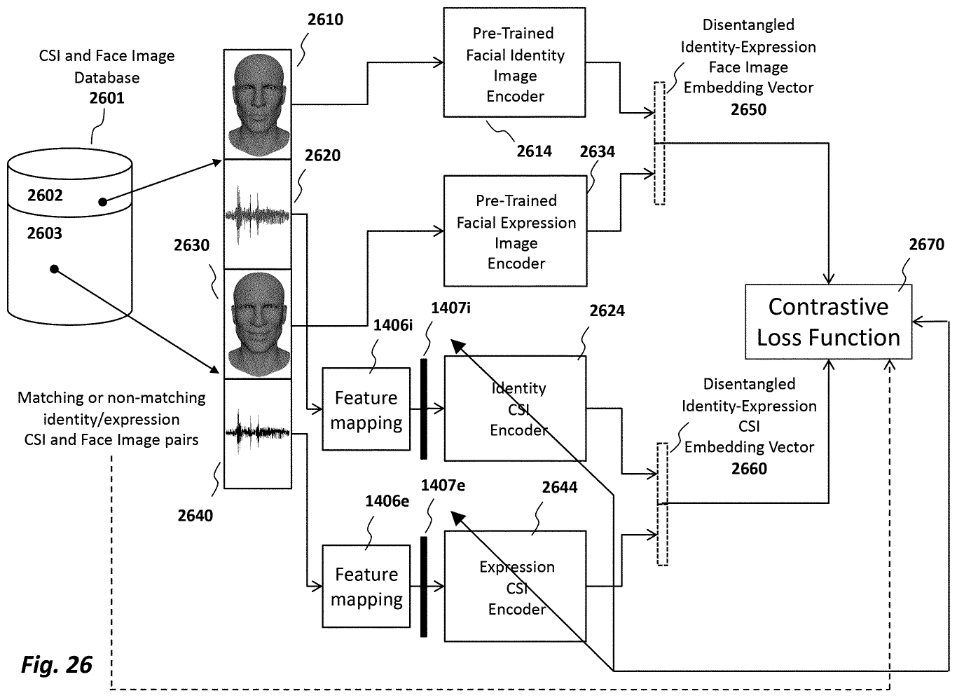

The aforementioned trained expression CSI encoder 2508 is designated expression CSI encoder 2644 in FIG. 26 before its training was complete and is exactly the same as trained expression CSI encoder 2508 except for the value of its internal parameters. CSI encoder 2644 is trained using the catalog created by recording video image frames capturing users' facial expressions while, simultaneously, the RF transceivers and antennas 611a-b integrated into the above-mentioned wearable device 650 capture the corresponding CSI 710r derived from the transmission and reception of SRS signals transformed by their propagation through and reflection on Head Structures of different subjects. As illustrated in FIG. 26, that catalog forms a CSI and face image database 2601 that is segmented into two sections, 2602 and 2603. This segmentation is logical and instantiated through a specific marker, label, or physical storage location. A first section, an identity section 2602, is formed of matching identity face image and CSI pairs. In exemplary embodiments, these pairs are generated with a plurality of subjects with a neutral facial expression. A second section, an expression section 2603, is formed of matching expression face image and CSI pairs, which are all the other matching face image and CSI pairs. A training set instance is formed of two face image and CSI pairs, one derived from entries in the identity section 2602, the identity face image 2610 and CSI 2620 pair, and one derived from entries in the expression section, the expression face image 2630 and CSI 2640 pair. Within each pair, the face image and the CSI could be matching, i.e. they are a pair from the original catalog, or they could be non-matching, i.e. they are each taken from different entries in the original catalog. The set of two pairs formed of the Identity face image 2610 and CSI 2620 pair and the expression face image 2630 and CSI 2640 pair is said to be matching if both pairs are matching. It is said to be non-matching otherwise and this Boolean information is passed to the contrastive loss function unit 2670. In other exemplary embodiments, two Boolean values are passed to the contrastive loss function unit 2670 indicating whether, on the one hand, the identity face image 2610 and CSI 2620 pair is matching and, on the other hand, whether the expression face image 2630 and CSI 2640 pair is matching. Components of this set of two pairs are processed through four different branches. The two branches that process the two face images are the two branches of a prior-art Identity-expression disentangling face image encoder. The face image 2610 of the Identity face image and CSI pair is input into the Pre-Trained Face Identity Image Encoder 2614 and the face image 2630 of the expression face image and CSI pair is input into the pre-trained expression face image encoder 2634. The two face image encoder outputs are concatenated to form the disentangled identity-expression face image embedding vector 2650 that is subsequently input into the contrastive loss function unit 2670. Simultaneously, the CSI 2620 of the Identity face image and CSI pair is input into an instance of the previously described feature mapping unit 1406i and produces an input feature vector 1407i that is subsequently input into the Identity CSI encoder 2624, and the CSI 2640 of the expression face image and CSI pair is input into an instance of the previously described feature mapping unit 1406e and produces an input feature vector 1407e that is subsequently input into the expression CSI encoder 2644. The two CSI encoder outputs are concatenated to form a disentangled Identity-expression CSI embedding vector 2660 that is subsequently input into the contrastive loss function unit 2670. The contrastive loss function computes from those inputs a contrastive loss value. That loss function value is fed back to adjust the Identity CSI encoder 2624 and the expression CSI encoder 2644 parameter values according to a training algorithm such as backpropagation. After training is complete, the CSI encoders map instances of the Identity CSI 2620 and expression CSI 2640 to an instance of the disentangled identity-expression CSI embedding vector 2660 arranged in a way that mimics the semantic structure captured in the arrangement of instances of the disentangled identity-expression face image embedding vector 2650.

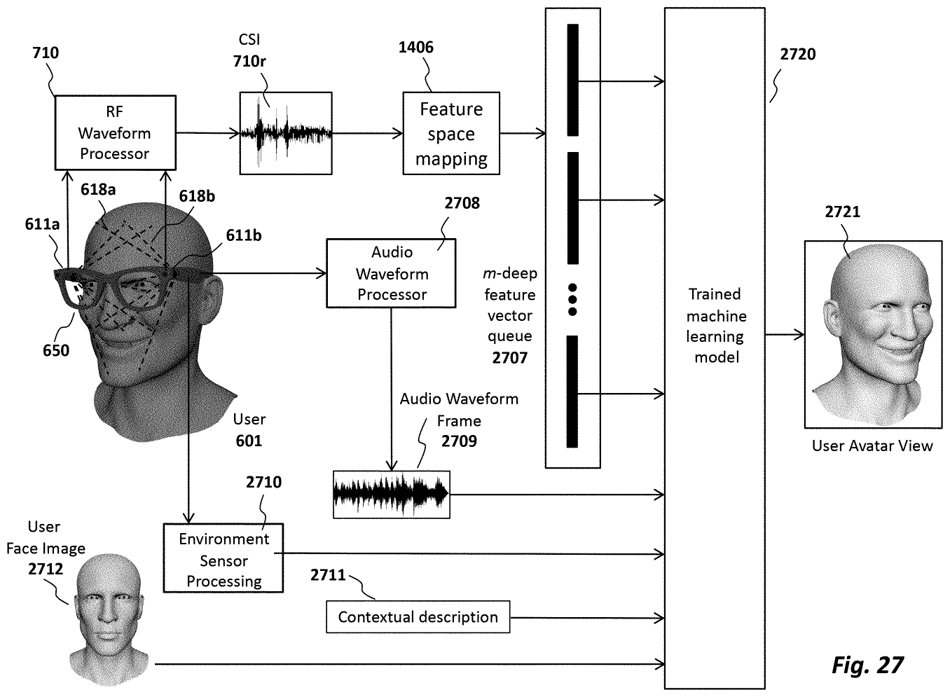

In exemplary embodiments of the invention illustrated in FIG. 27, the system includes RF transceivers and antennas 611a-b integrated into a wearable device such as a pair of glasses 650. The integrated RF transceivers and antennas 611a-b implement the transmission and reception of SRS signals, illustrated by RF waveforms 618a-b, transformed by their propagation through and reflection on Head Structures of user 601. An RF waveform processor 710 derives from such waveforms the CSI 710r between pairs of transmit and receive antennas as described above and illustrated in FIGS. 9A-D in the form of CSI RF baseband waveforms. This CSI 710r, which is arranged in a multidimensional real or complex vector, is further processed through a feature mapping unit 1406 to derive an input feature vector 1407. In a repeated operation, each cycle produces one input feature vector that is pushed into a m-deep queue 2707 containing an m-long subsequence of temporally consecutive input feature vectors. This subsequence of input feature vectors is input into a trained machine learning model 2720. The wearable device 650 also includes audio sensors such as microphones that produce audio waveform frame 2709 after passing through an audio waveform processor 2708 at the same rate as input feature vectors 1407. The system also includes a plurality of other environment sensors such as but not limited to ambient light, temperature, pressure sensors that produce environment sensor data after passing through an environment sensor processing unit 2710 at the same rate as the input feature vectors 1407. At each cycle, the m-long input feature vector subsequence 2707, the audio waveform frame 2708, the environment sensor data as well as static data such as a contextual description text 2711 and a user face image 2712 are input into a trained machine learning model 2720 and outputs a rendered user avatar view 2721 that looks almost exactly like what the user looks like when making a given expression with attributes such as lighting, color tonality, and background that vary in accordance with the user environment, the contextual description 2711, and the user face image 2712.

In exemplary embodiments of the invention the wearable device 650 incorporates, without limitation, at least one of audio input(s); video input(s); inertial sensors, including but not limited to, 3-degree of freedom and 6-degree of freedom inertial sensors; compass sensors; and/or gravity sensors. The output from one or a plurality of these sensors is used to enhance the training and/or the generation of user avatar view 2721.

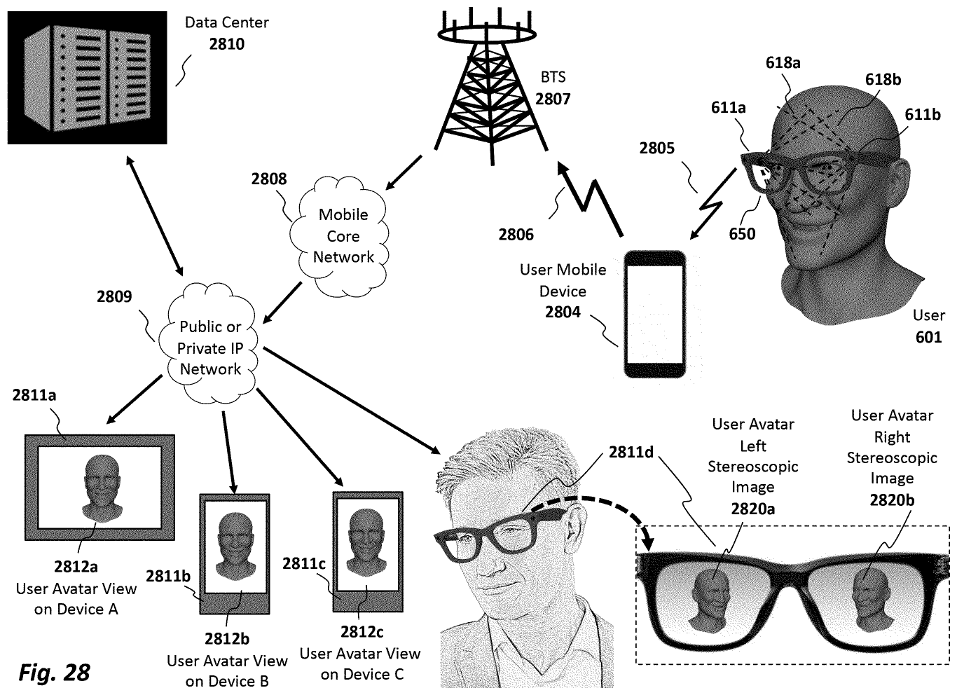

In exemplary embodiments of the invention illustrated in FIG. 28, the system includes RF transceivers and antennas 611a-b integrated into a wearable device such as a pair of smart glasses 650. The integrated RF transceivers and antennas 611a-b implement the transmission and reception of SRS signals, illustrated by 618a-b, transformed by their propagation through and reflection on the Head Structures of a first user 601. An RF waveform processor derives from such waveforms the CSI between pairs of transmit and receive antennas as described above and illustrated in FIGS. 9A-D in the form of CSI RF baseband waveforms. A first user 601 wears the wearable device 650, which includes a processor operatively connected to memory and a wireless communication unit operatively connected to the same memory and also to a first user mobile device 2804 such as a mobile phone that could be in their pocket through a wireless connection 2805 such as Bluetooth or Wi-Fi, or any other Private Area Network (PAN) communication technology. At each cycle the CSI data is captured and transferred to the first user 601 mobile device 2804, which subsequently transfers it to a Data Center 2810 through a connection 2806 to a Public Land Mobile Network (PLMN) Base Transmit Station (BTS) 2807, a PLMN Mobile Core Network 2808, and a Public or Private IP Network 2809. Details of such mobile network data exchange protocols such as 4G LTE or 5G NR and processing units involved in such a data transfer are publicly available. The data center 2810 subsequently implements, using central processing units or hard-wired processing units operatively connected to memory, the processing described in previous paragraphs to derive a 3D avatar face digital representation in the form of 3D digital face data that, once rendered, looks like the face of the first user 601. In exemplary embodiments, early stages of the CSI processing are implemented in the first user 601 mobile device 2804 and the more computationally intensive processing steps are implemented in the data center 2810. The data center 2810 sends through the Public or Private IP Network 2809 the 3D digital face data to other user devices in communication with the first user 601 such as within a videoconferencing application. The 3D digital face data is rendered on the screen of their devices 2811a-c to show an avatar face that looks like the first user's 601 face 2812a-c. These devices can be mobile phones 2811b-c, tablets 2811a or Virtual Reality (VR) or Augmented Reality (AR) devices such as a VR headset or a pair of AR glasses 2811d. On AR/VR devices, the 3D digital face data is rendered into a pair of stereoscopic Images 2820a-b so that an avatar face that looks like the face of first user 601 appears to be floating in 3D in front of a real or synthetic background.

In exemplary embodiment, at each frame time, the CSI data is transferred to the first user 601 mobile device 2804, which implements the processing described in previous paragraphs. It subsequently forwards the texture maps and 3D tracked mesh outputs to other devices with which it is in a communication session. These devices can be mobile phones, tablets or virtual reality (VR) or augmented reality (AR) devices such as a VR headset or a pair of AR glasses. On AR/VR devices, the 3D digital face data is rendered into a pair of stereoscopic images so that an avatar face that looks like the face of first user 601 appears to be floating in 3D in front of a real or synthetic background.

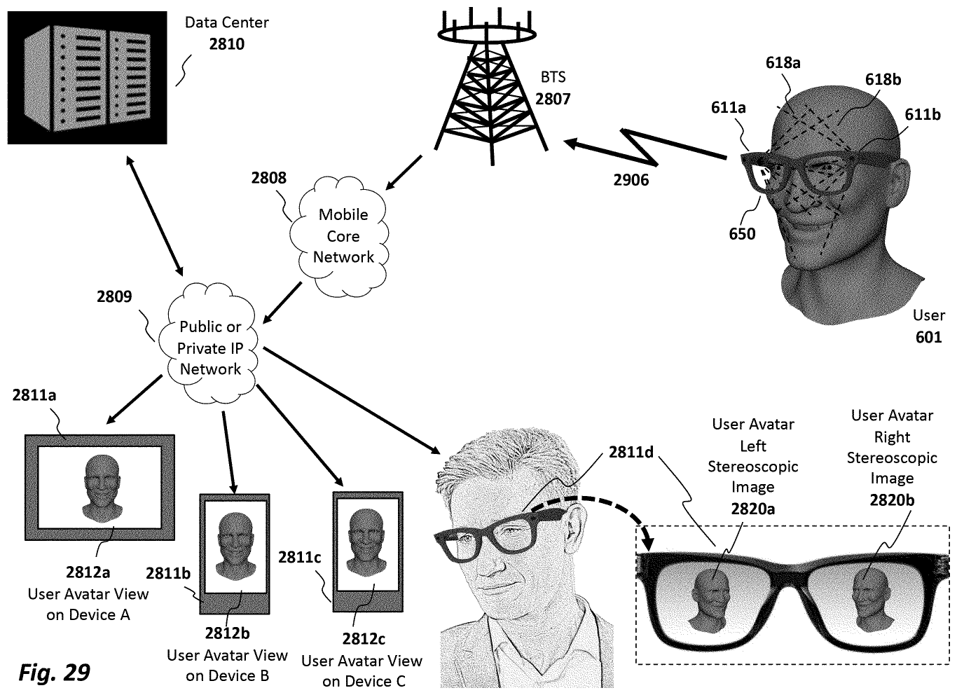

In exemplary embodiments of the invention illustrated in FIG. 29, the system includes RF transceivers and antennas 611a-b integrated into a wearable device such as a pair of glasses 650. The integrated RF transceivers and antennas 611a-b implement the transmission and reception of SRS signals, illustrated as 618a-b, transformed by their propagation through and reflection on the Head Structures of a first user 601. A RF waveform processor derives from such waveforms the CSI between pairs of transmit and receive antennas as described above and illustrated in FIGS. 9A-D in the form of CSI RF baseband waveforms. This CSI is arranged in a multidimensional real or complex vector. A first user 601 wears the wearable device 650, which includes a processor operatively connected to memory and a wireless communication unit operatively connected to the same memory and to a Public Land Mobile Network (PLMN). In each frame when the CSI data is captured after SRS transmission and transformation, the CSI data is transferred to a data center 2810 through a connection 2906 to a Public Land Mobile Network (PLMN) Base Transmit Station (BTS) 2807, a PLMN Mobile Core Network 2808, and a Public of Private IP Network 2809. The data center 2810 subsequently implements, using central processing units or hard-wired processing units operatively connected to memory, the processing described in the previous paragraphs to derive a 3D avatar face digital representation in the form of 3D digital face data that, once rendered, looks like the face of the first user. The data center 2810 multicasts through the Public or Private IP Network 2809 the 3D digital face data to other user devices in communication with the first user 601 such as within a videoconferencing application. The 3D digital face data is rendered on the screen of their devices 2811a-c to show an avatar face that looks like the first user's face 2812a-c. These devices can be mobile phones 2811b-c, tablets 2811a or virtual reality (VR) or augmented reality (AR) devices such as a VR headset or a pair of AR glasses 2811d. On AR/VR devices, the 3D digital face data is rendered into a pair of stereoscopic Images 2820a-b so that an avatar face that looks like the face of the first user 601 appears to be floating in 3D in front of a real or synthetic background.

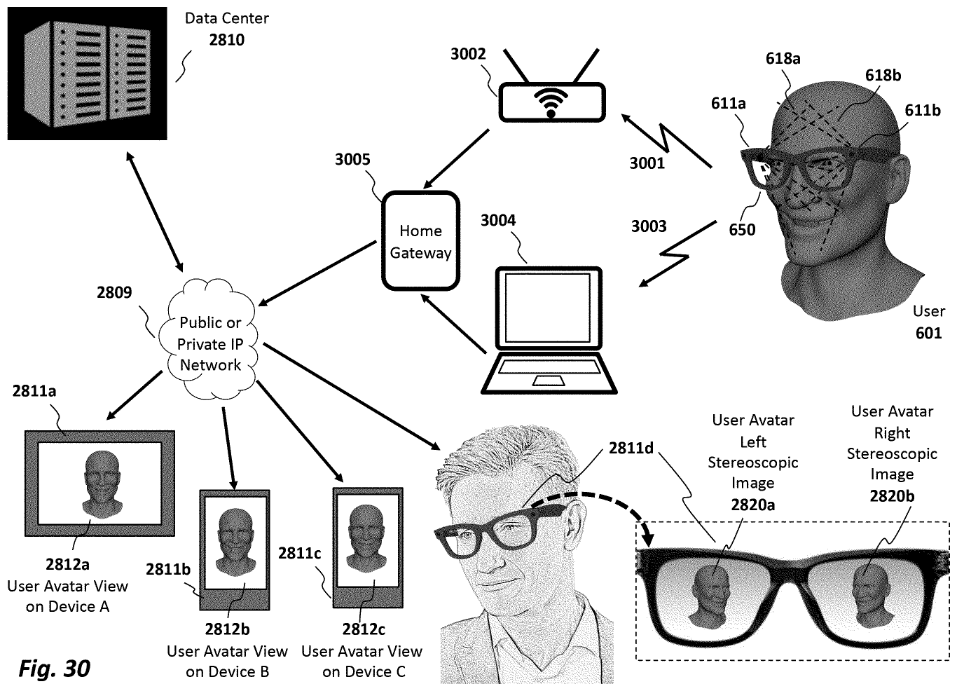

In exemplary embodiments of the invention illustrated in FIG. 30, the system includes RF transceivers and antennas 611a-b integrated into a wearable device such as a pair of smart glasses 650. The integrated RF transceivers and antennas 611a-b implement the transmission and reception of SRS signals, illustrated by 618a-b, transformed by their propagation through and reflection on the Head Structures of a first user 601. An RF waveform processor derives from such waveforms the CSI between pairs of transmit and receive antennas as described above and illustrated in FIGS. 9A-D in the form of CSI RF baseband waveforms. This CSI is arranged in a multidimensional real or complex vector. A first user 601 wears the wearable device 650, which includes a processor operatively connected to memory and a wireless communication unit operatively connected to the same memory and to a Wireless Local Area Network (Wireless LAN) router 3002 through a wireless connection 3001 such as Wi-Fi, or any other Wireless LAN communication technology as in commonly known to a person having ordinary skills in the art. Wireless LAN Router 3002 is connected to a Home Gateway 3005, that bridges the home network of user 601 to the Public or Private IP Network 2809. In each frame when the CSI data is captured after SRS transmission and transformation, the CSI data is transferred to a data center 2810 through home networking appliances 3002 and 3005 and Public of Private IP Network 2809. In exemplary embodiments, the wearable device 650 is connected to a personal computer 3004 through a wireless connection 3003 such as WiFi, Bluetooth, or other wireless communication technology and personal computer 3004 is connected to the home gateway 3005. Details of the data exchange protocols and processing units involved in such a data transfer are public knowledge. The data center 2810 subsequently implements, using central processing units or hard-wired processing units operatively connected to memory, the processing described in the previous paragraphs to derive a 3D avatar face digital representation in the form of 3D digital face data that once rendered looks like the face of the first user. The data center 2810 multicasts through the Public or Private IP Network 2809 the 3D digital face data to other user devices in communication with the first user 601 such as within a videoconferencing application. The 3D digital face data is rendered on the screen of their devices 2811a-c to show an avatar face that looks like the first user's face 2812a-c. These devices can be mobile phones 2811b-c, tablets 2811a or virtual reality (VR) or augmented reality (AR) devices such as a VR headset or a pair of AR glasses 2811d. On AR/VR devices, the 3D digital face data is rendered into a pair of stereoscopic Images 2820a-b so that an avatar face that looks like the face of the first user 601 appears to be floating in 3D in front of a real or synthetic background.

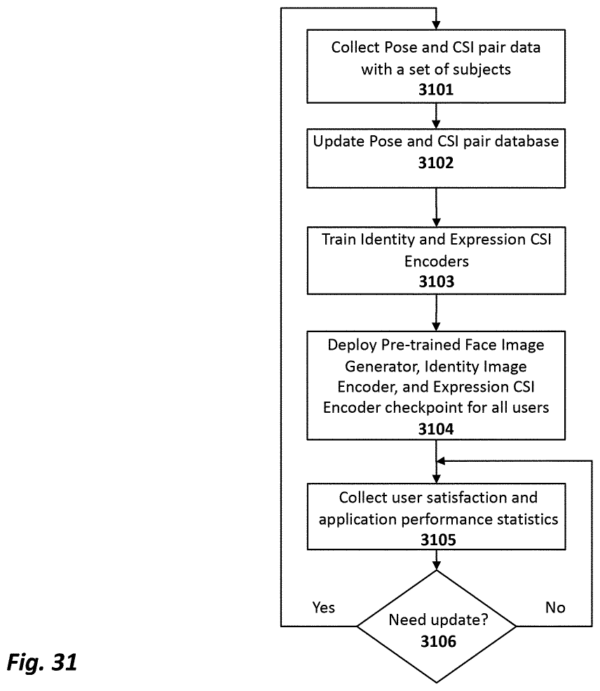

FIG. 31 illustrates the process of maintaining and deploying an exemplary embodiment of the facial capture system using CSI. The first step 3101 consists in collecting Pose and CSI pair data. In exemplary embodiments the Pose data component consists of texture maps and a 3D tracked mesh acquired using a system such as MOVA Contour technology or other facial capture technology. In another embodiment the Pose data consists in a face image acquired with a camera rigidly attached to a headset. The CSI data is simultaneously acquired using transceivers and antennas placed at the location relative to a subject's head equivalent to their location in the end wearable product. This data acquisition is performed with a wide variety of subjects. The second step 3102 consists in updating the Pose and CSI Pair database, which is a container for training, dev, and test data sets according to a machine learning methodology. In a third step 3103, these training, dev, and test data sets are used to train the Identity and expression CSI encoders illustrated in FIG. 26. Once training is complete, the next step 3104 is to deploy the pre-trained Identity face image encoder and expression CSI encoder checkpoint to all users of the system and the associated applications. As the system is being used by the entire user base, the following step 3105 consists in collecting user satisfaction and as well as objective application performance statistics to answer the question 3106 whether the deployed components require updating. If yes, the process goes back to step 3101. If no, the process goes back to step 3105.

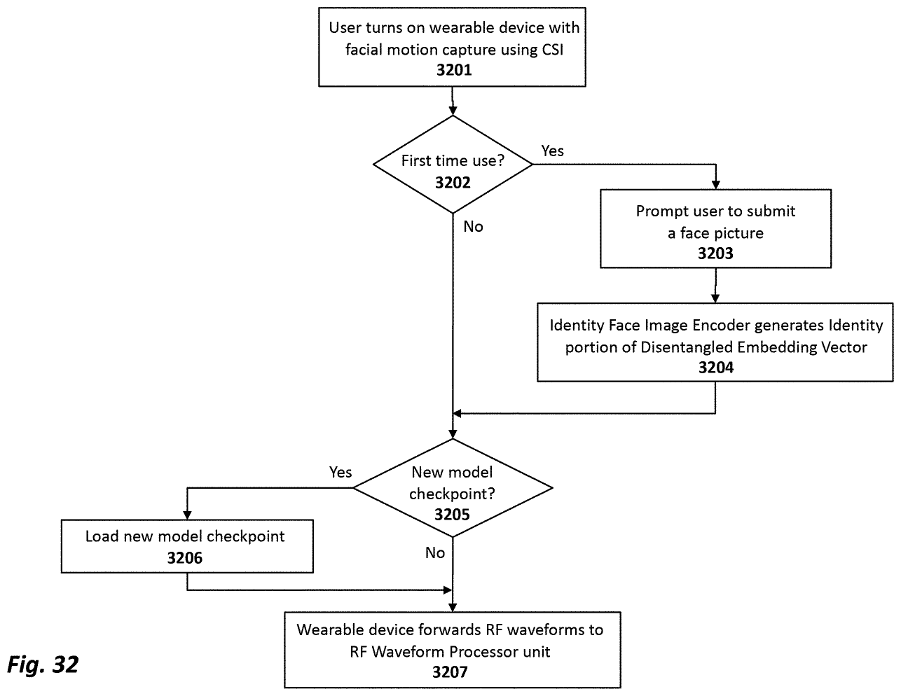

FIG. 32 illustrates what happens from the perspective of a user of a wearable such as a pair of glasses part of the facial capture system using CSI illustrated in FIG. 25. Once a user turns on the wearable device as a first step 3201, the application running on a CPU operatively connected to memory integrated in the wearable itself or running on a mobile device the wearable is paired with as illustrated in FIG. 28 or running in a data center the wearable is connected to as illustrated in FIG. 29 determines whether this is a first-time user in step 3202. If it is, on-boarding steps are implemented with step 3203 that prompts the user to submit a face picture with a neutral expression that serves as an Identity face image, which is used in step 3204 to generate the Identity portion of the disentangled embedding vector for that user the use of which is illustrated in FIG. 25. In any case, the application then checks in step 3205 whether a new model checkpoint is available for the CSI encoder, the pre-trained Image encoder, and the pre-trained face image generator. If so, the new model checkpoint is loaded in step 3206. In any case, the application then proceeds to step 3207 and starts the RF transceivers and antennas operation that repeatedly captures and forwards the RF waveforms from which CSI is derived to downstream system units as illustrated in FIG. 25.

Embodiments of the invention may include various steps as set forth above. The steps may be embodied in machine-executable instructions which cause a general-purpose or special-purpose processor to perform certain steps. Various elements which are not relevant to the underlying principles of the invention such as computer memory, hard drive, input devices, have been left out of the figures to avoid obscuring the pertinent aspects of the invention.

Alternatively, in exemplary embodiments, the various functional modules illustrated herein and the associated steps may be performed by specific hardware components that contain hardwired logic for performing the steps, such as an application-specific integrated circuit (“ASIC”) or by any combination of programmed computer components and custom hardware components.

Elements of the present invention may also be provided as a machine-readable medium for storing the machine-executable instructions. The machine-readable medium may include, but is not limited to, flash memory, optical disks, CD-ROMs, DVD ROMs, RAMs, EPROMS, EEPROMs, magnetic or optical cards, propagation media or other type of machine-readable media suitable for storing electronic instructions. For example, the present invention may be downloaded as a computer program which may be transferred from a remote computer (e.g., a server) to a requesting computer (e.g., a client) by way of data signals embodied in a carrier wave or other propagation medium via a communication link (e.g., a modem or network connection).

Throughout the foregoing description, for the purposes of explanation, numerous specific details were set forth in order to provide a thorough understanding of the present system and method. It will be apparent, however, to one skilled in the art that the system and method may be practiced without some of these specific details. Accordingly, the scope and spirit of the present invention should be judged in terms of the claims which follow.

1. A wearable device comprising:
(A) at least one radio frequency (RF) transmitter comprising an antenna integrated into at least one component of the wearable device, the at least one RF transmitter configured to periodically transmit at least one RF waveform;
(B) at least one RF receiver comprising an antenna integrated into the at least one component of the wearable device, the at least one RF receiver configured to receive the at least one RF waveform subsequent to the at least one RF waveform contacting an anatomy of a wearer of the wearable device;
(C) one or more data processing apparatus; and
(D) a computer-readable medium operatively coupled to the one or more data processing apparatus and the at least one RF receiver, the computer-readable medium having stored thereon:
(1) a database of RF channel state information (“CSI”) entries, wherein each CSI entry is associated with a 2-dimensional (“2D”) texture map of the wearer's anatomy; and
(2) instructions which, when executed by the one or more data processing apparatus, cause the one or more data processing apparatus to perform a method comprising:
(i) estimating a CSI from the received at least one RF waveform;
(ii) comparing the estimated CSI with CSI entries in the database to determine the closest matching CSI in the database; and
(iii) selecting the texture map of the wearer's anatomy associated with the CSI in the database.

2. The wearable device of claim 1, wherein the method further comprises:
(iv) rendering an avatar based on the selected texture map.

3. The wearable device of claim 1, wherein the wearable device comprises a device selected from the groups consisting of: headphones, earbuds, earphones, ear cuffs, hearing aids, over the ear hooks, in ear devices, devices attached by piercings, glasses, smart glasses, monocles, goggles, virtual reality or augmented reality goggles or glasses, contact lens, devices attached to one or both eyes, nose attachments, piercings, hat, cap, helmet, visor, headband, hair clip, support extensions mounted to the body, wrist and ankle bands, bracelets, necklaces, finger and toe rings, garment, suit, undergarment, shoe, glove, microphones, cameras, phones, smartphones, watches, smart watches, pendants and subcutaneous devices.

4. The wearable device of claim 1, wherein the wearer's anatomy comprises anatomy selected from the groups consisting of: face, eyeballs, head, hair, ears, lips, inner mouth, teeth, tongue, nostrils, jaw, neck, shoulders, chest, breasts, torso, genitals, buttocks, arms, hands, fingers, legs, feet, toes, piercings, tattoos, scarification, prostheses, joints and deformable parts of the body.

5. The wearable device of claim 1, wherein the wearable device is a pair of glasses.

6. The wearable device of claim 5, wherein the at least one component of the pair of glasses comprises frames of the pair of glasses.

7. The wearable device of claim 1, wherein the at least one RF waveform comprises a sounding reference signal (SRS).
